(19) United States
(12) Patent Application Publication
(10) Pub. No.: US 2013/0249934 A1
(43) Pub. Date: Sep. 26, 2013

(54) COLOR-BASED IDENTIFICATION, SEARCHING AND MATCHING ENHANCEMENT OF SUPPLY CHAIN AND INVENTORY MANAGEMENT SYSTEMS

(71) Applicant: ZENCOLOR CORPORATION, Coral Gables, FL (US)

(72) Inventors: Dann GERSHON, Coral GAbles, FL (US); David ROBINSON, Jersey City, NJ (US); Jonathan WILDER, Miami, FL (US)

(73) Assignee: ZENCOLOR CORPORATION, Coral Gables, FL (US)

(21) Appl. No.: 13/762,160

(22) Filed: Feb. 7, 2013

Related U.S. Application Data
(60) Provisional application No. 61/595,887, filed on Feb. 7, 2012.
(60) Provisional application No. 61/656,206, filed on Jun. 6, 2012.
(60) Provisional application No. 61/679,973, filed on Aug. 6, 2012.

(51) Int. Cl. G09G 5/02

(52) U.S. Cl. CPC G09G 5/022
USPC 345/594

(57) ABSTRACT

A color-based system, methods and interfaces to gather, identify, search for and match products using color as a primary indicator. The system, methods and interfaces are preferably implemented as an enhancement of proprietary merchant inventory management systems (IMS) and supply chain management systems (SCM) which enable the effective codification and evaluation of color-based data received and transformed from a number of different merchant IMS and SCM feeds. The system architecture further enables dynamic color processing, pattern recognition and a robust set of features for enhancing commercial experiences of and interactions between consumers and merchants.

### RELATED APPLICATIONS

The present invention claims priority to U.S. Provisional Patent Application No. 61/595,887 filed on Feb. 7, 2012, U.S. Provisional Patent Application No. 61/656,206 filed on Jun. 6, 2012, and U.S. Provisional Patent Application No. 61/679,973 filed on Aug. 6, 2012, all incorporated herein by reference.

This application further incorporates by reference U.S. application Ser. No. 13/762,281 and PCT Application No. PCT/US2013/25200 filed herewith and entitled Mobile Shopping Tools Utilizing Color-Based Identification, Searching and Matching Enhancement of Supply Chain and Inventory Management Systems.

### FIELD OF THE INVENTION

The present invention relates to a system, methods and interfaces to identify and present products from a single or plurality of proprietary supply chain management systems and inventory management systems, using a universal color-based visual indicator as a primary identifier for those products. The present invention also relates to a system, methods, and interfaces for color-based product searching, matching, dynamic analysis, codification and a robust set of features for enhancing commercial experiences of both users and merchants.

### BACKGROUND OF THE INVENTION

At times, a user will want to search for a product by color even though it is an attribute that cannot be described adequately using words. For example, other than using rudimentary color names, such as “red” and “blue,” searching for products of a particular shade using color as a parameter is extremely difficult, even when the color is relatively popular and intuitively should be easy to locate. For example, there are numerous colors which would fit the simple “red” or “blue” description, and searching using the textual word “red” is not likely to bring up the specific red or the specific product of interest. Also, searches based on a particular type of color by name, such as “rose red” or “ocean blue” are unlikely to turn up the color of interest, as there may be a number of different colors, each with a different name or with multiple names varying by the naming convention used. Similarly, searching for a pattern made of colors, such as “blue and red stripes” is unlikely to turn up the desired pattern of particular colors.

Many of the drawbacks involving color-based searching stem from the nature of internet searching, which has historically been text-based, thus requiring a user to enter text into a search engine to describe the information sought. With regard to color, textual color names are typically tagged or embedded beneath an image of a product or associated webpage as metadata, making it virtually impossible to obtain reliable and complete search results when specific color shades are sought. More specifically, because many search systems that implement searching based on a color (or a pattern) are operable only as text searching, a system may allow a user to select a color by name or even “click” on the color (in the form of a color swatch) and then search for the selected color. However, in these instances, the system typically converts the inputted search parameter to a text-string associated with or representing a particular color. For example, a search system may search based on clicking red swatch on a webpage but converts the click to a search for “red” as text, but not as an actual color. In such a system, the name of the color “red” is “tagged” to an image by way of a text string and the search is based by matching the input “red” to the text string “red” on the tag, and not to the color. From a consumer's perspective, such a system is insufficient to reliably capture all relevant products of a particular shade of red that are being sought. From a merchant perspective, such a system does not allow for dynamic analysis or codification of color which is a crucial but missing data set in understanding consumer preferences.

Another problem with contemporary color searching is a lack of universal color codification and unifying color naming conventions. For example, even when a search using a specific color such as “cherry red” yields some relevant results when utilizing a search engine or a search field on a particular merchant's website (i.e., where the merchant utilizes the term “cherry red” as a tag to identify some of its products), such searches do not yield all of the relevant results for the particular type of red being searched. This is the case even when there are available products sold by other merchants that have the identical color or a close equivalent color but which use a term other than “cherry red” to identify that color.

Even color systems that offer naming conventions suffer from underlying drawbacks in their inconsistent application by merchant users and their vendors. For example, a wholesale buyer for a retailer may decide to order a line of products from a vendor in a color that is identified as “cobalt blue.” A second wholesale buyer at the same retailer may order another line of products from a second vendor in a color that the second buyer also identifies “cobalt blue,” having the intention that the colors be precisely the same so that a purchaser of product from the first line will be more inclined to purchase the second line of product as a matching set. Indeed, the variation in color between two products that purportedly have the ‘same color’ can be remarkable when the products are placed side by side. The lack of consistency among vendors and suppliers, even when the same color names are utilized, is often not appreciated until after the products arrive, at which time it is too late to ameliorate the situation.

Current systems further lack the ability to aggregate a user's preferred and/or customized colors onto a unified area or palette for purposes of identifying and searching for products. Also, use of the palette for forming color combinations and to perform searches based on a primary color and a secondary color (and a pattern) are lacking in the prior art. To that end, it would be beneficial to have that group of preferred colors identified, collected and readily available to that user in a single palette for effective color-based searching.

### BRIEF DESCRIPTION OF THE PRESENT INVENTION

It is a primary objective of the present invention to provide a system, methods and interfaces for merchants and consumers to identify, search for and match products based on color.

It is another objective of the present invention to provide a universal convention for color-based identification, searching and matching across multiple proprietary platforms for consumers and merchants to conduct more efficient searches and provide more relevant and up-to-date product results.

Further objectives of the invention will be apparent from the disclosure which follows. Generally, the present invention is directed to identifying, searching for and matching products based on color and/or pattern across multiple proprietary supply chain management systems (SCM) and/or inventory management systems (IMS). The present invention is also directed to recognition and matching of products by color and/or pattern and a number of other more conventional attributes. The present invention also lends itself to data aggregation, analysis and making purchase recommendations to consumers that are based, at least in part, on color and/or pattern, potentially in combination with other available information to provide users with more of what they actually want.

The present invention may stand on its own or serve as an enhancement of or upgrade to IMS and/or SCM systems directed to facilitating a wide range of functions, including search, product selection, purchase, marketing, advertising, product planning and sales. An overarching goal of the present invention is the application of operations research principles to selected problems in retailing by organizing and identifying products according to color and/or pattern and by using those attributes as primary indicators, where retailing extends from product development and manufacturing through customer service.

The system includes one or more servers operated by machine-readable software instructions present on non-transitory computer readable storage media to perform a variety of functions associated with product identification, searching and matching utilizing color as a principle attribute.

The system of the present invention is designed and intended to perform the following tasks:

1. Process and integrate data from merchant IMS and SCM system(s) via formatted data feeds to create a database of products with corresponding color information (i.e., digitally defined color identifier);

2. Gather available supplementary data from merchant IMS and SCM system(s) via formatted data feeds which are used to enhance the user shopping experience and the merchant commercial experience from the initiation of production through final sale;

3. Provide interfaces for users to query product databases with real-time merchant IMS and SCM system(s) information, using digitally defined color identifiers, and to purchase products from multiple merchants based on color and other customizable parameters;

4. Dynamically analyze codified color-based preferences, trends and system-wide activities to make targeted and micro-targeted product recommendations to users with color as a primary product attribute.

Generally, the present invention provides a system, methods and a set of interfaces that provide users and merchants with a number of previously unavailable opportunities and tools in the context of color identification, selection and matching. One significant feature of the present invention is a color matching system that is more effective for both users and merchants than current methods used to search and match colors. When utilizing this feature, users are supplied with increasingly relevant search results for a number of merchant products that correlate more closely (or exactly) to the colors for which a user is searching.

With respect to the hardware of the system, CPU-based servers are arranged to communicate with one another and with one or more data warehouses, preferably residing therein, which are used to store user data, merchant data, product data, and color data. In a preferred embodiment, servers receive formatted data feeds from IMS and SCM systems which populate the data warehouse once the data is normalized by machine processes. The servers and software gather, parse and filter the data warehouse data according to encoded instructions to allow a user to search for and purchase products from merchants.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-described and other advantages and features of the present disclosure will be appreciated and understood by those skilled in the art from the following detailed description and drawings of which:

FIG. 1 illustrates a basic system configuration fashioned in accordance with the present invention;

FIG. 2 is a flow diagram depicting the consumption and integration of proprietary merchant IMS and SCM systems data carried out by machine processes that perform the functions of data normalization, dynamic analysis, conversion and storage, and data syncing;

FIGS. 3A and 3B together comprise a system diagram depicting interaction among various system segments and functions carried out in accordance with the present invention, including data consumption, data search and data analytics;

FIG. 4 illustrates the dynamic color analysis engine of the present invention and its sub-modules;

FIG. 5 illustrates a four-quadrant framework, each subdivided into a 16×16 grid into which a swatch or image is divided for processing by the color engine of the present invention;

FIG. 6a illustrates a grayscale representation of a red and black checkered pattern presented for color and pattern recognition by the image processing module;

FIG. 6b illustrates a grayscale representation of a red and black checkered pattern presented for color and pattern recognition by the image processing module, where the pattern is somewhat rotated;

FIG. 6c illustrates a grayscale representation of a red and black checkered pattern presented for color and pattern recognition by the image processing module, where the pattern is partially distorted;

FIG. 7 is a flow diagram depicting a sequence of pattern and color processing;

FIGS. 8a through 8g illustrate a sequence of pattern and color processing with respect to a striped shirt pattern having colors specified in hexadecimal code;

FIG. 9 illustrates an embodiment of a graphical user interface or display for color search access; and

FIGS. 10-1 through 10-86 are listing of hexadecimal color codes and corresponding color swatches in a preferred system embodiment utilizing 4096 colors.

### DETAILED DESCRIPTION OF THE INVENTION

The present invention provides a color-based system, methods and interfaces to gather, identify, search for and match products based on color. The invention further provides a color-based system, methods and set of interfaces to analyze color data, product data, and anonymous user and merchant data to provide a more robust product searching and purchase experience for users and a more effective means for merchants to target, advertise and sell to consumers.

As an enhancement of proprietary merchant IMS and SCM systems, the preferred embodiment of the present invention permits merchants to conduct real-time (or more frequently updated) data analytics that are based on universal color data, which is a data set that has heretofore been unavailable to merchants for the purpose of conducting analytics. These analytics are instrumental to enabling retailers and their manufacturers make or adjust supply chain and inventory decisions sooner and more effectively in accordance with shifting consumer demand and commercial activities.

As referenced herein, the term “user” may properly refer to a merchant or to an individual shopper or consumer. However, it should be understood, unless otherwise indicated or apparent from the specification, that the term “user” typically refers to an individual shopper or consumer. In addition, it should be understood that a preferred embodiment of the present invention is implemented primarily, but not exclusively, as a web-based system with accessibility to the system and its databases via an open distributed computer system, such as the Internet. Moreover, while the discussion below is often with reference to a single server and storage device, it should be appreciated that a number of servers and storage devices may be utilized in tandem to implement the system.

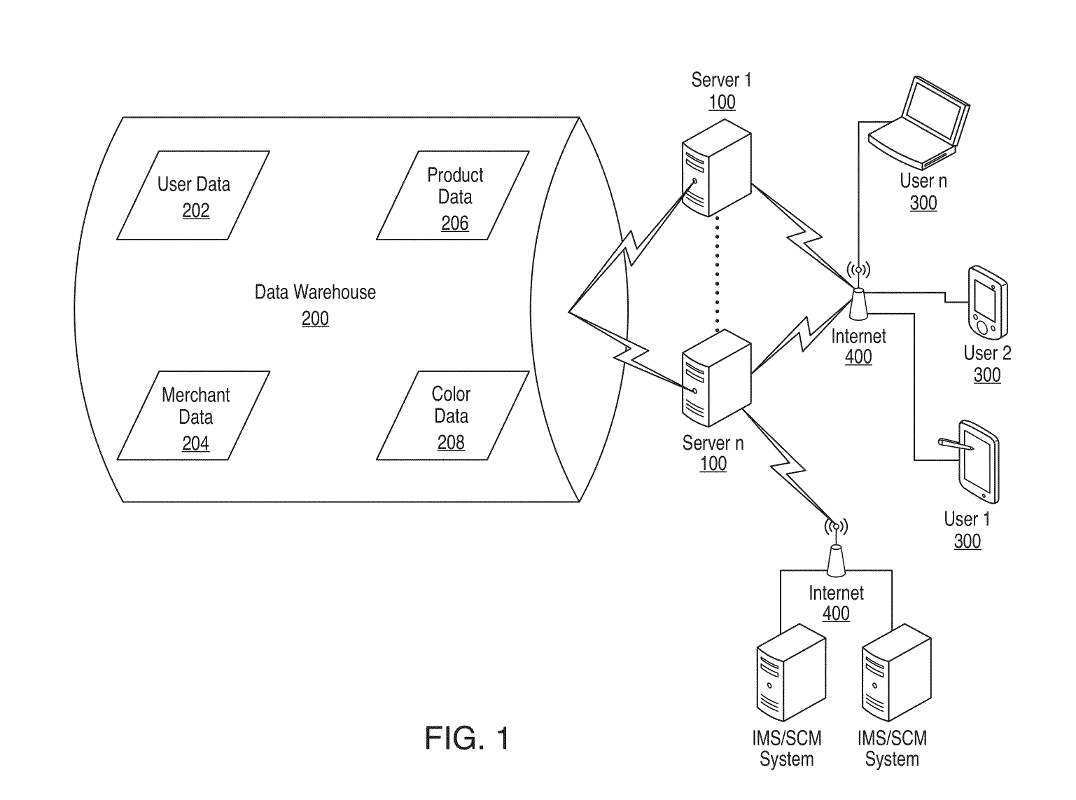

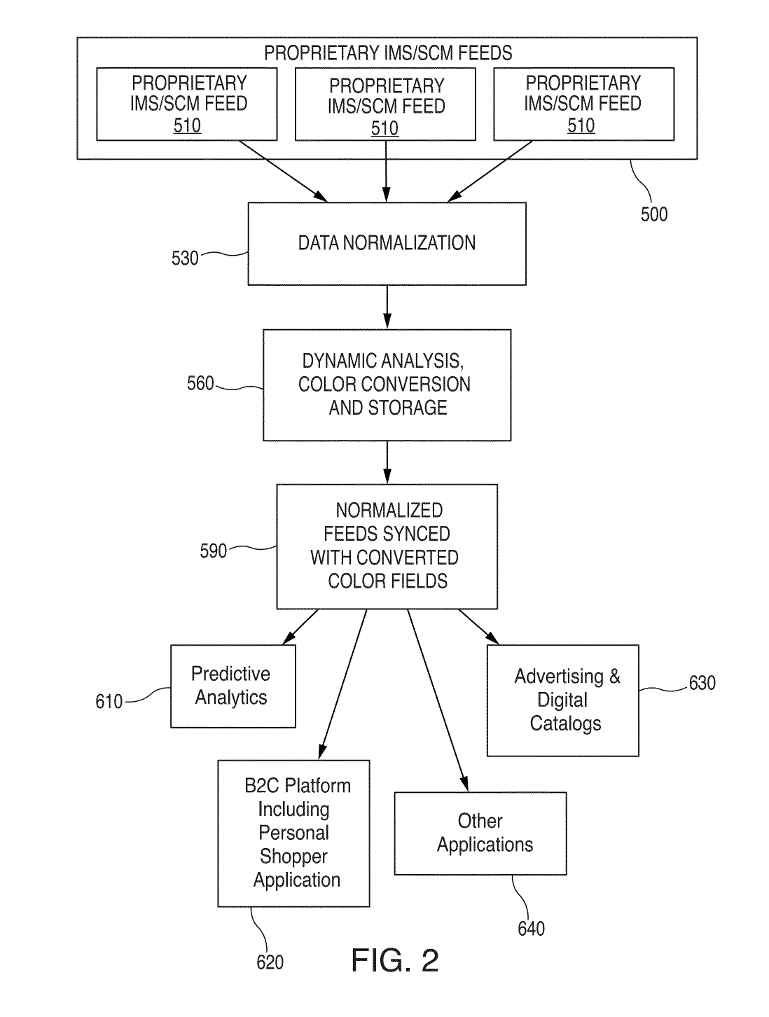

With reference to FIG. 1 there is shown a basic system configuration comprising a processor-based machine, such as computer(s) or server(s) 100, with hard disk or memory drives running software comprising machine readable program instructions. Server 100 serves as and/or provides access to data warehouse 200, which comprises data stores with information related to users 202, data stores with information related to merchants 204, data stores with information related to products 206, and data stores with information related to color 208. All data are maintained in data warehouse 200 or other conventional database system having read and write accessibility using a database management system. Although described herein for illustrative purposes as being separate data stores, in at least some alternative embodiments, the data stores may be combined in various combinations.

Information contained in data warehouse 200 is accessible by both consumer and merchant users operating devices 300 over the Internet 400. Devices 300 comprise processor-based machine(s), such as laptops, PCs, tablets and/or other handheld devices to and from which server 100 communicates. Devices 300 are connected to server 100 utilizing customizable interfaces described herein. Custom interfaces may be in the form of a graphical user interface, an application to form a client-server arrangement and/or other well-known interface conventions known in the art. Depending on the nature of the user and its access to various forms of information, different interfaces are made available. To support various options, the system of the present invention may include at least one application programming interface (API) so that certain types of users could enhance their interfaces, and different ones may be available for users and merchants.

Each data set introduced in the data warehouse 200 represents interrelated data sets that communicate with and rely on other data sets for complete information (but do not necessarily represent discrete data sets).

These data sets may be accessed using a variety of database management systems (DBMS), including but not limited to relational database management systems (RDBMS) and “post-relational” database management systems (e.g., not only Structured Query Language (“NOSQL”) database management systems). In this manner, the data sets illustrated in FIG. 1, namely, user data 202, merchant data 204, product data 206 and color data 208, are meant to be purely illustrative and are not intended to necessarily depict a physical housing of data. Furthermore, by using a DBMS such as RDBMS or a “post-relational” DBMS, the data may be available to a merchant in a variety of manners, such as based on a specific demographic profile or a specific color or color grouping.

In a preferred embodiment of the present invention, user data 202 includes data specific to individual users which users may wish to make available, such as:

1. Personal information, including but not limited to, username, name, address (and more generalized geographic information), telephone data, birth date information, astrological information, keywords with which the user associates, colors with which the user associates specific keywords, etc.

2. Demographic information, including but not limited to, age, gender, education history, income, marital status, occupation and religion.

3. Color preference and bookmark data;

4. Product history information, including but not limited to, browsing history, product ratings (e.g., like and hide), purchase history, favorite stores, favorite brands; and

5. Social information including specifics for user-to-user or user-to-merchant associations including, but not limited to, friends, family, colleague, romance, and acquaintance associations.

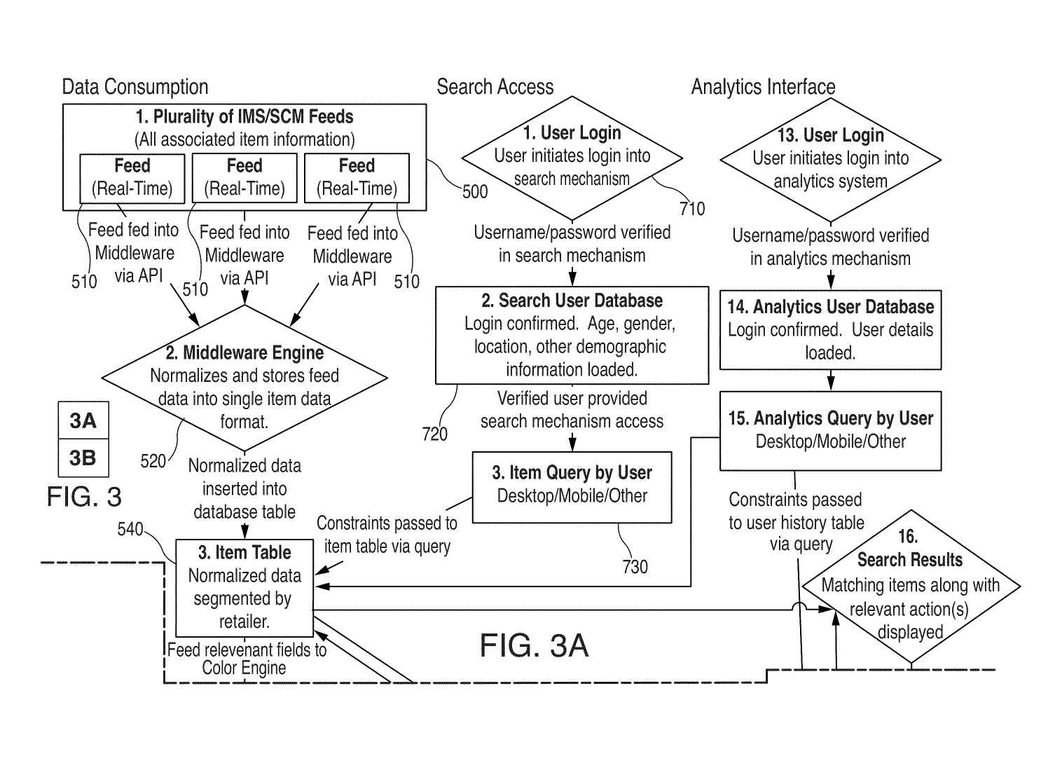

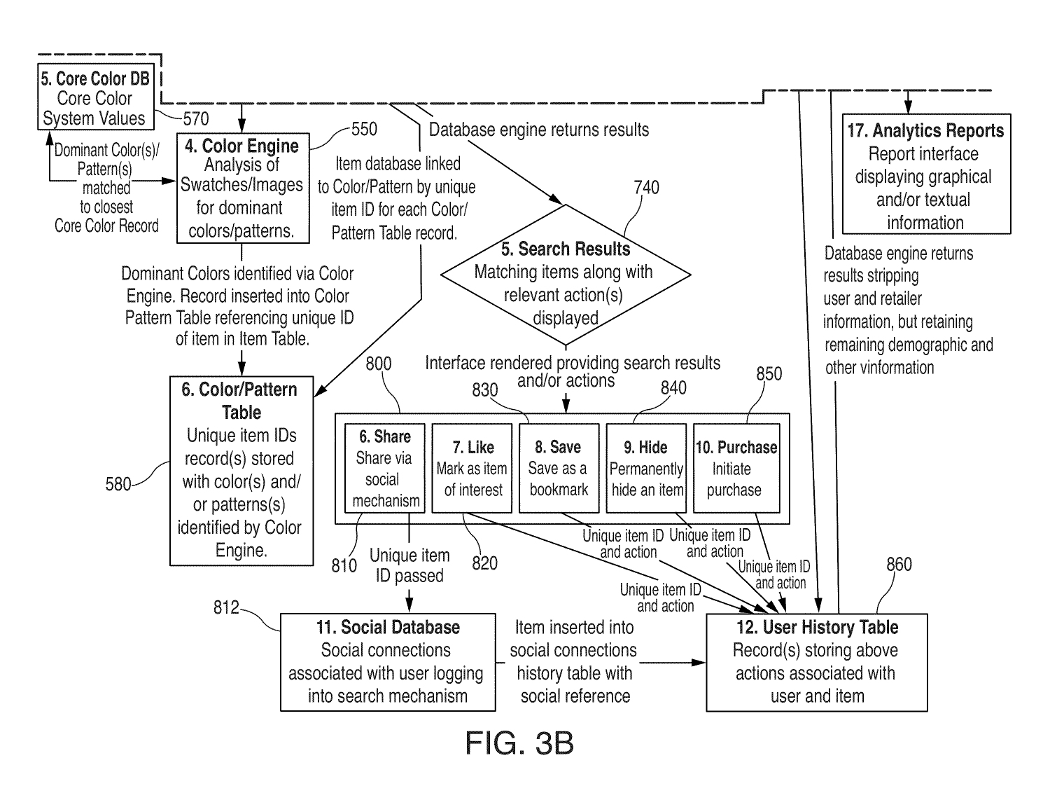

Personal information and demographic information are typically acquired from a user in the context of an initial user registration process and subsequently stored in a user history table 860 (see FIG. 3B) which contain a broad range of records pertaining to user identification and user selections. The remaining forms of user data 202 are acquired and recorded in the user history table 860 as a result of user-system interactions via a graphical user interface. These interactions will be described below in further detail.

In a preferred embodiment of the present invention, merchant data 204 includes data specifics for a merchant, such as:

1. Business name, contact name, address, telephone number;

2. Demographic information, including but not limited to, target demographics, user and merchant demographics and preferences;

3. Physical locations;

4. Inventory information;

5. Supply chain information;

6. Planogram and store schematic information; and

7. Purchase history information;

In a preferred embodiment of the present invention, product data 206 includes data specifics for products, such as:

1. Basic product identification information, including name of product;

2. Color identification information, including universal hexadecimal color code and corresponding component red, green, blue (RGB) values, color histogram and statistical information;

3. Pattern identification information, where applicable;

4. Image data, preferably in the form of a three-dimensional digital rendition of the product or another form of digital image of the product;

5. Recommendation data, including historical recommendations of products, ratings of products and advertisement data pertaining to products; and

6. Current and future product availability information.

It should be appreciated that data stored as product data 206 can be indexed and cross-referenced in a number of useful ways by associating the product data 206 with specific types of user data 202, merchant data 204 and color data 208. Thus, various types of product data 206 can be referenced and manipulated utilizing, for example, any combination of color, land location, user preference and demographic. In that way, data in the data warehouse 200 is interrelated forming a powerful tool in the context of predictive analytics.

In a preferred embodiment of the present invention, color data 208 includes data specifics for color information, such as:

1. Color identification information in the form of hexadecimal codes for each selectable color;

2. Color identification information in the form of RGB component intensities for each selectable color, with RGB intensities mapped to the corresponding hexadecimal codes;

3. Pattern identification information in the form of pre-determined pattern configurations;

4. Statistical color information, such as frequency of products that contain a particular color among selectable colors, and trending information, such as which colors are forecasted as popular colors for selected past, present and future seasons;

5. Astrological information, including colors are associated with each astrological sign;

6. Keyword information, such as frequent user-associated keywords relating to a particular color. The associated keywords may be based on (a) an original color-word association index; (b) user-defined keywords whereby a user associates colors with specific keywords; (c) pre-determined keywords which the user links with colors that the user determines are associated with those pre-determined keywords. The keywords and their color associations are stored and updated as users continue to update and create associations; and

7. Color grouping information, such as colors associated with a timeless collection or a particular trending collection (e.g., Spring 2012 colors).

Color identification information and pattern identification information are preferably maintained as a core color database 560 with individual entries corresponding to each selectable color and selectable pattern against which, in specified instances, dominant colors and patterns may be determined and associated with products after being transmitted to server 100.

In a preferred embodiment, the system, methods and interfaces described herein are designed to operate in a 4096 color environment, but on a scale which allows the system to expand to over 16 million colors using the full range of 256 color intensities (measured from 0 to 255) for each of R (Red), G (Green) and B (Blue) which yields 256³ or 16,777,216 possible color variations, and hence potential color classifications. In a preferred embodiment, the 4096 selectable colors are equidistantly spaced along the full scale of available colors. However, it should be understood that the selectable colors may be moved along the scale or added or subtracted in order to provide more or less variation in a particular color region, depending on user and merchant trends or needs.

Typically, the RGB codes or component intensities for a particular color are expressed as a 24-bit, 6-digit hexadecimal code which uses a base sixteen number instead of conventional base ten numbers, two digits for each of the Red, Green and Blue values. Similarly, colors may be expressed as a concatenation of digital values for R, G and B components of a color and assigned to a product as a color identifier. To that end, if a particular color exhibits RGB values: 189 Red: 202 Green: 220 Blue, that number is converted to a hexadecimal value BDCADC which is also used. 189 corresponds to BD in hex notation, 202 corresponds to CA in hex notation and 220 corresponds to CD in hex notation.

Referring again to FIG. 1, server 100 is also in communication with proprietary merchant IMS and SCM systems 500, which are typically closed systems that are inaccessible to the public or to third party merchants. As referenced in FIG. 2 and FIG. 3, proprietary merchant IMS and SCM systems 500 provide continuous or frequently updated (in excess of once per day) data feeds 510 to server 100, which include product data, inventory data and supply chain data. This function is performed in a closed environment, typically tailored to the requirements and requests of individual merchants.

From a merchant perspective, basic merchant information (e.g., name of company, mailing address, contact information) is requested and integrated to create a merchant account and ID. As described in more detail below, once a merchant account is created, merchants provide formatted product feeds for processing that include basic product identification, pricing information and unique color information.

Under traditional circumstances, before data on a new product entering a merchant's product line is fed to server 100, that data is initially input into a merchant's SCM system in accordance with its pre-production and supply chain management practices. The input of that information conforms to a pre-approved, customized or stock format that is suitable to the merchant's routine practices and which coincides with a format that is compatible with server 100 software implemented for subsequent processing of the data.

For example, where a new product comprises a piece of clothing, available fields for supply chain data input may include any number of relevant categories, including product type, material type, size(s) and number of units to manufacture. These data may be utilized to create a digital three-dimensional (3D) model of the piece of clothing, which, in addition to the foregoing data, can optionally be stored as product data 206. The number of fields may be expanded or contracted as desired so long as the format remains compatible with server 100 software so that the data in the field can be recognized and processed.

Significantly, fields that identify color utilizing an unmistakable, universal hexadecimal color code (or its corresponding RGB component measurements or other digital representation) are required in most instances and comprise the most preferred means to identify color(s) in which a product is produced and input into a merchant SCM to initiate production. Alternatively, fields that accept an anonymous color swatch—from which a universal 24-bit hexadecimal color code (or its corresponding RGB component measurements) can be identified by a color engine 550 via image/swatch analysis 560—may be utilized as a less preferred but acceptable means to identify color. A field for proprietary color names owned and used by merchants may also be utilized in conjunction with the foregoing color identification information, but not as a replacement.

Upon following an acceptable format and input of information, SCM data feeds 510 are transmitted and loaded onto server 100 by the merchant's SCM system 500 as soon as the product goes into production. As products are manufactured and are ready to enter inventory, the databases in a merchant's IMS and SCM systems 500 are updated to reflect available inventory of product, resulting in additional data being sent from the closed IMS and SCM systems 500 to server 100. In a preferred embodiment, once products enter merchant inventory, events are triggered to issue and release targeted advertisements, digital catalogues and other marketing tools to connect now-available products with consumer users. Where there are delays in production of product of a certain color, the IMS and SCM feeds 510 are likewise updated, which may trigger other advertising events. As available products are sold, IMS and SCM systems 500 continue to be updated, with corresponding data being sent to server 100. While the example herein references information initially input and fed to server 100 via the supply chain, it should be appreciated that information may be fed to server 100 utilizing inventory management information which typically relates to the post-production status of product.

Since information relating to products provided by different merchants is often expected to be formatted differently from one another, product and color data received from merchants must be transformed or normalized so that the information may be handled efficiently and consistently. While the information may be segmented by merchant, a merchant product table or item table 540 is created and maintained to manage, manipulate and search all of the types of information stored in product data storage 206. In practice, as formatted data from the IMS and SCM feeds 510 are introduced to the server 100, they are fed into a middleware engine 520 via an application programming interface. Generally, the middleware engine 520 is segment of software which enables the integration and management of incoming data as the data is transmitted from IMS and SCM systems 500 to server 100. In that regard, the middleware engine 520 manages the interaction between the otherwise incompatible applications residing on the server 100 and merchant IMS and SCM systems 500. While the input of the middleware engine 520 comprises the formatted IMS and SCM feeds 510, the output is normalized or transformed so that the data can be efficiently organized in an item table 530 in accordance with conventional normalization practices that are known in the computer software arts.

In a preferred embodiment, the normalization process 530 also strips away identification information which could be used to relate product information to a specific merchant. Accordingly, concern regarding access to sensitive information by competitors is effectively eliminated by removing access to the IDs of merchants from the products they sell.

After the normalization process 530 is completed by the middleware engine 520, item table 540 contains all available product information from the proprietary merchant IMS and SCM system 500, which includes a universal color identifier in the form of a hexadecimal color code, preferably along with component RGB values.

There are instances in which merchant IMS and SCM systems 500 and formatted feeds 510 will not contain the appropriate hexadecimal color identification required to classify a product by one of the available, selectable colors. These instances may arise as a result of previously adopted color naming conventions by a merchant or as a result of merchant-vendor practices which are ostensibly incompatible with assigning a universal color code to a given product via the merchant's IMS and SCM system. Under these circumstances, formatted feeds 510 are fitted with an available data field into which an anonymous, preferably digital, color swatch alone or in combination with a merchant color name (or names) for that swatch may be inputted by a merchant.

After the color swatch is formatted and incorporated into the feed 510, it is sent with the rest of the available merchant product data to server 100 where it is transformed or normalized 530 by the middleware engine 520 and then introduced to color engine 550 which performs an analysis of the color swatch 560 to determine its dominant color(s) (and pattern(s) where applicable). As referenced in FIG. 2 and FIG. 3, primary functions of the image processing module or color engine 550 are to gather and process the available color and pattern data in an image or color swatch presented via the proprietary merchant data feed 510 and to store the color and pattern data as product data 206 560. Thus, the color engine 550 serves as a “reader” of both colors and patterns on behalf of merchants, enabling the system to directly determine the colors and patterns of a product in a given image when that information is not provided via the formatted feed 510. Whether in the form of a color swatch or complicated image of a product, its color and patterns can be “read” by the color engine 550 and introduced to the data storage warehouse 200.

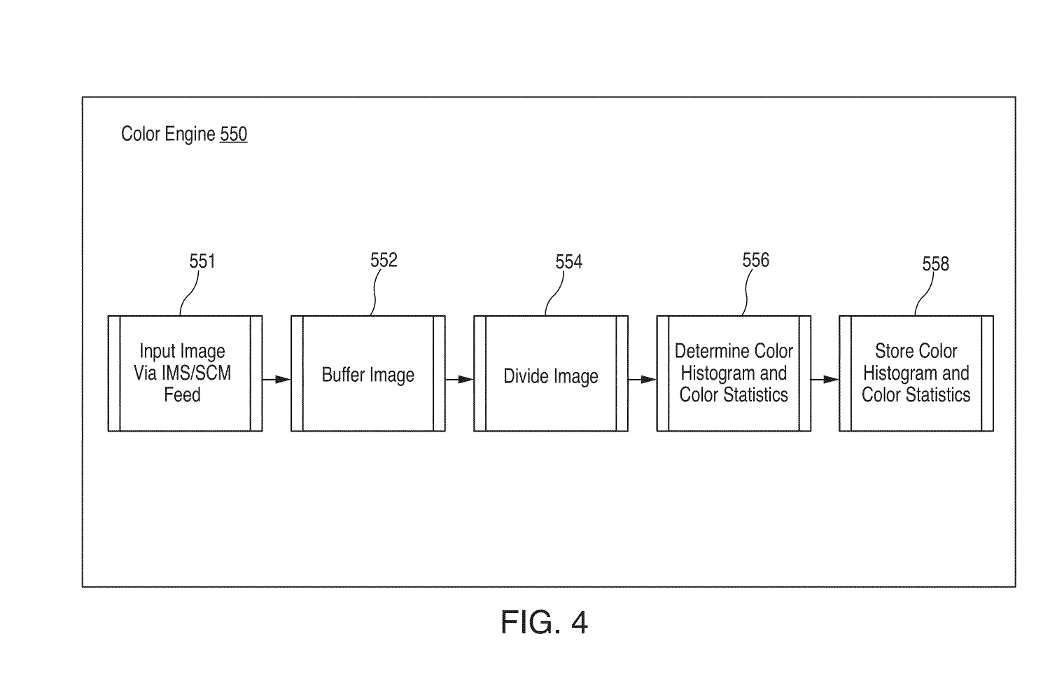

With reference to FIG. 4, the color engine 550 comprises software which analyzes images or swatches 560 in a series of steps which are used to determine the color and/or pattern of a product presented via the formatted data feed 510. The universal color identification information obtained as a result of the analysis is then stored as product data 206. More particularly, the color engine 550 initially receives an anonymous swatch or image 551 as a normalized data input. After receiving the input, the normalized image is then buffered 552 and potentially divided into a plurality of sub-images 554 for purposes of accurately determining component color(s). Thereafter, numerical color values (e.g., RGB and hexadecimal values) associated with those sub-images are determined 556, as well as color histogram and statistical data that may include detailed RGB band information, including the mean, standard deviation and minimum value and maximum value associated with each of the RGB bands.

Once the color data for the swatch are determined 556, the image is associated with a matching color—and most optimally the identical color—that is available in the core color database 570. Where the determined color from the image analysis is not precisely the same as an available color (i.e., one of the 4096 colors) in the core color database 570, the candidate color that is selected is the closest one of the available colors in the core color database 570, as determined by the formula c=sqrt((r−r₁)²+(g−g₁)²+(b−b₁)²), wherein c=closest color; r=first red value; r₁=second red value; g=first green value; g₁=second green value; and b=first blue value b₁=second blue value. Using component RGB values for the candidate colors and known color from the processed image, the closest candidate color to the known color present in the processed product image is the color that yields a value where c is closest to 0. (A value of c=0 means that the colors are the same.)

Once a candidate color is selected as a result of the image analysis 560, a record is created in a color-pattern table 580 which utilizes a unique item or product ID of the product listed in the item table 540 to link a given product provided by a normalized IMS and SCM feed 510 to the candidate color present in the color pattern-table 580 as a hexadecimal code (and component RGB values). This method syncs 590 the normalized IMS and SCM data feeds 510 having converted color fields to the rest of the system, thus establishing a universal color identifier for product that was input into the server 100 without one, and enabling product and its associated color information—input via proprietary IMS and SCM systems 500—to be searched, codified, and dynamically analyzed.

Notably, current and outmoded color conventions and identifications of merchants (the feeds from which do not possess a universal hexadecimal/RGB color code) may be reverse mapped without fundamentally damaging or totally eliminating those merchants' own color naming preferences. Thus, in addition to the system's own color classification, a color, for example, that is identified with RGB code 255 Red: 0 Green: 102 Blue and corresponding hexadecimal code FF0066, may also be identified in the color storage database and/or merchant database using the particular merchant's own unique name or alias, such as “flamingo pink.” Likewise, other merchants that wish to assign their own alias to that very same color may do so using a different name. Regardless of the number of aliases applied to the particular color, the key is that all are codified and searchable using the standardized RGB and/or hexadecimal values assigned to the color.

By reverse mapping all major merchant color systems into one universal color system, a significant hindrance to user searching for and finding products from different merchants is resolved. Reverse mapping enables dynamic analysis and codification of precise color. When layered into proprietary merchant IMS and SCM systems, the search is further enhanced as it is no longer requires scraping the Internet. Likewise, issues associated with merchant product planning and production are ameliorated by providing them with standardized color information on sales, searches and availability.

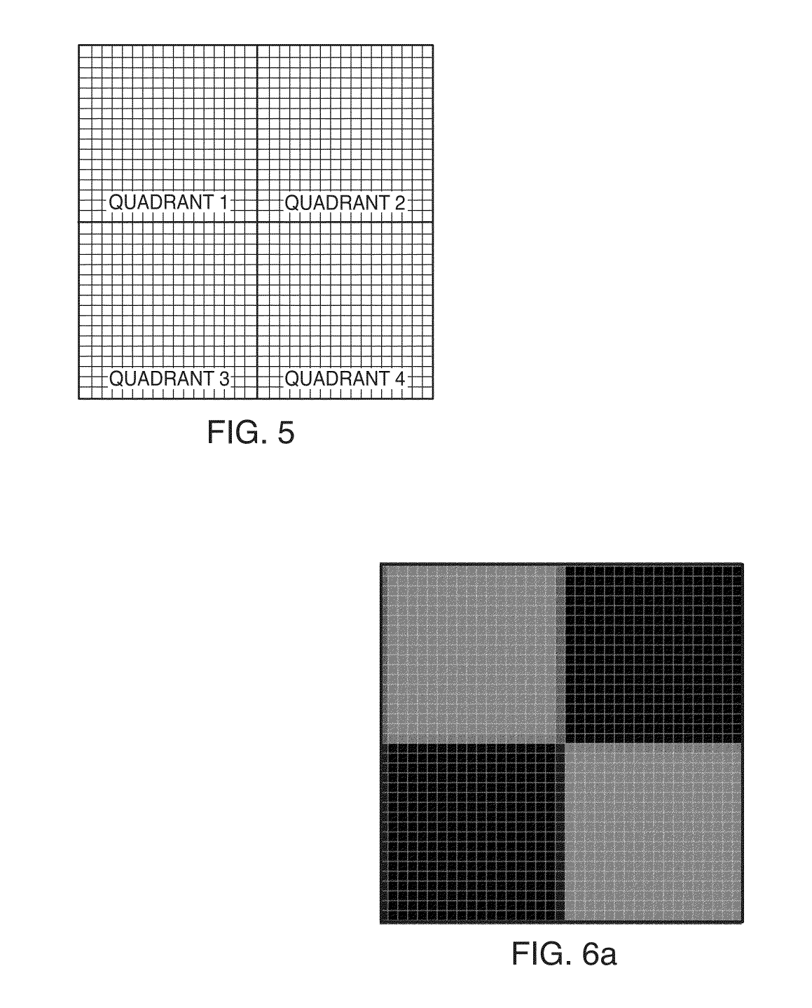

While swatches or images that contain a single dominant color are intuitively easier to classify by color, there are many instances where an image must be parsed further to make accurate color and pattern determinations. Thus, at times, dynamic image analysis 560 is more intensive, requiring an image to be manipulated by subdividing the image 554 into four or more sections (e.g., four-quadrant grid, subdivided into a 16×16 cellular network) as shown in FIG. 5, where additional detail and analysis may be required to determine the most appropriate color to be associated with the image. In still other embodiments, the subdivisions carried out may be performed successively such that a given cell or sub-image may be further broken down into another grid, or another set of sub-images. Successive breakdowns of images are typically beneficial in recognizing more complex patterns or images with various combinations of colors and patterns. Such determinations with respect to pattern are made by determining and analyzing the frequency, quantity, and repeat of colors used within an image. Accordingly, in addition to color determination, patterns in an image, such as stripe, checkered, hounds tooth, paisley, can be isolated and identified. When that occurs, the divided parts of the image are “read” to determine the dominant color(s) and pattern(s) appearing therein. With respect to color, the dominant color is determined by identifying the color values across all pixels in each of the cells of the grid, including mean values and standard deviations. In a basic example where an image or swatch would naturally be identified with a single color and no pattern, the color appearing the most across all cells is the color with which the image is identified, using the color's hexadecimal value and RGB values. Typically a 5-15% color variance is permitted along each of the bands when determining color dominance in a particular image. This allows for color variations in an image that are based on lighting conditions and shading, but not due to the presence of a different color in the image. Of course, it should be understood that a similar process may be utilized to determine that multiple dominant colors are present in a single image, particularly when there are stark color contrasts in an image and increased frequency of two or more distinct colors.

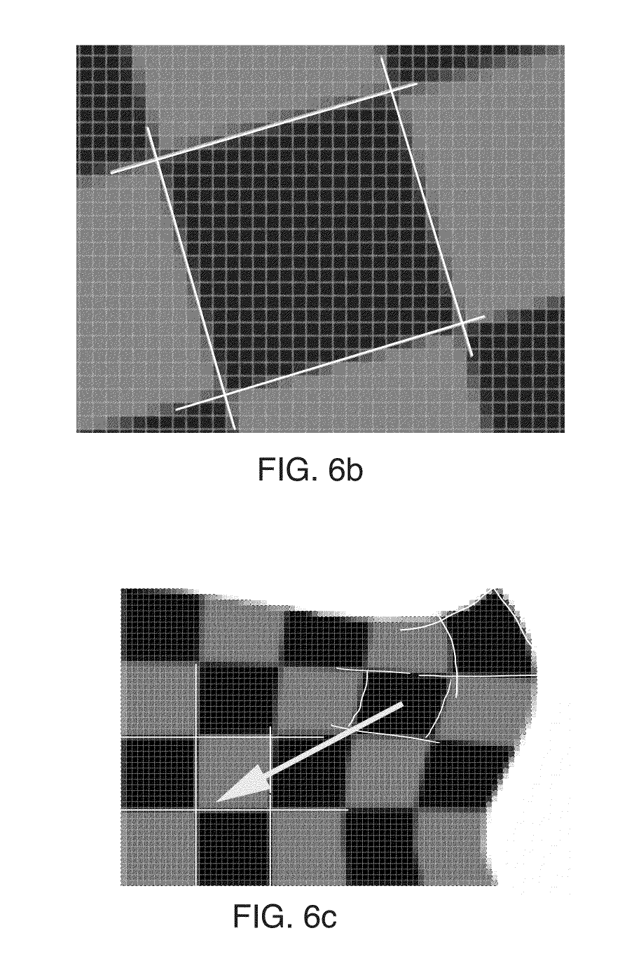

With respect to pattern recognition, such as the basic checkered pattern shown in FIG. 6a, prior to assigning a RGB value or hexadecimal value to the pattern or its constituent colors, the pattern must first be defined against a predefined set of patterns maintained in the core color database 570. In this instance, a red and black checkered pattern is presented for pattern and color determination. When analyzing the pattern, the program determines the proximity and repeated frequency of two or more colors. For example, where the first color that is detected in a 3×3 pixel/unit square is next to another color that is detected in a 3×3 pixel/unit square, then followed by the first color in the same configuration, the system determines that the pattern is a checkered pattern and assigns a “checker” value to the image. After the pattern is defined and classified with a pattern value, the colors detected within in the pattern (in this case a checker pattern) are identified. Thereafter, the image is assigned values corresponding to the dominant red and black colors appearing in the image.

With reference to FIG. 6b, utilizing the same red and black checkered pattern, the software instructions implemented herein also account for patterns that are rotated somewhat within the processed image. In this instance, even though the border between the red and black colors appears somewhat jagged when the image is processed, the borders are perceived as a straight line with a 90 degree angle separating the edges of the same color. With that information, the module determines that the image is a checkered design of red and black.

With reference to FIG. 6c, utilizing the same red and black checkered pattern, the software instructions implemented herein also account for patterns that are somewhat distorted or stretched within the processed image. In this instance of image distortion, the software divides the image further into smaller areas until a pattern is recognized. In this case, with sufficiently small areas, the module determines that the image is a checkered design of red and black. The quantity of regions in the initial or later division(s) may be based on the digital size of the image or swatch, on a defined quantity, historical analysis or another conventional basis well known in the field of image recognition.

Successive subdivisions of a given image or swatch are performed in order to formulate a more precise representation of the color and pattern values which are present in the image. Without this process, an average color value of an entire image may be determined. However, the color value associated with the image would in many instances be an extremely poor representation of the actual colors in the image and of the product therein. Indeed, in some cases, where a given image contains many different colors, the average color value of the entire image that would be determined may yield a grayish tone as opposed to distinct colors that formulate the image. Thus, in the method of the present invention, the image is subdivided and each subdivided section is analyzed independently from the others. In the preferred embodiment, the subdivision of images into large cellular networks enables more accurate and precise representations of the color values (e.g., color histogram and color statistics). Depending upon aspects such as similarity in colors in sections or analysis of previous images provided by the same user, different grids might be used.

In a preferred embodiment of the system, a basic selection of patterns such as, checkered, striped, paisley, polka dot, floral, are provided for classification purposes. These patterns can be identified and associated with products when product images are analyzed and processed. As the system is populated with product, it would be desirable to incorporate sub-classifications of each of the patterns to provide more robust classification and search options.

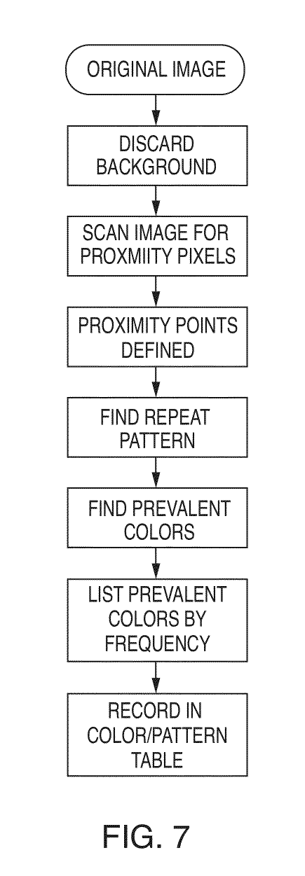

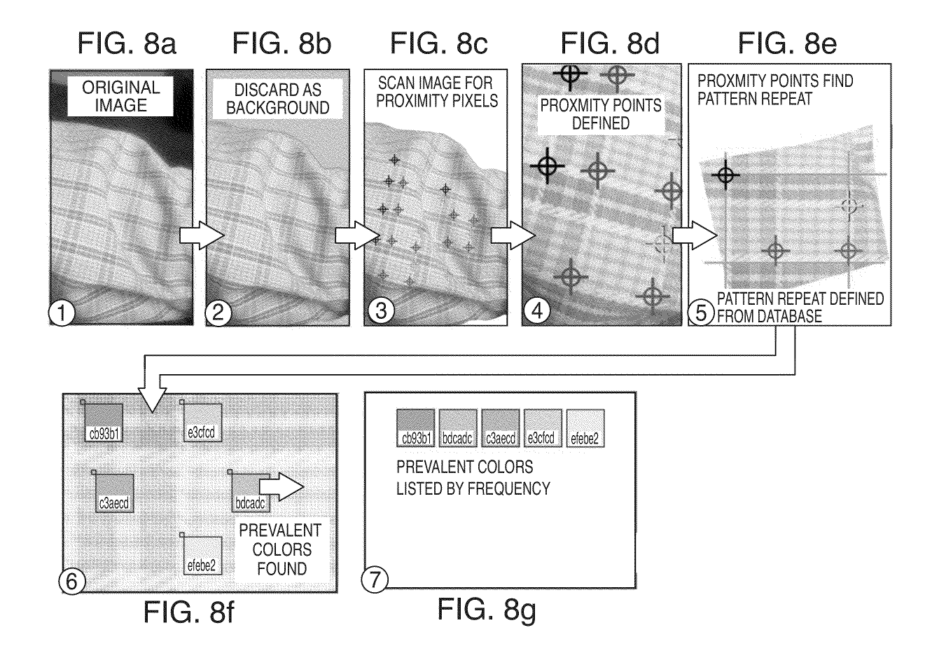

With reference to FIG. 7 and FIGS. 8a through 8f, another colored pattern is presented as a digital photographic image or swatch of a shirt for processing and recognition. After the image is presented, the relevant product pattern and color are isolated from the rest of the image, with the irrelevant portion of the image being deemed “whitespace” and discarded. The image is then scanned for proximity pixels and proximity points are defined. Once the proximity points are defined, the image is searched for patterns utilizing pattern repeat parameters defined in a pattern database. Depending on whether and the extent of distortion of the pattern of the product appearing in the image, the image is further subdivided until a pattern can be determined. Once the pattern is determined against a predefined set of patterns, prevalent or dominant component colors are identified. The identified colors are listed by hexadecimal value by frequency of the color appearing in the image. In this case, the five colors are identified on the hexadecimal scale as CB93B1, BDCADC, C3AECD, E3CFCD and EFEBE2. After all of these colors and the pattern are identified, they become associated with the particular shirt that is integrated into the product data 206.

When analyzing patterns of multiple colors such as the one shown in FIG. 8a, colors are identified by sampling selected spots in a given region. When the sampling indicates that more than one color might exist, further sampling and/or more refined divisions may be implemented, and may continue iteratively as necessary even until the divisions, the samples, or both, are as small as a single pixel. The choice of sizing or subdivisions may be based on the quantity of colors identified in a region, the deviation of values of the colors in a region (as compared to a predetermined threshold), or some other criteria. Each region's color values are then analyzed, potentially on a pixel by pixel basis. In addition, each sampled location of each region is recognized and is stored via X,Y coordinates (together with its color identifying information), and each region is assigned one or more color values based on the observed or determined color or colors. A change in color can be recognized when a certain parameter changes by more than a fixed threshold, such as 15%. As a result, a virtual map which depicts colors in positions can be built to indicate where color changes occur and, in aggregate, a pattern can emerge. By identifying each region's color and the location of each region relative to the entire image, patterns are determined, typically using pixel geometry techniques that are known in the art. Once the patterns and colors are determined, identifying numerical values are assigned.

Following the consumption of normalized data from SCM and ISM feeds 510 and color assignment utilizing universal hexadecimal color identifiers, a number of merchant tools are enabled which pertain to predictive analytics 610, a B2C platform which includes a digital personal shopper application 620, advertising to consumers 630 and other applications 640. Notably, these tools leverage the ability of the system to capture codified color data from a plurality of customized proprietary IMS and SCM systems 500 previously available in the prior art.

By integrating a universal color identification technique into proprietary IMS and SCM systems, available color data can be dynamically analyzed and integrated to enable merchants to make color-based decisions and recommendations on a real-time basis that were heretofore not practical or, at best, based on incomplete information. With respect to supply chain management, inventories of products by particular colors can be managed and prioritized and decisions to replenish inventories can be effected sooner by triggering manufacturing and distribution as soon as, for example, certain sales thresholds are met, inventories dip below a particular level and/or additional consumer need is identified beyond current supply plans and capabilities. Moreover, merchants can also advertise and give information users on expected availability using available supply chain management information. Similarly, such information can be used to allow users to pre-order products. On the inventory side, inventories of available products can be kept more stable by promoting products based on current and near-term availability. Furthermore, where a particular color for a product is unavailable, default settings enable recommendations to be made of the closest matching color. Thus, product search and recommendations can be made considering both current and future inventories.

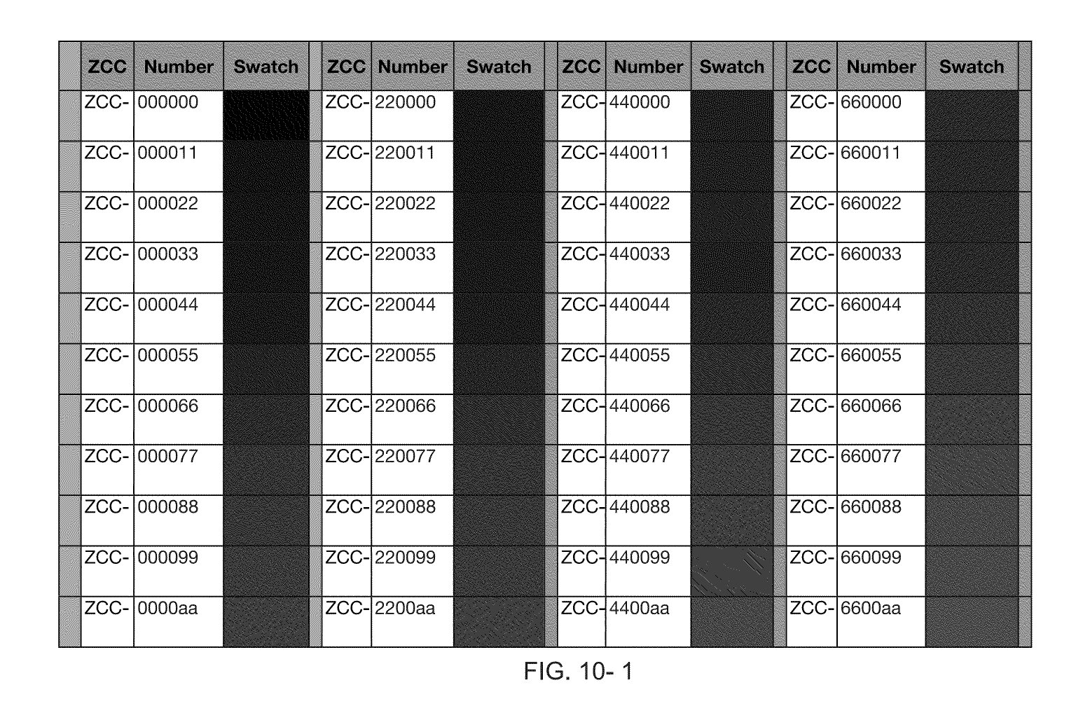

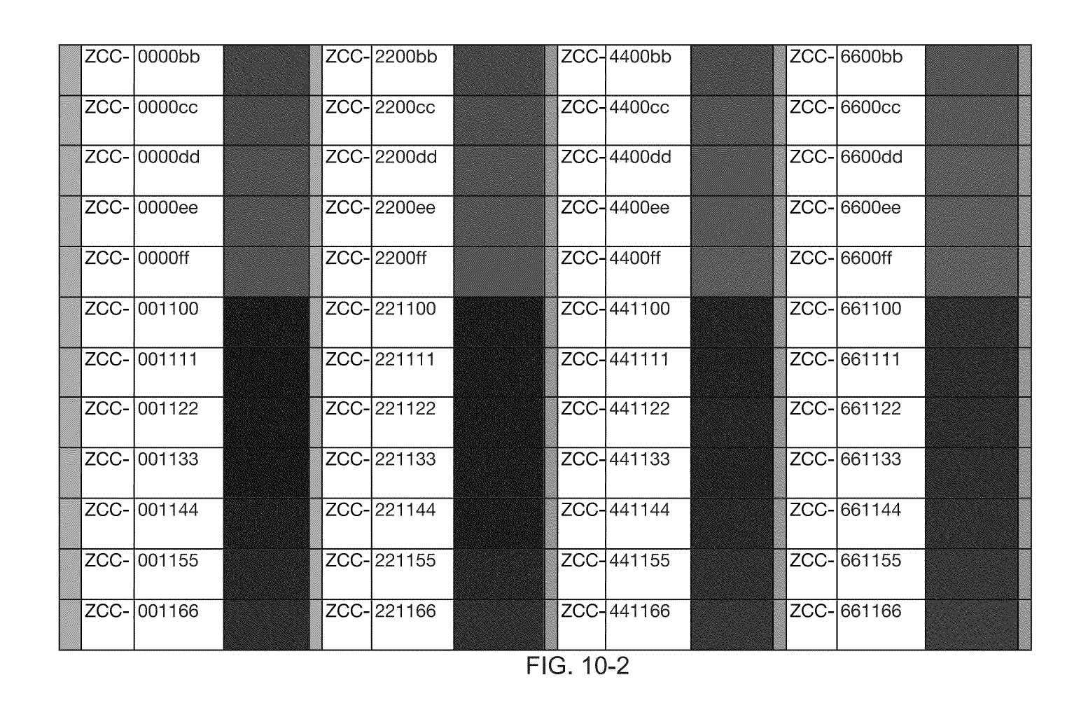

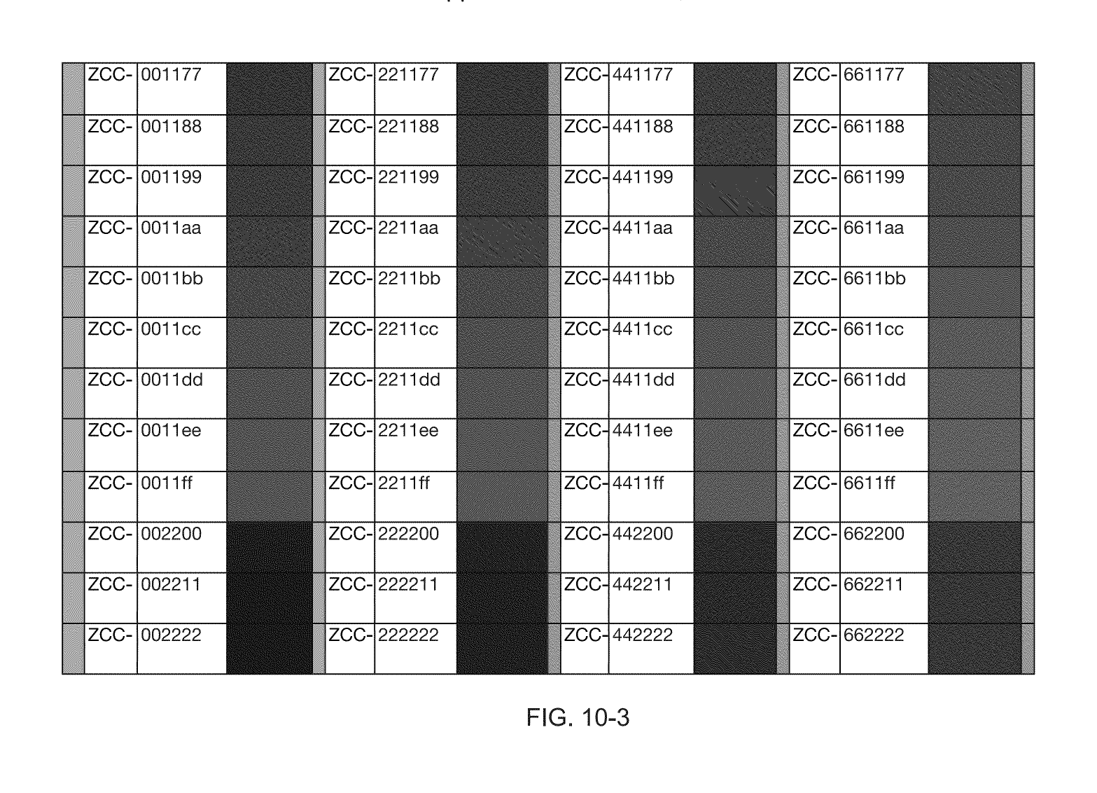

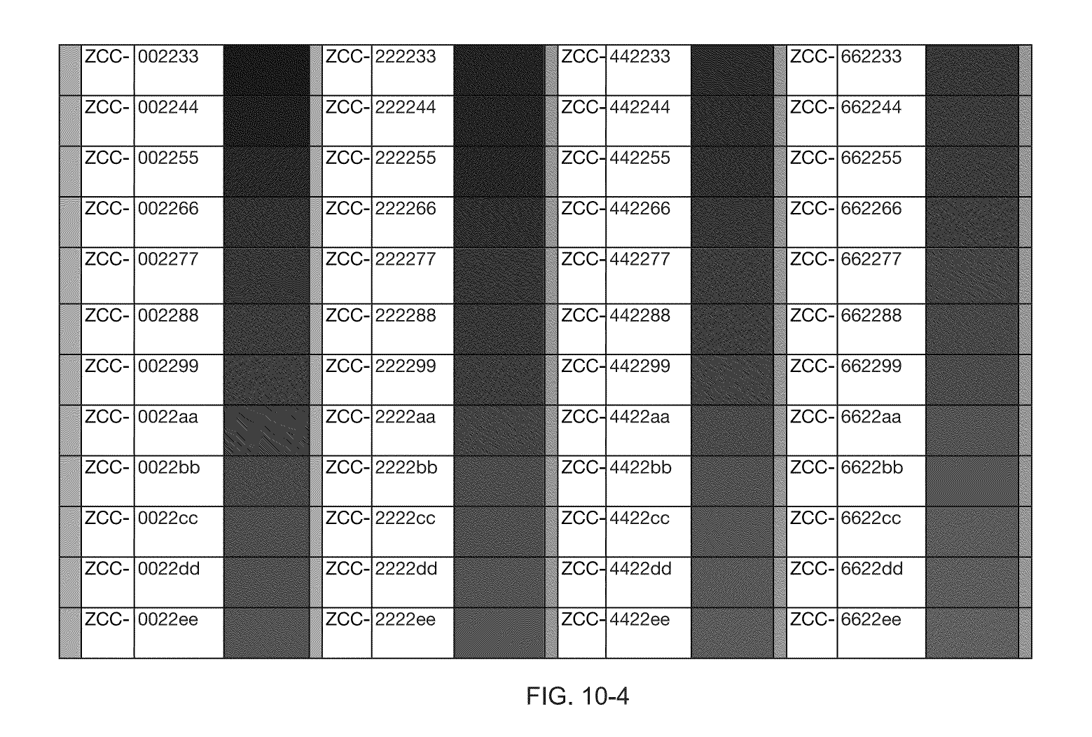

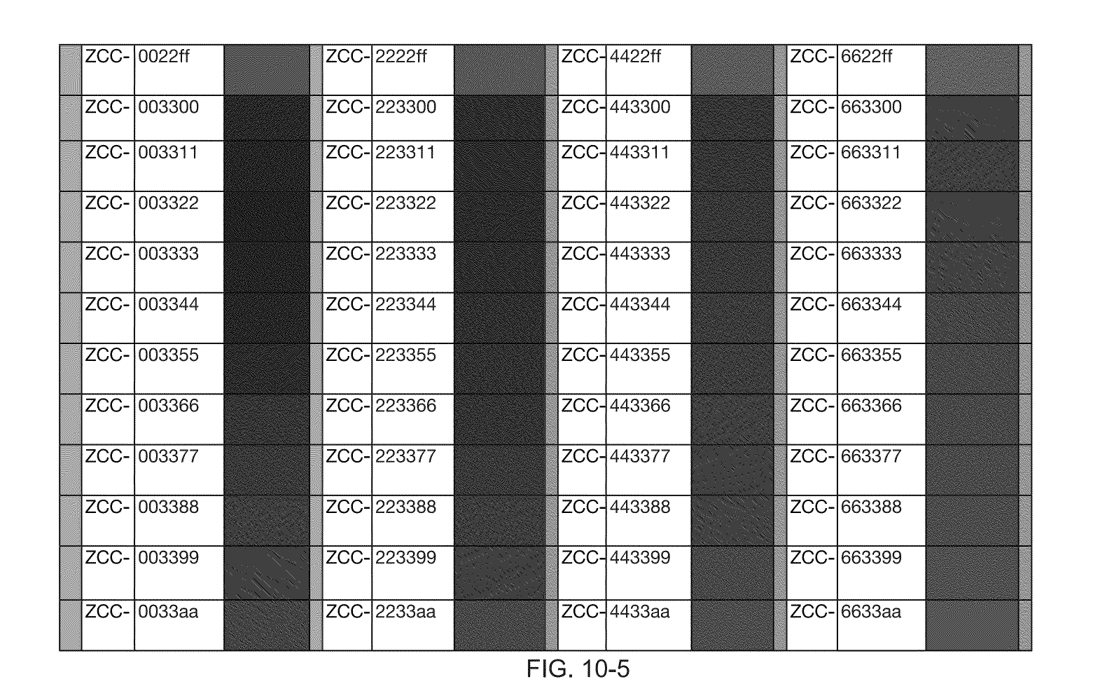

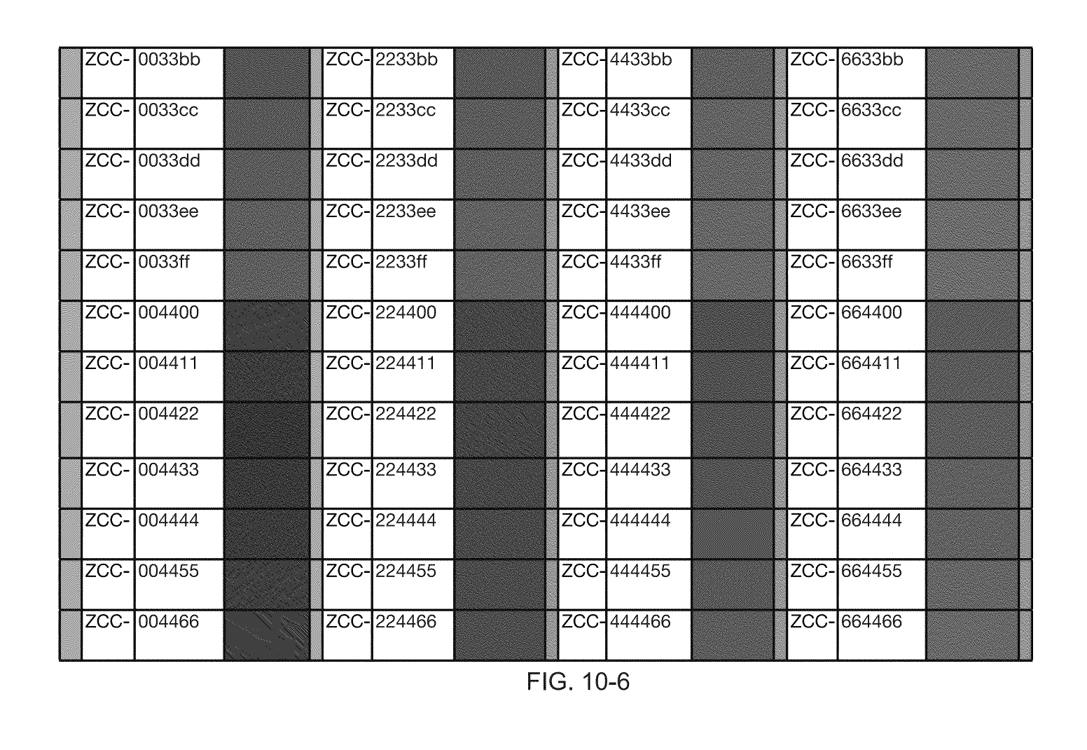

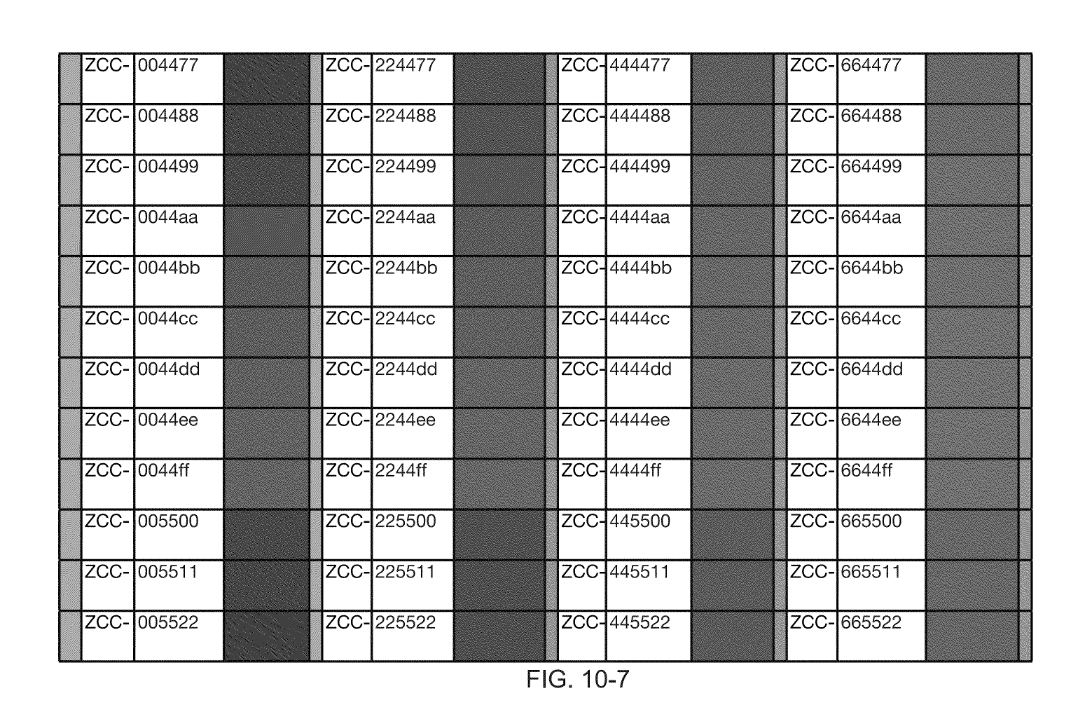

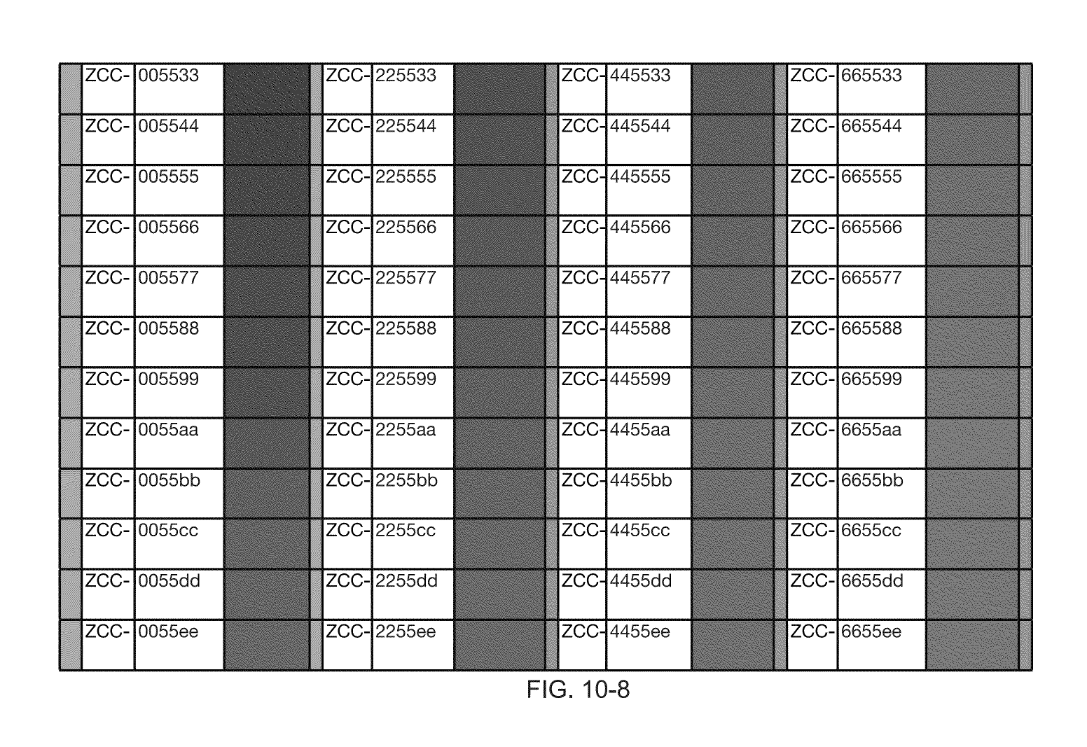

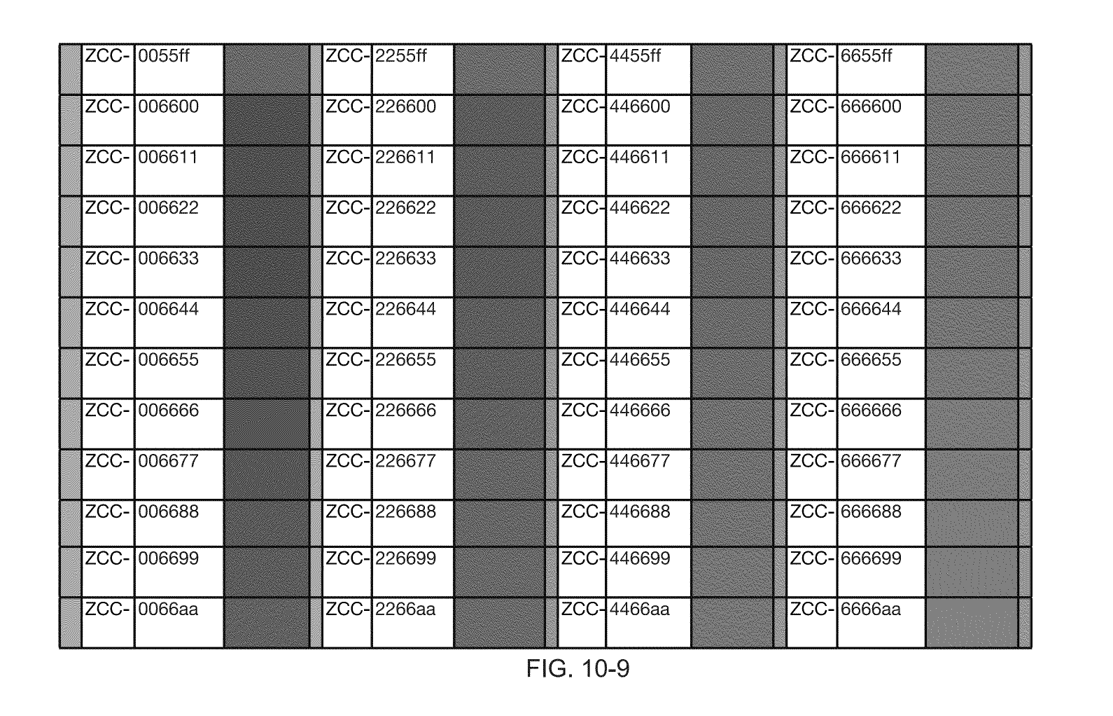

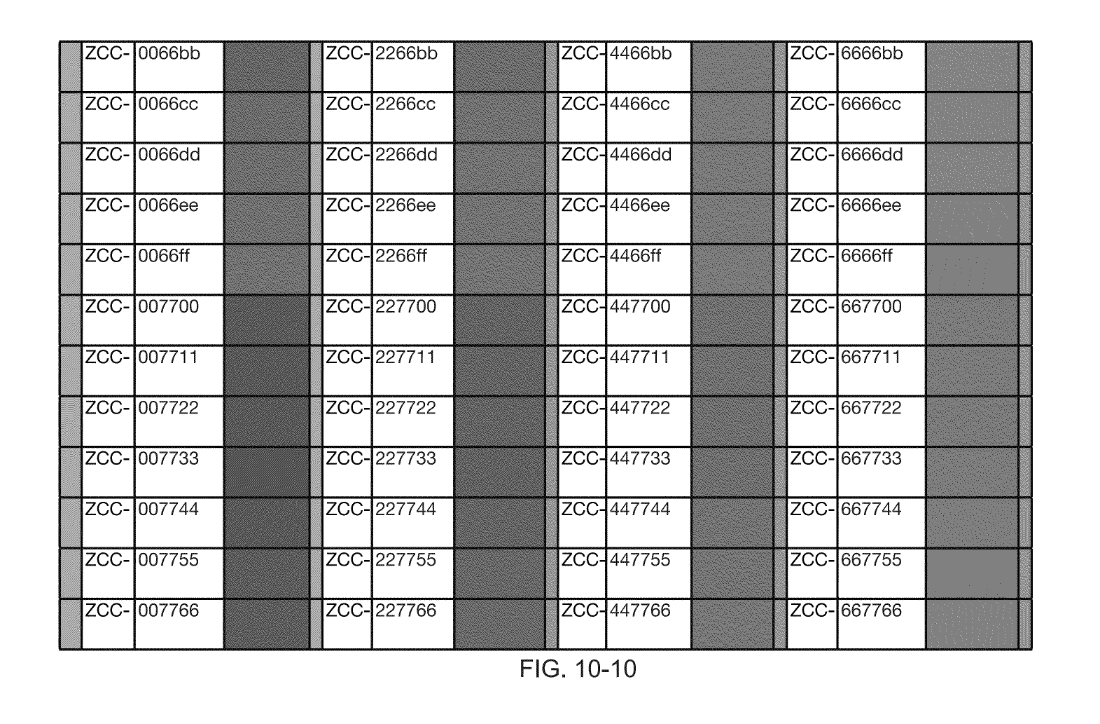

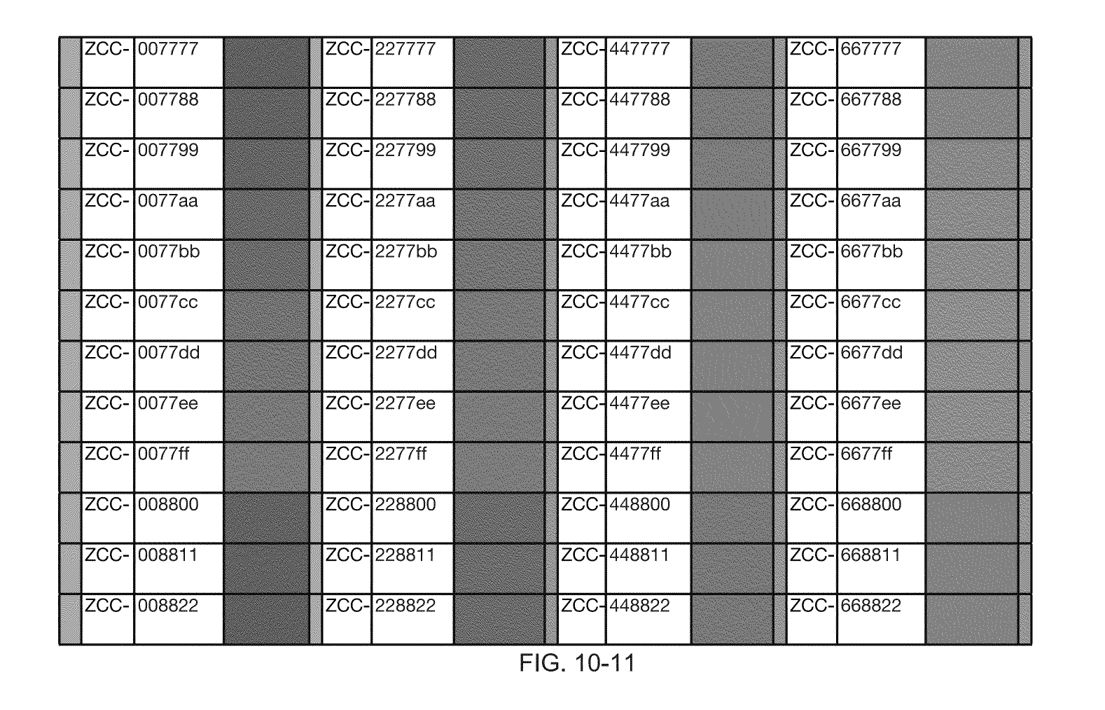

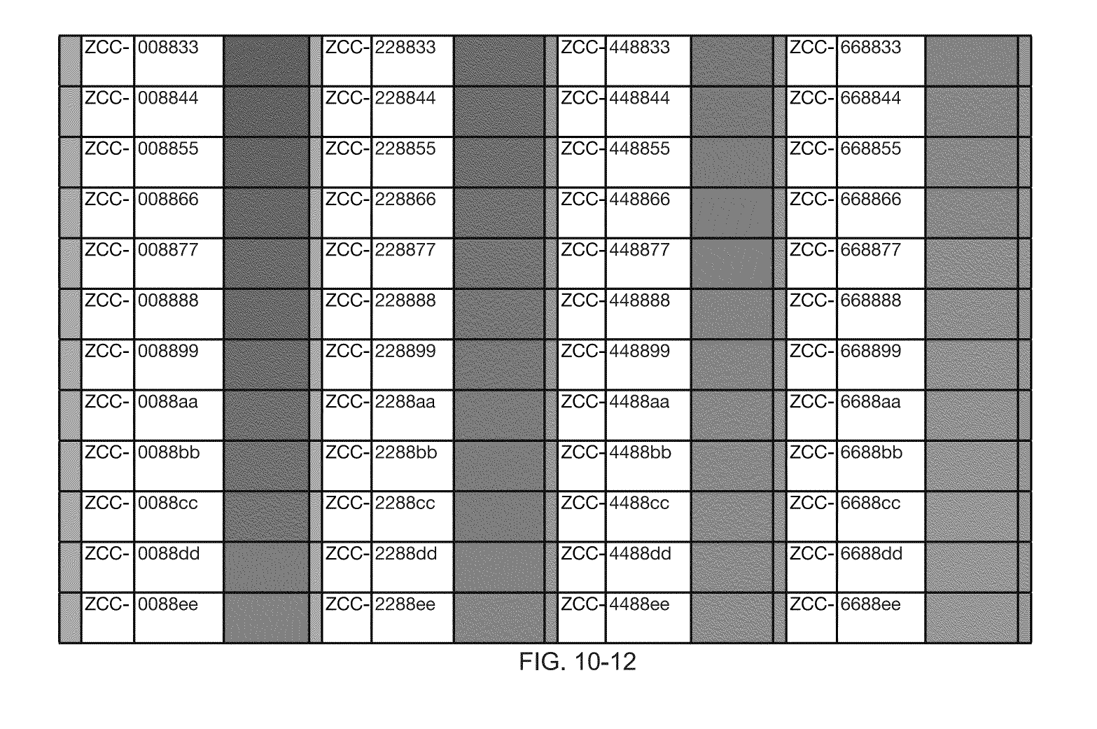

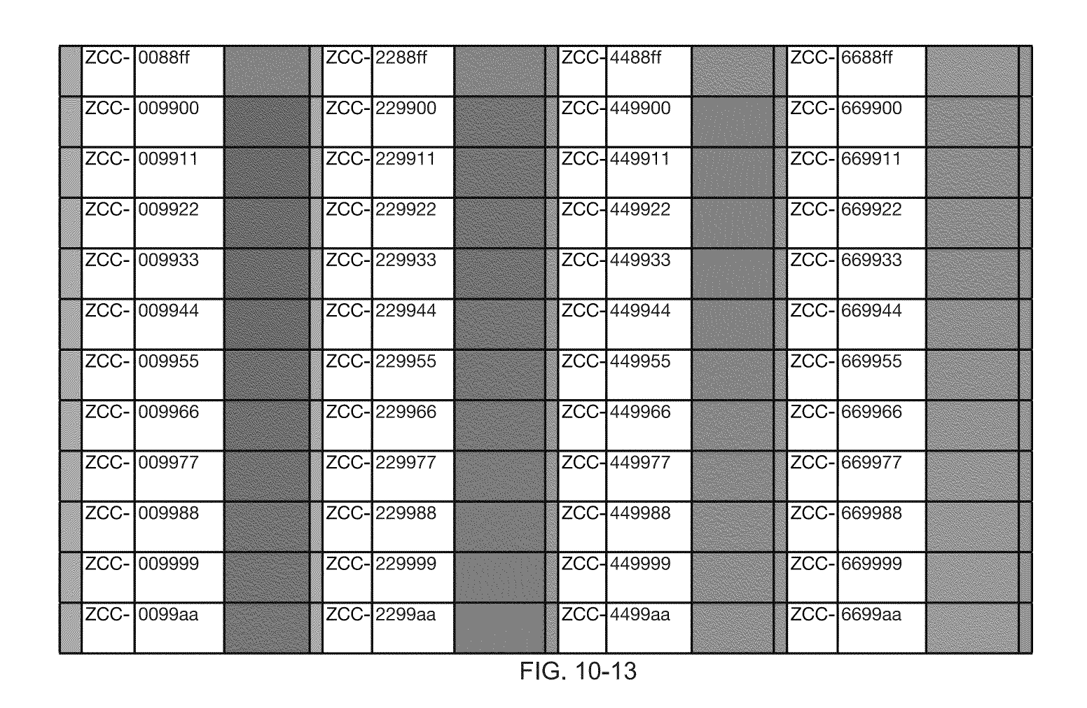

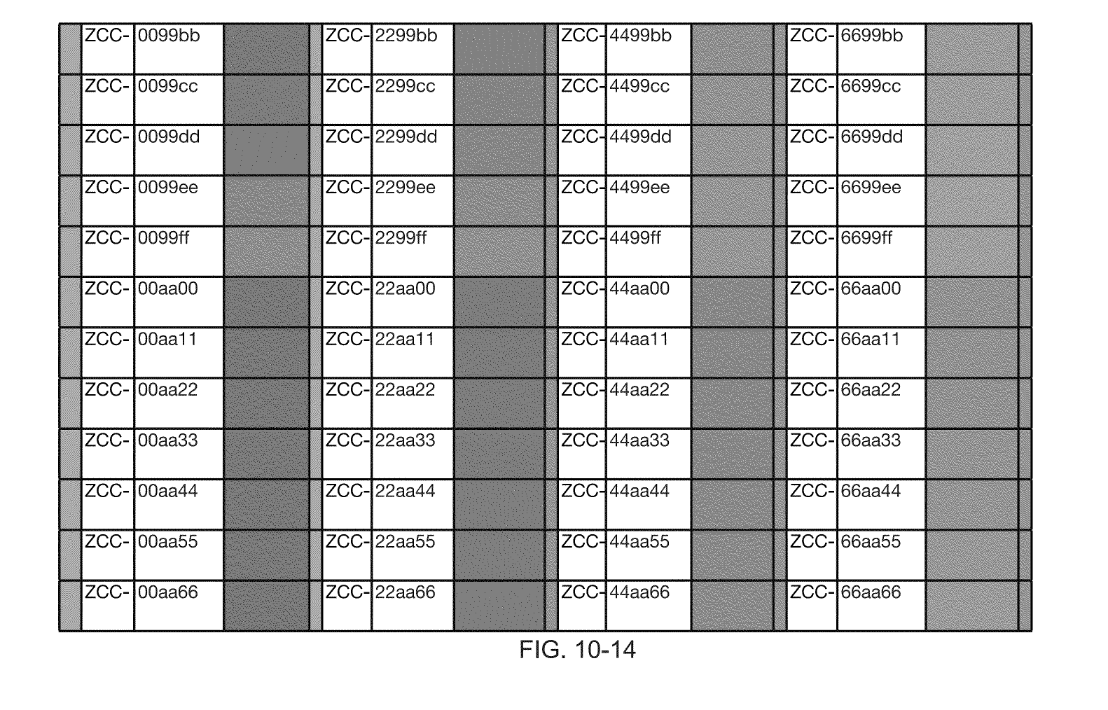

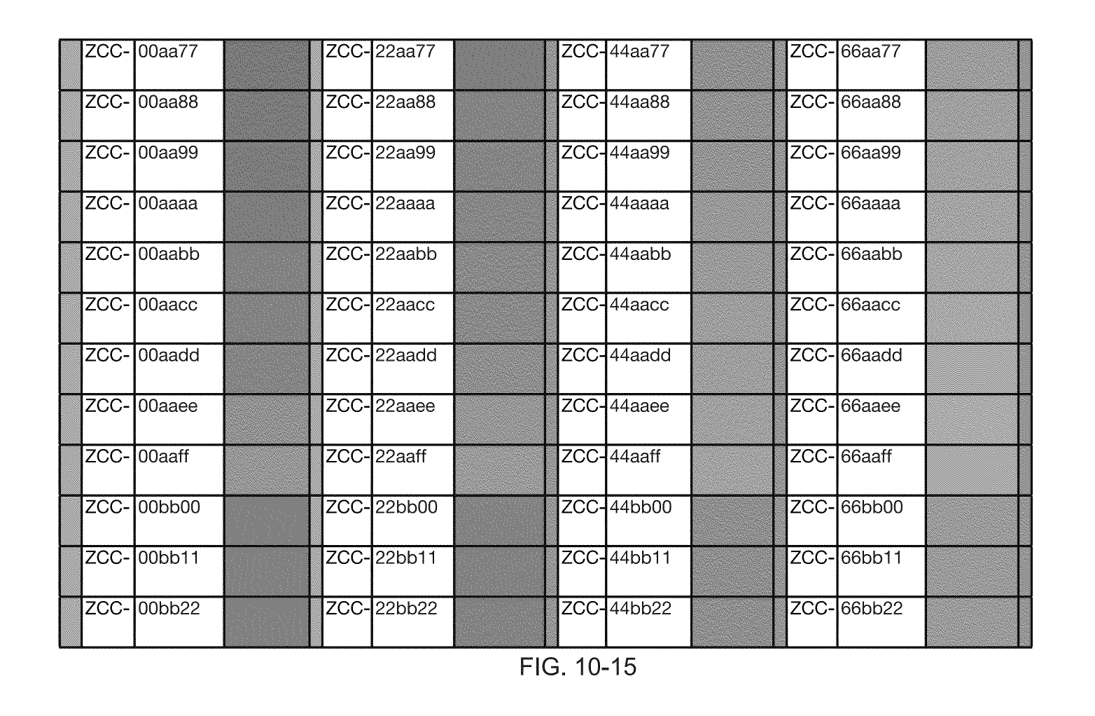

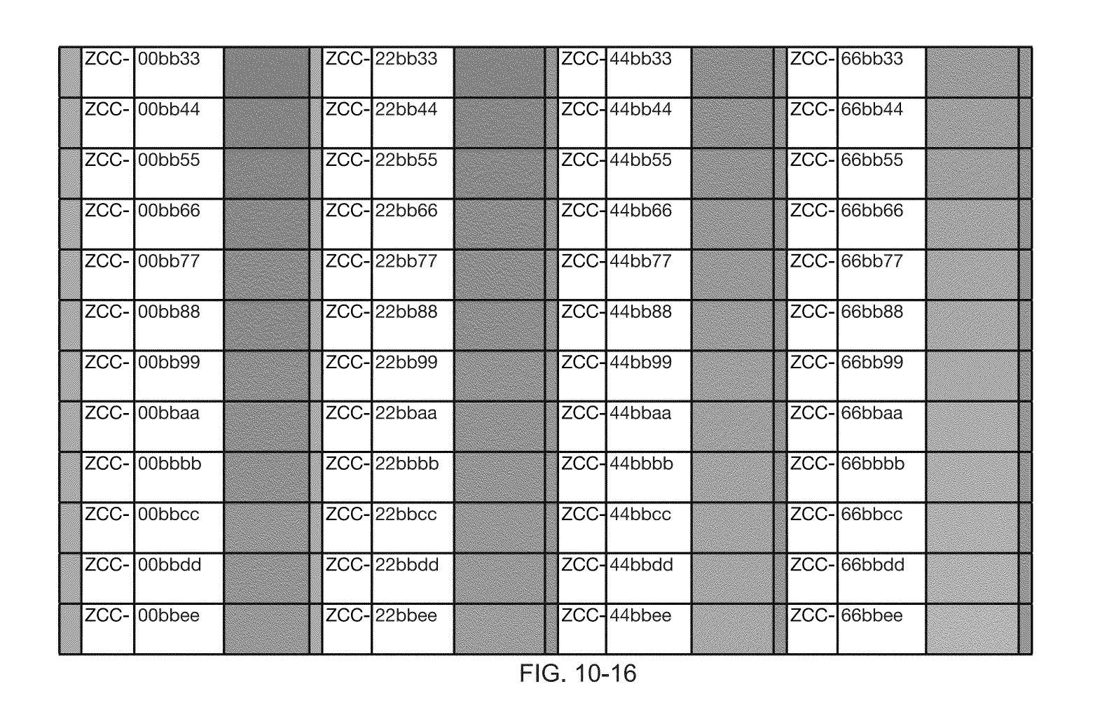

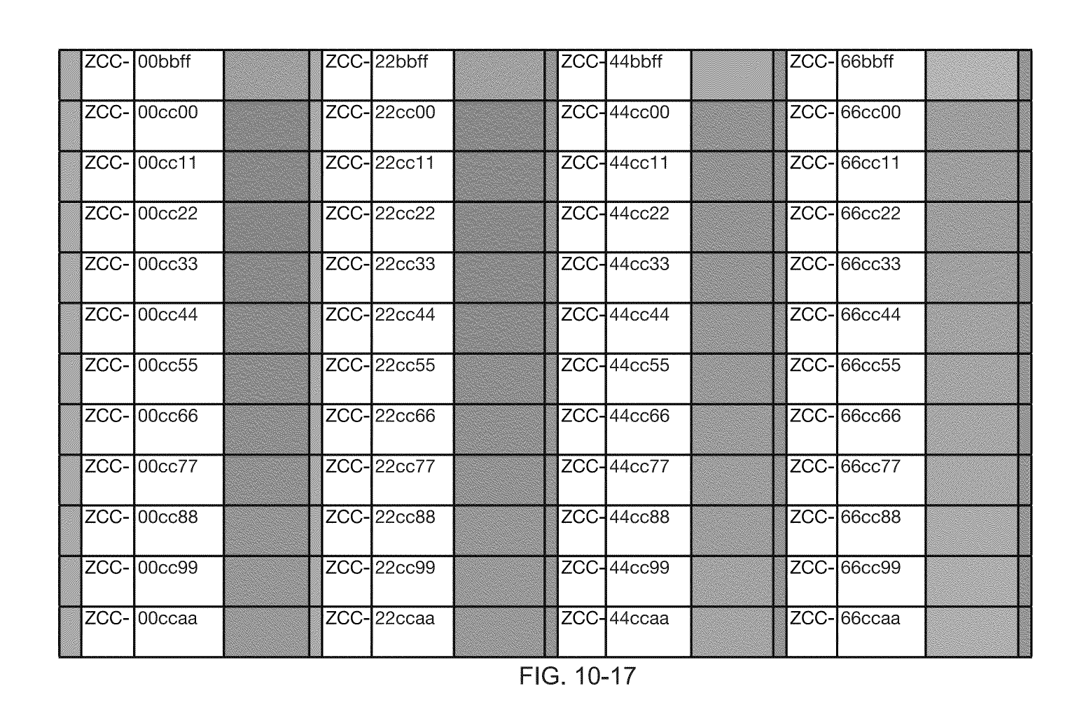

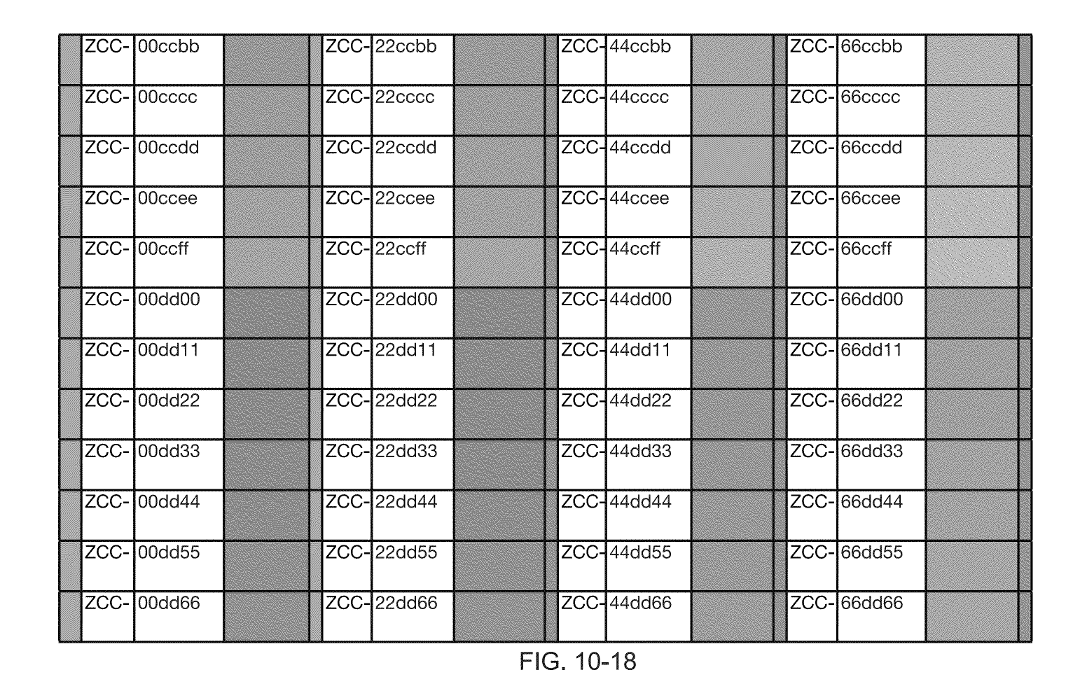

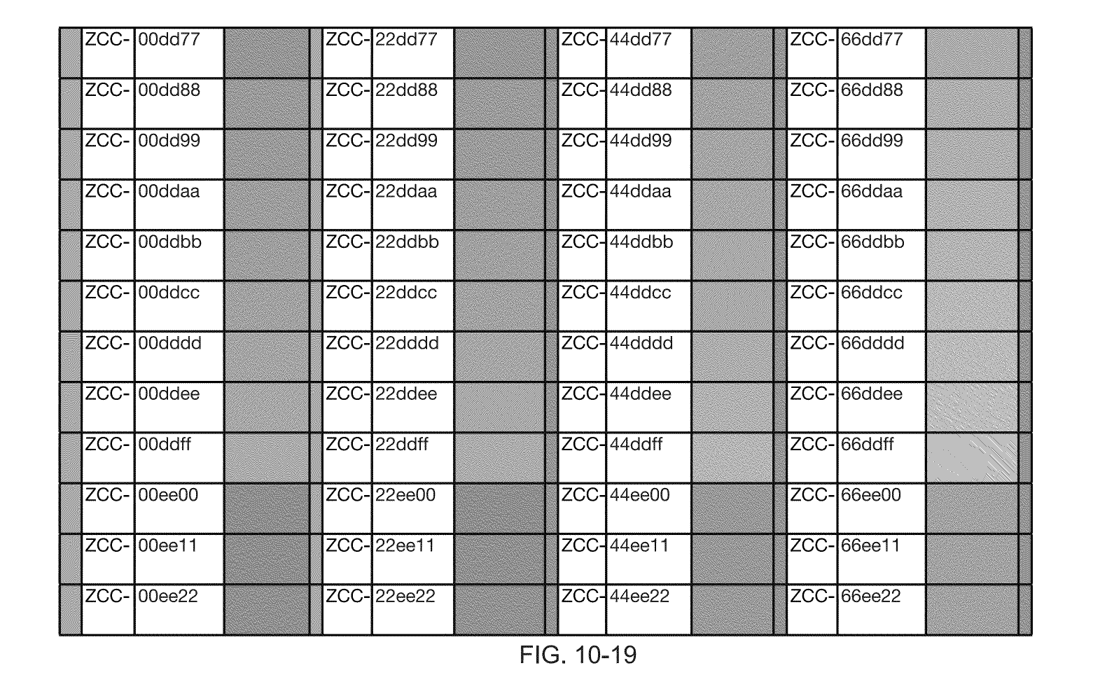

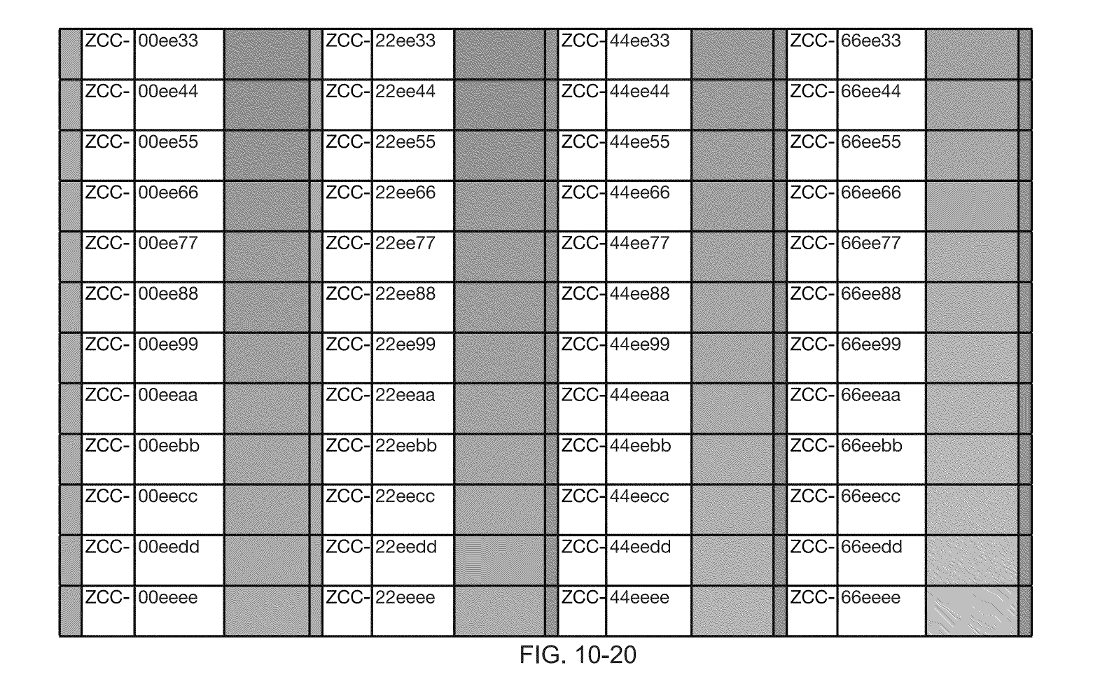

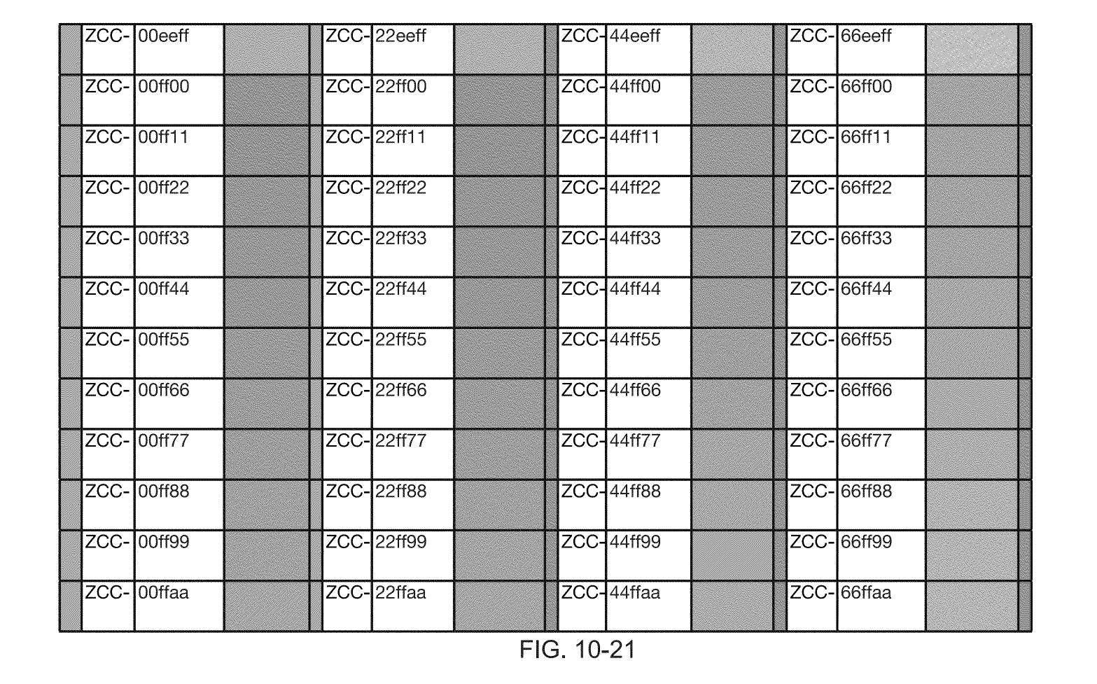

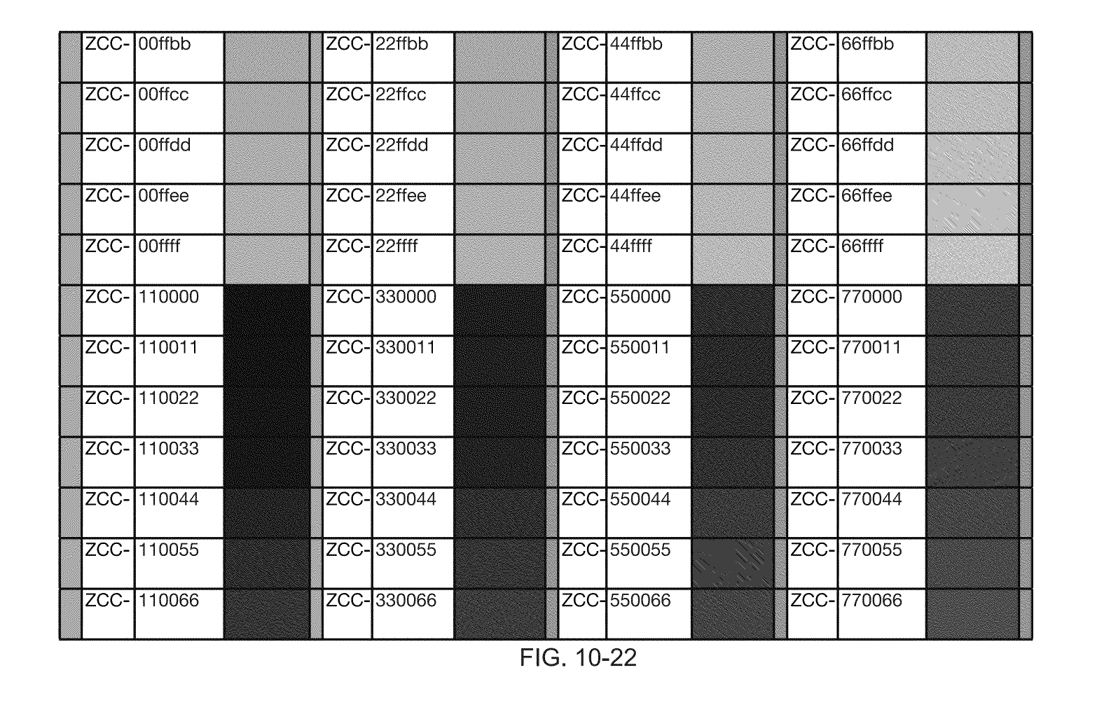

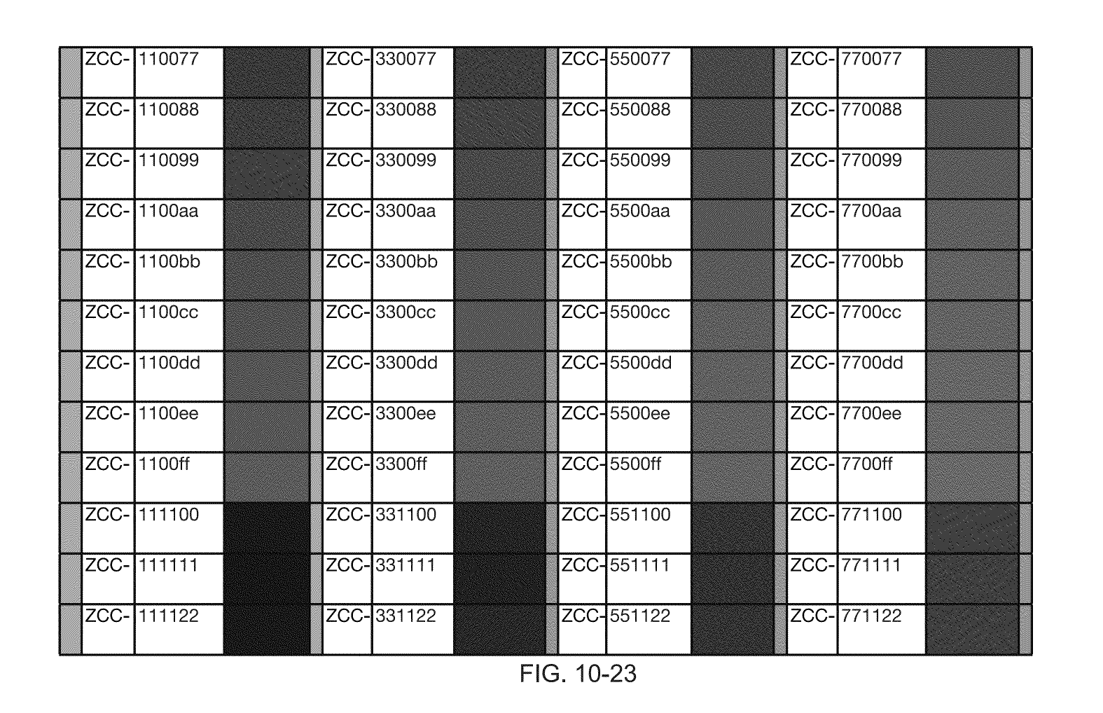

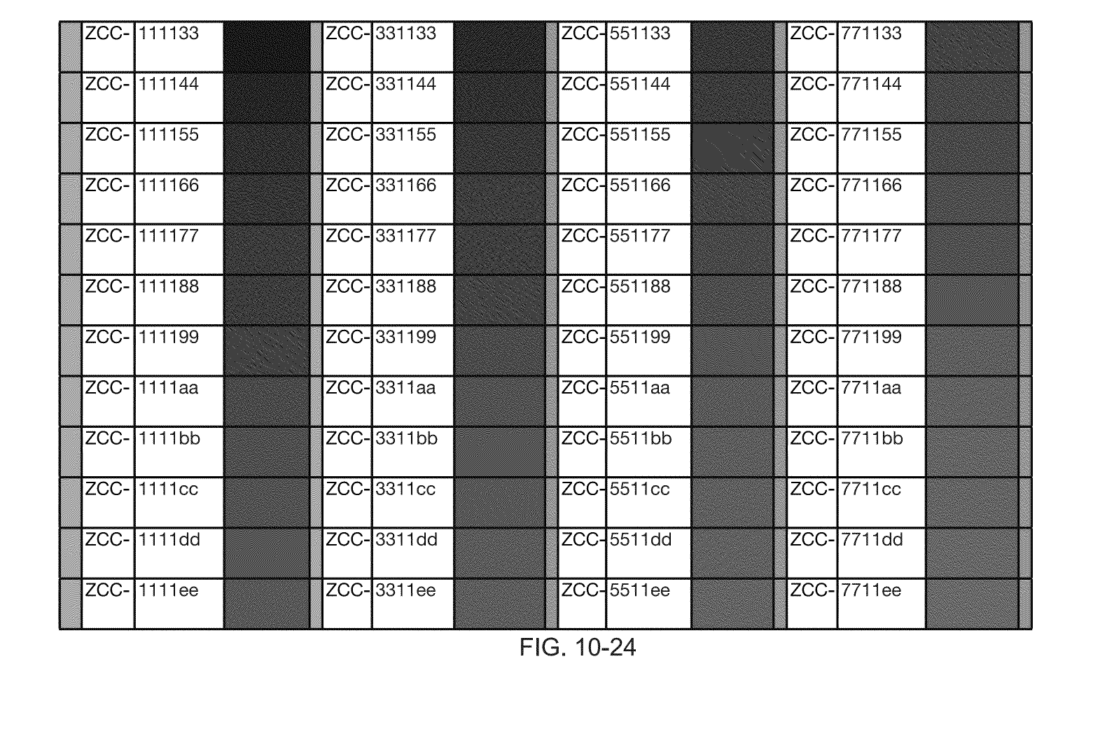

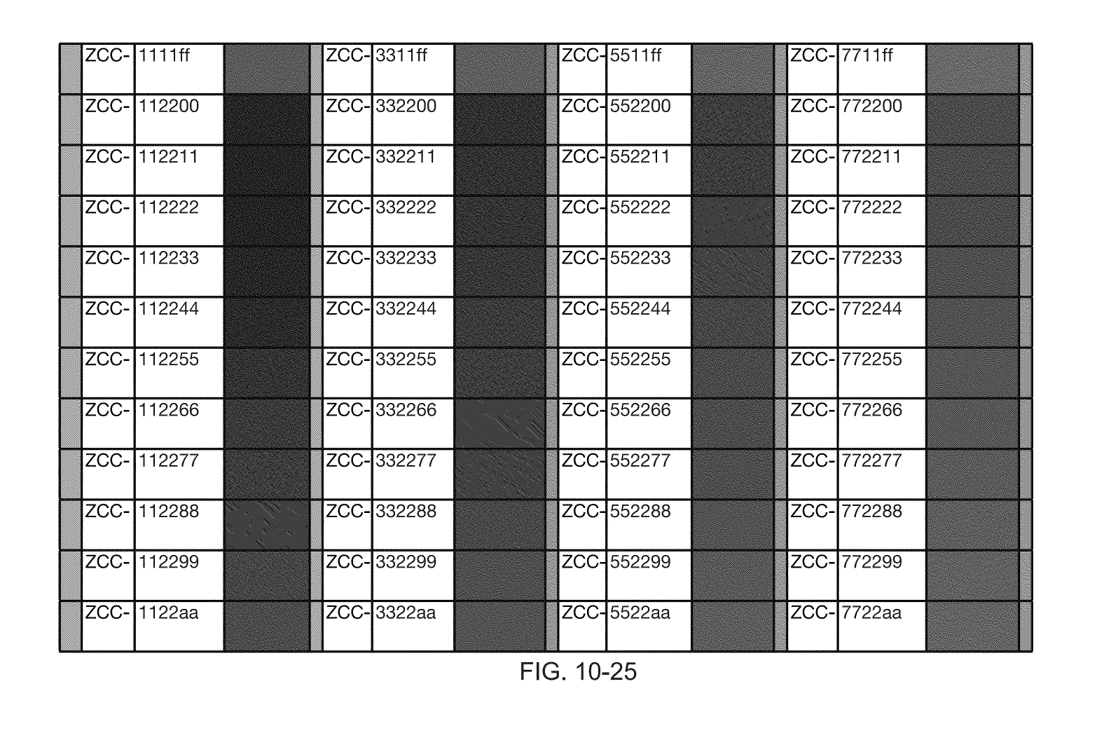

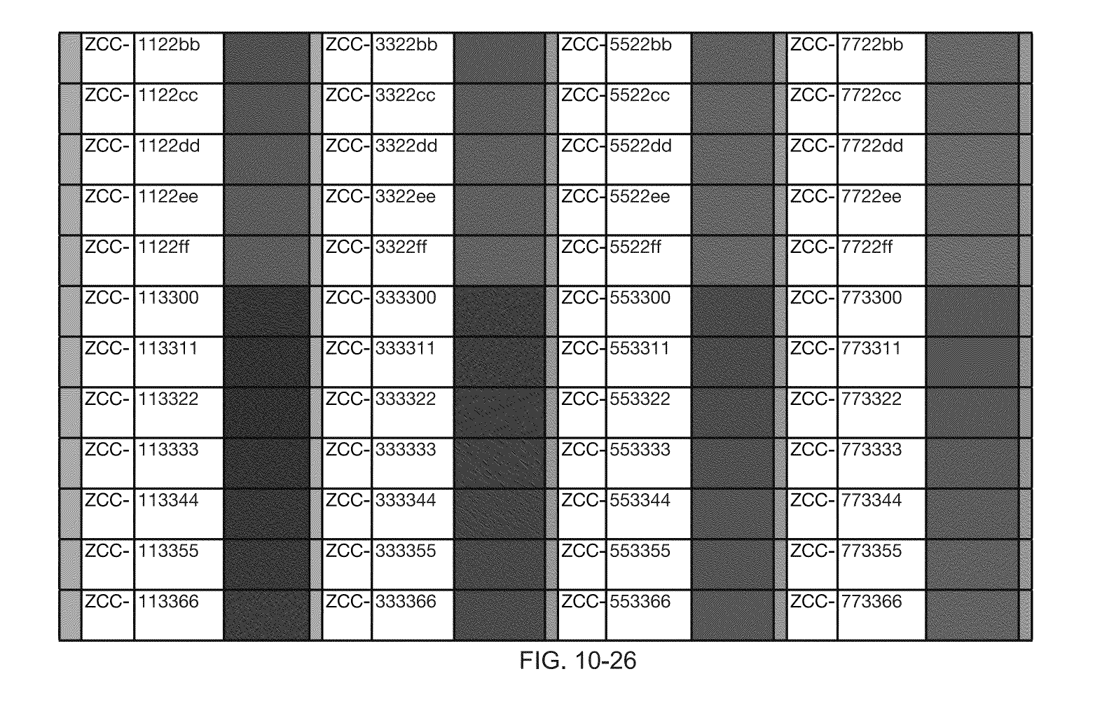

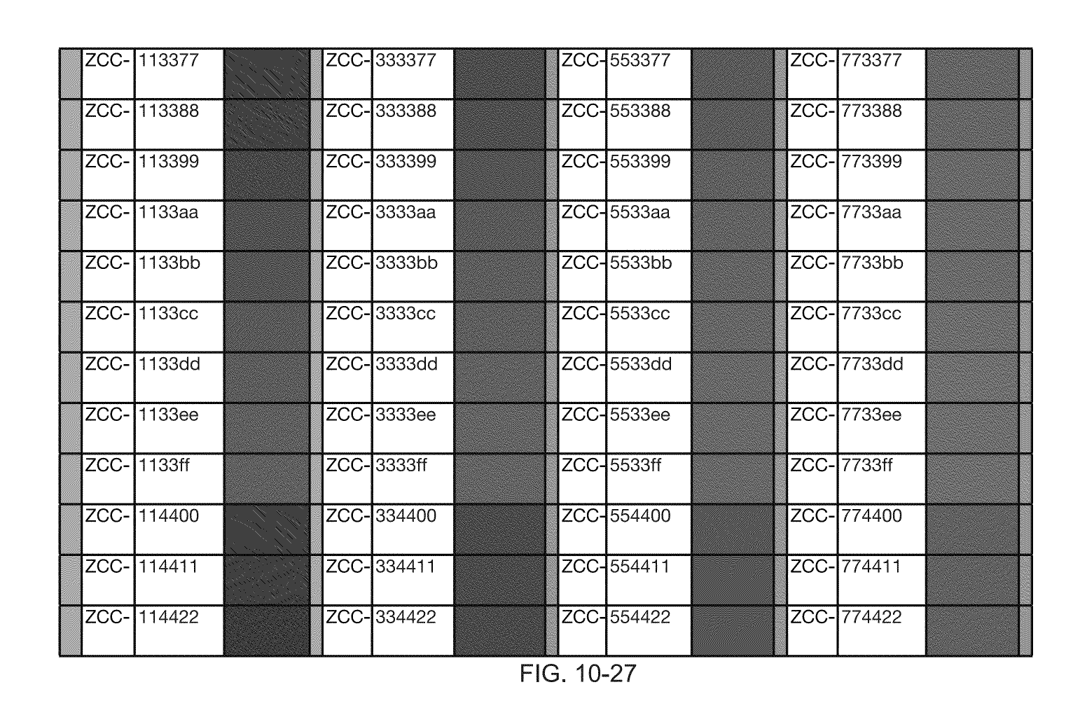

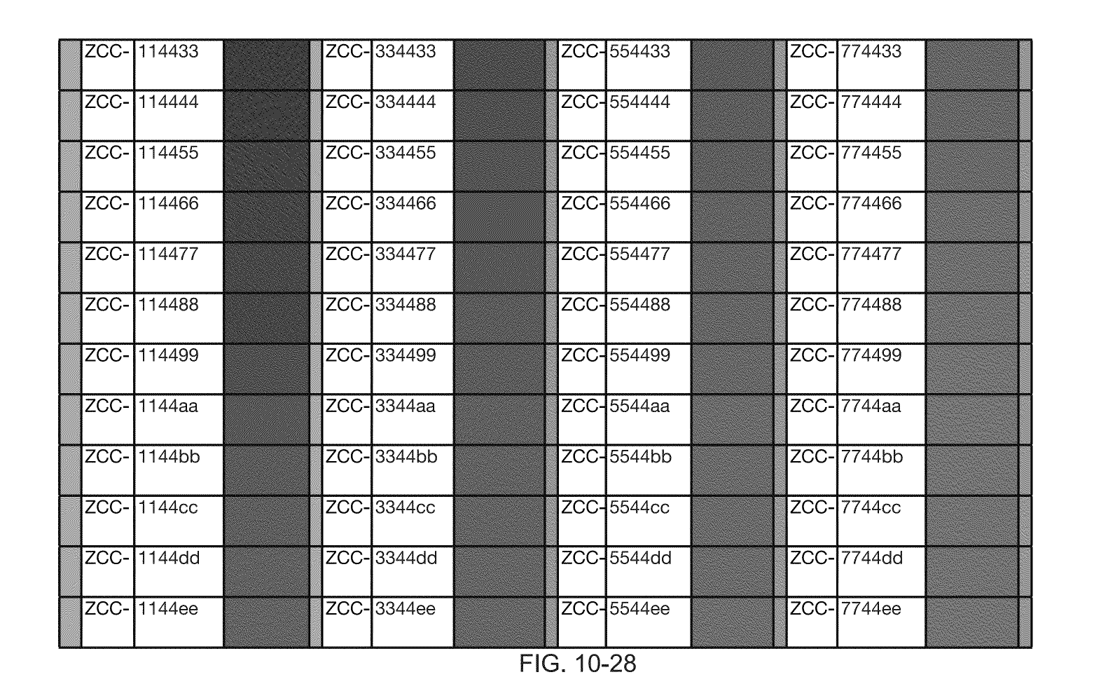

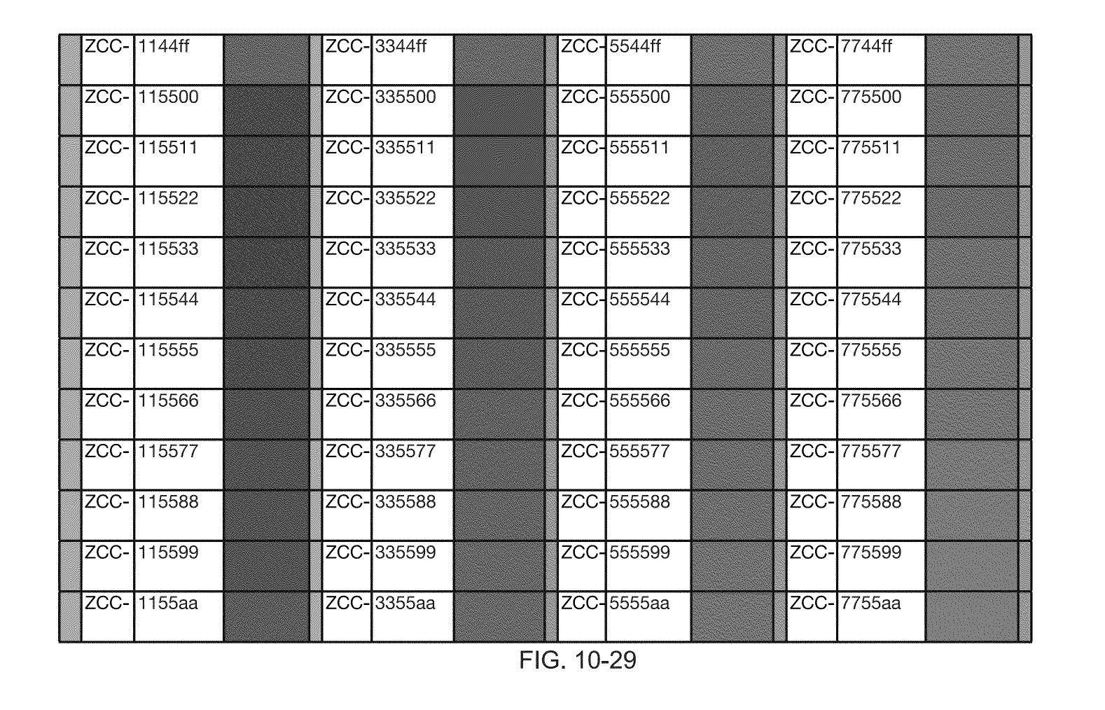

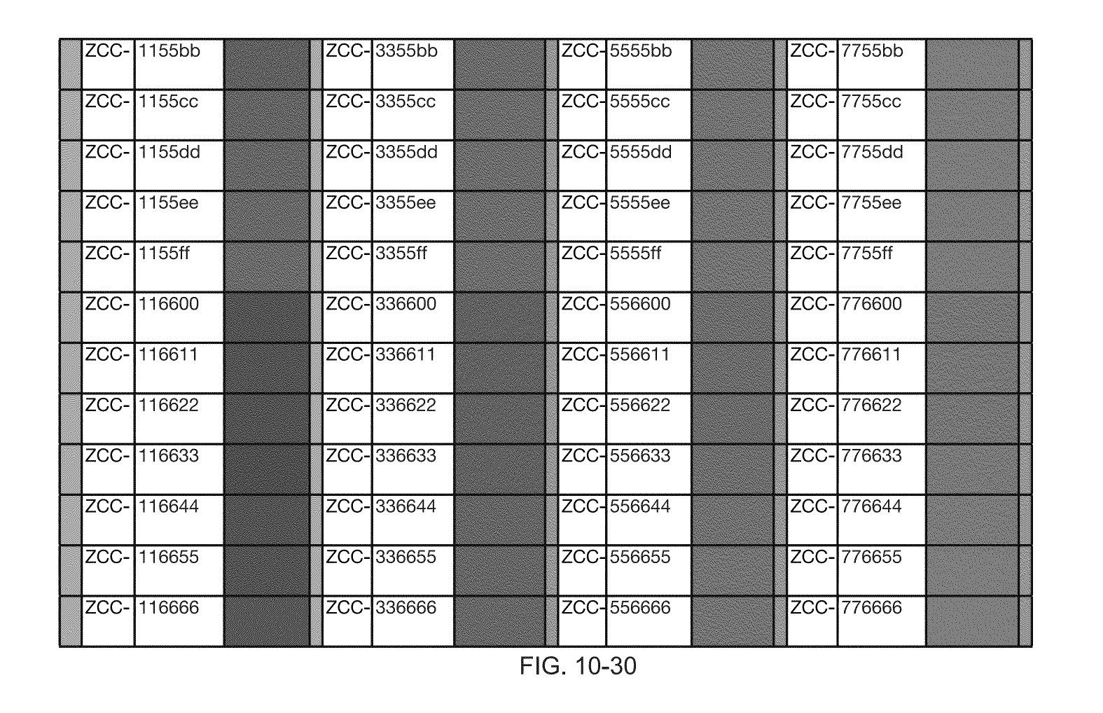

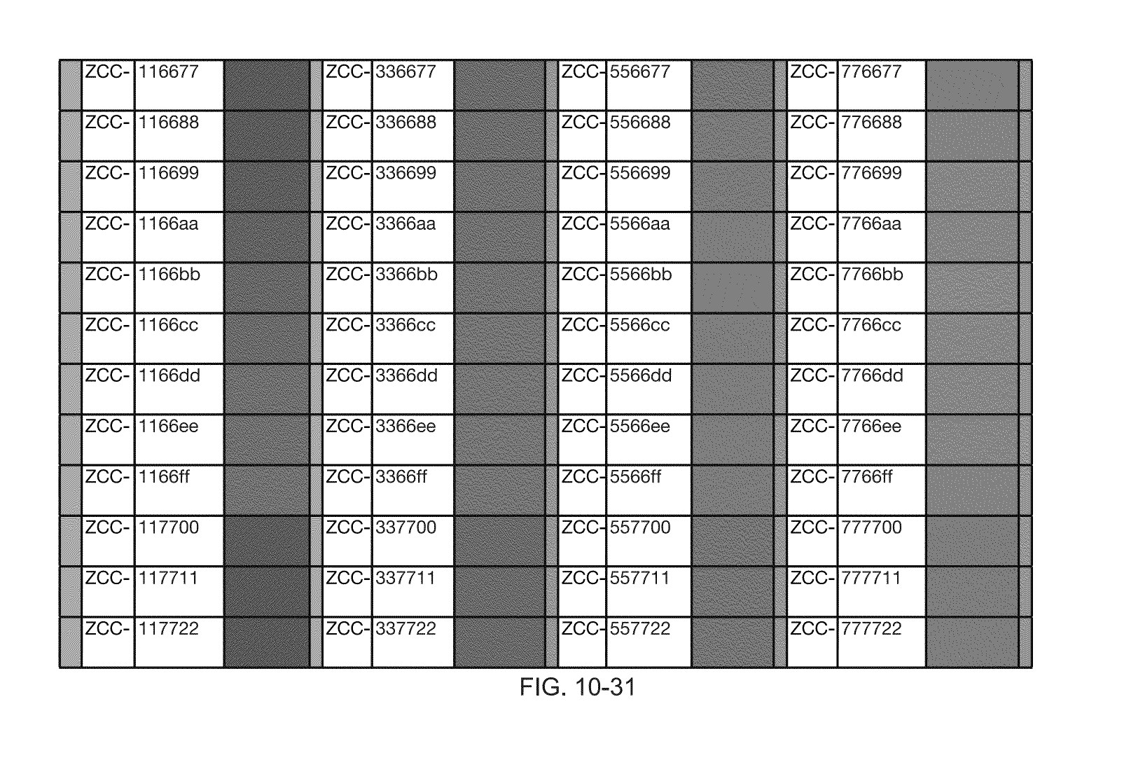

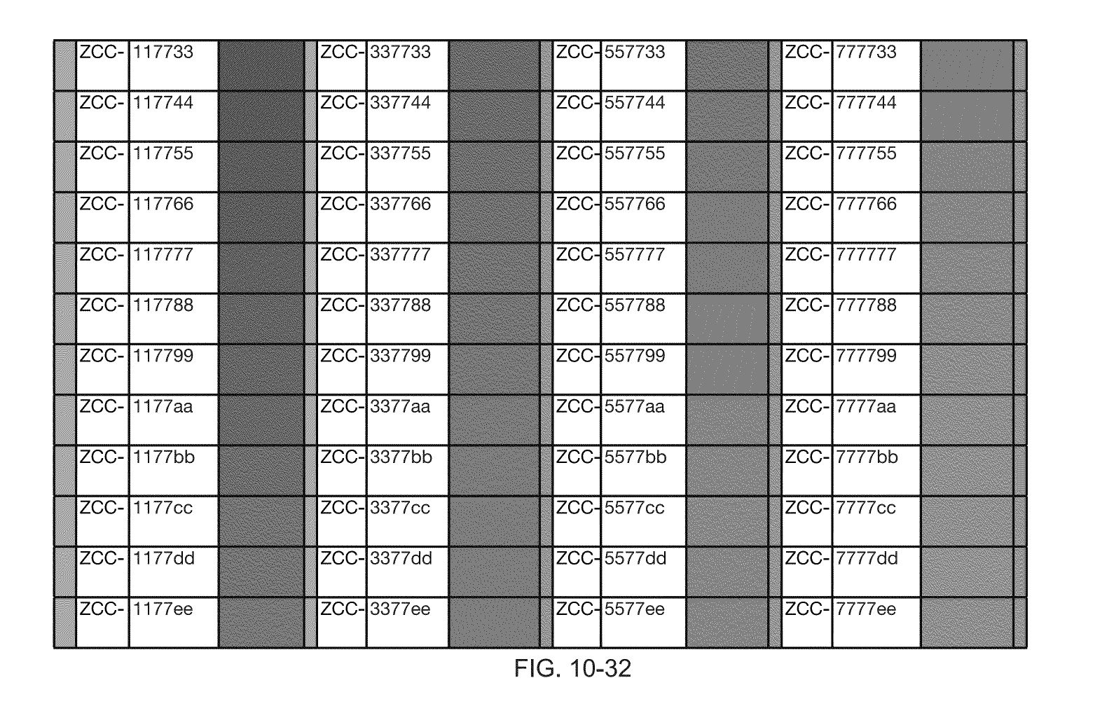

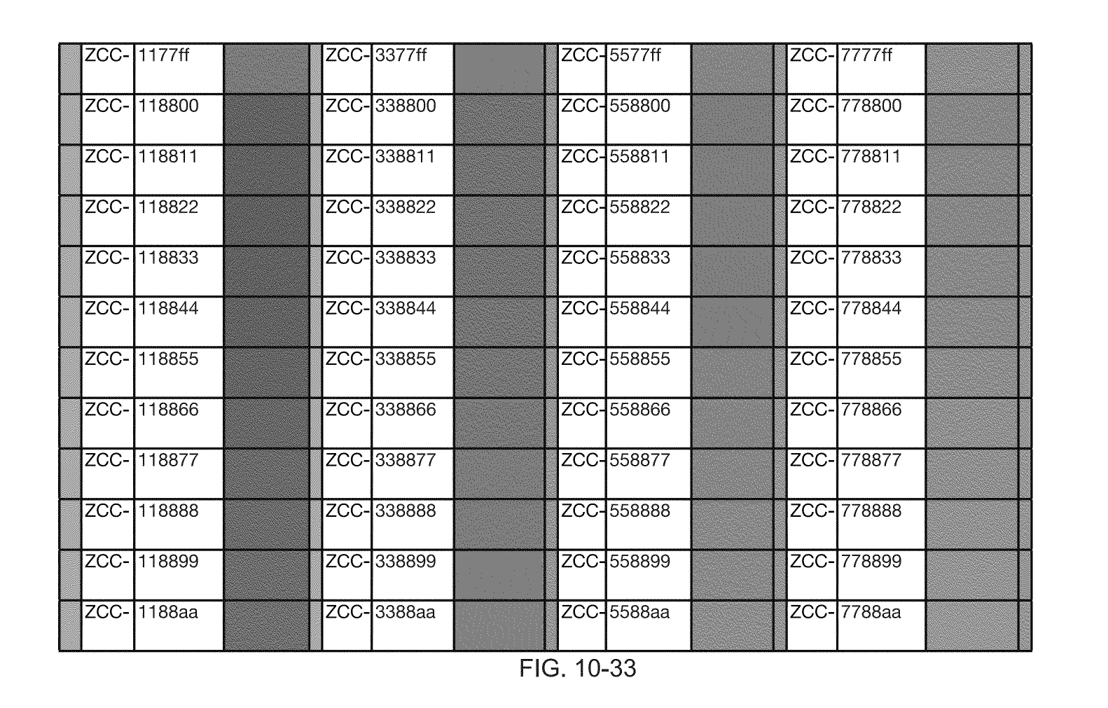

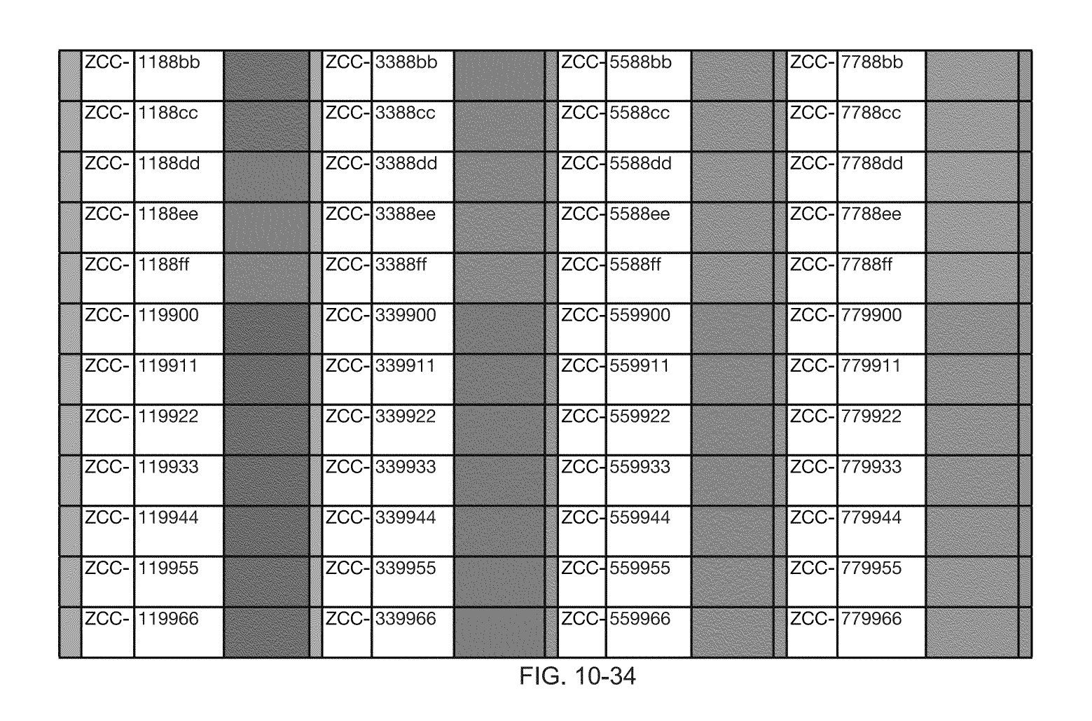

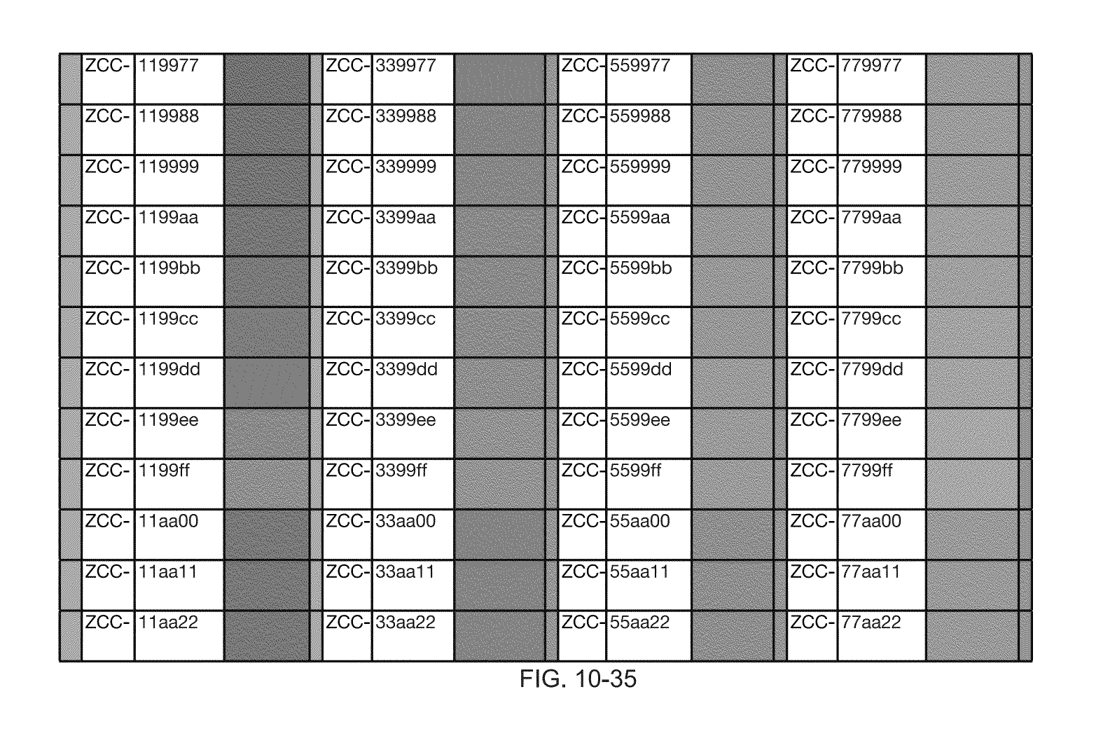

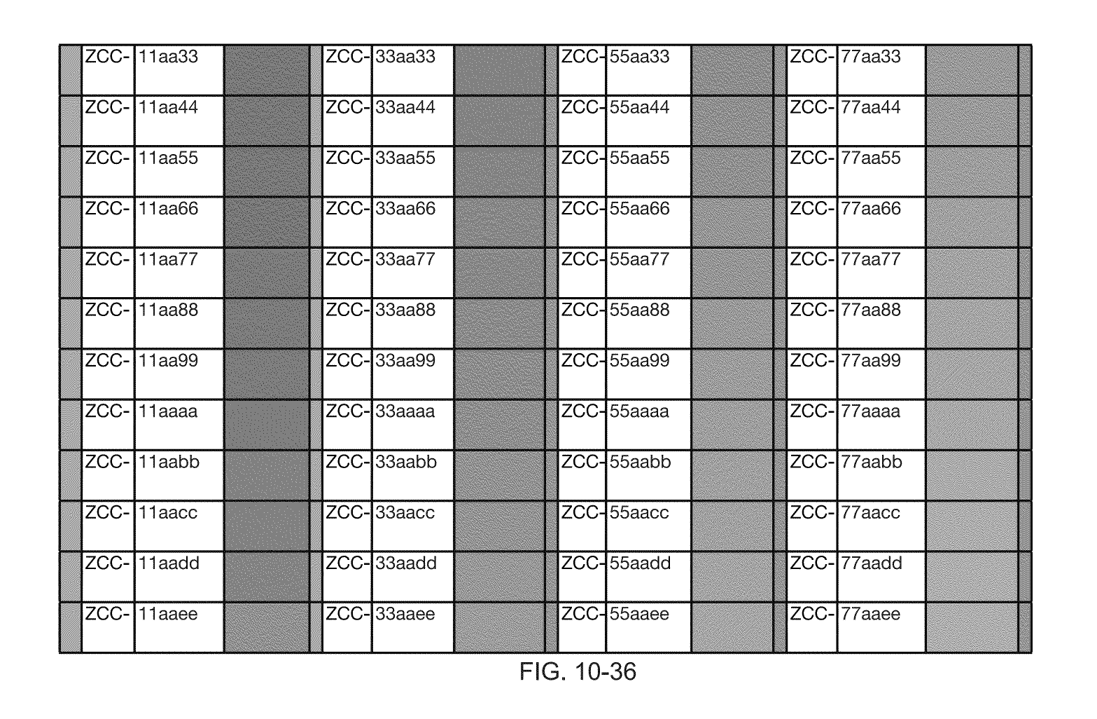

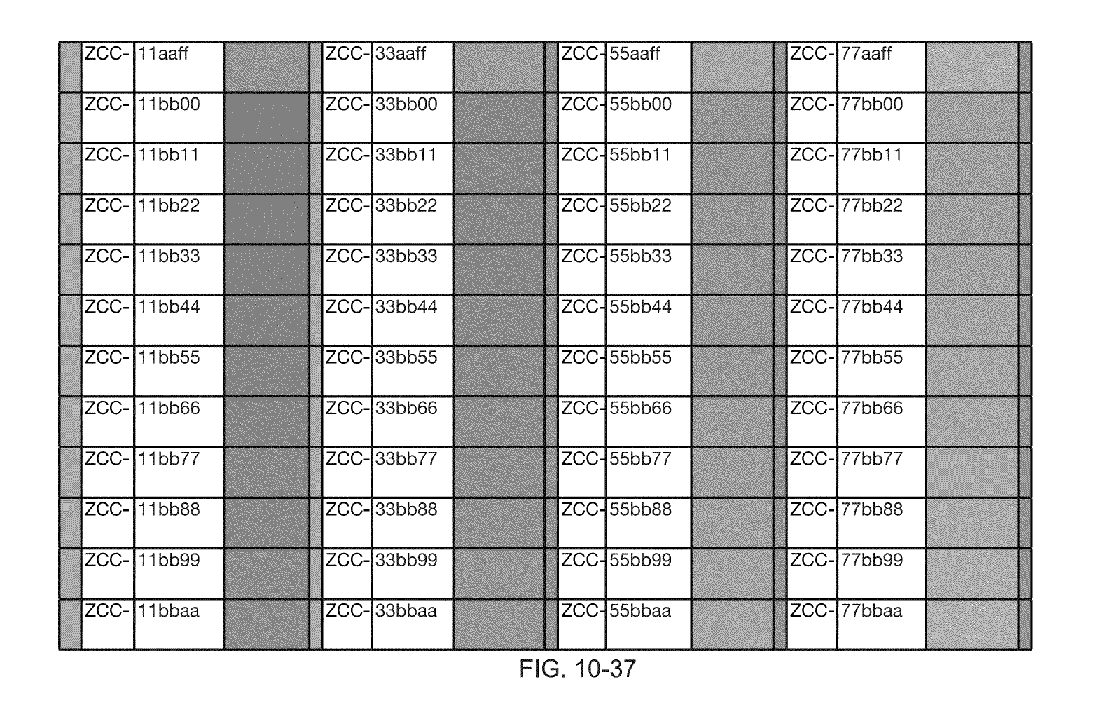

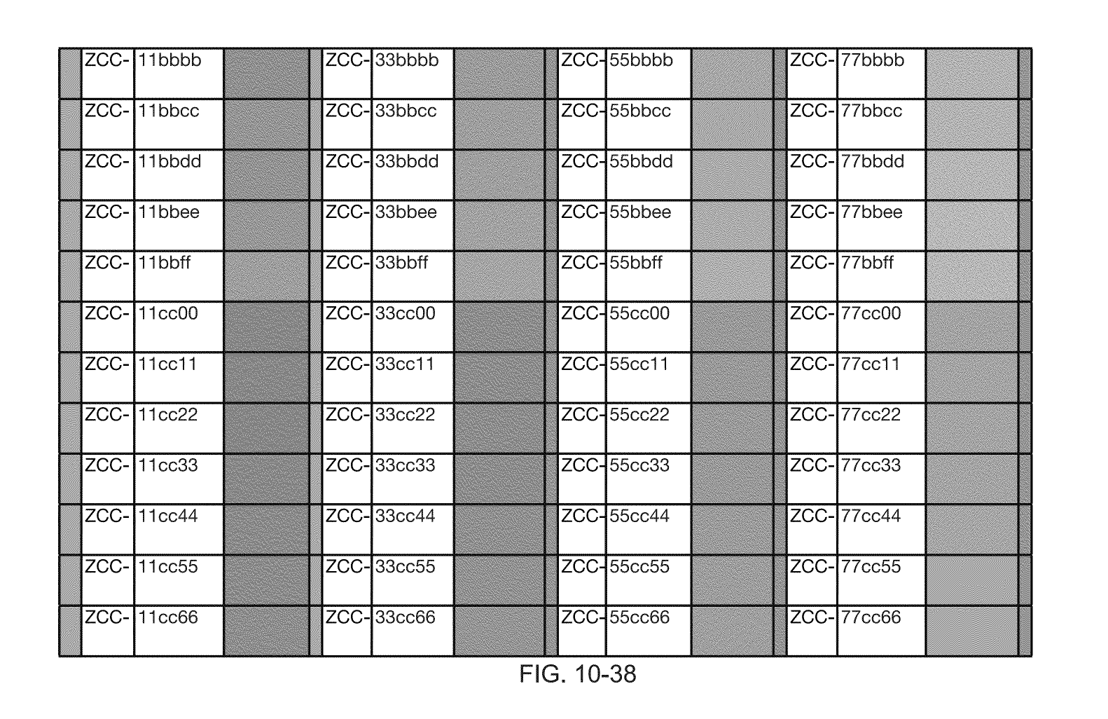

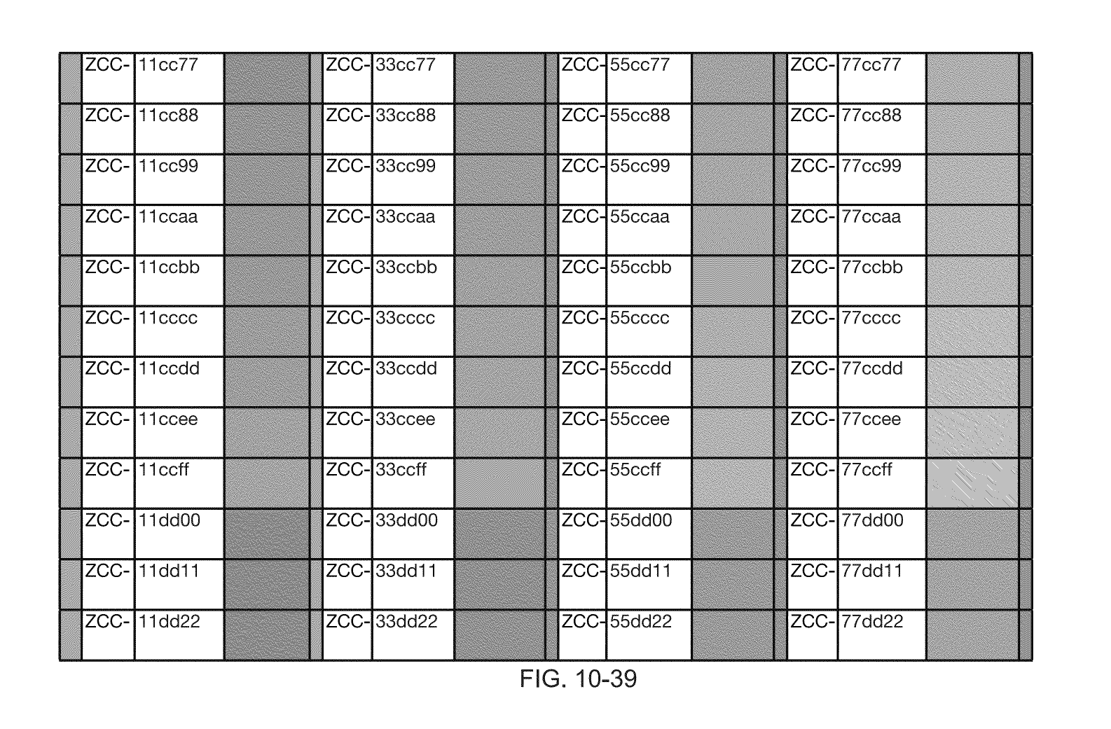

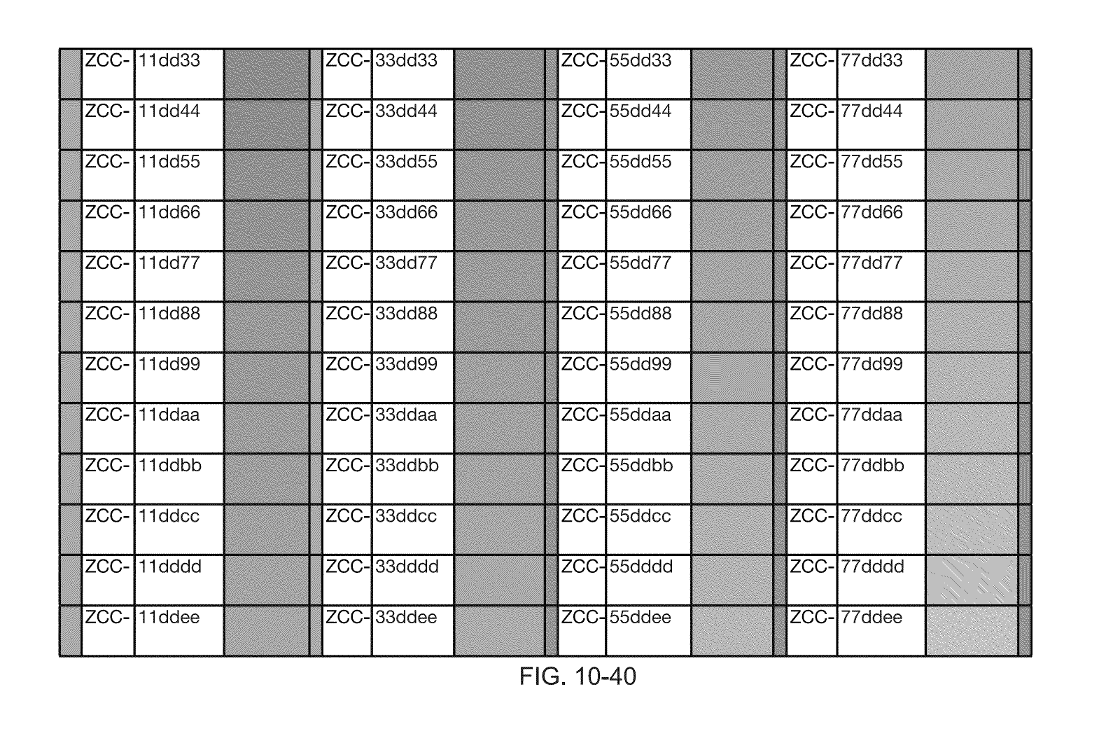

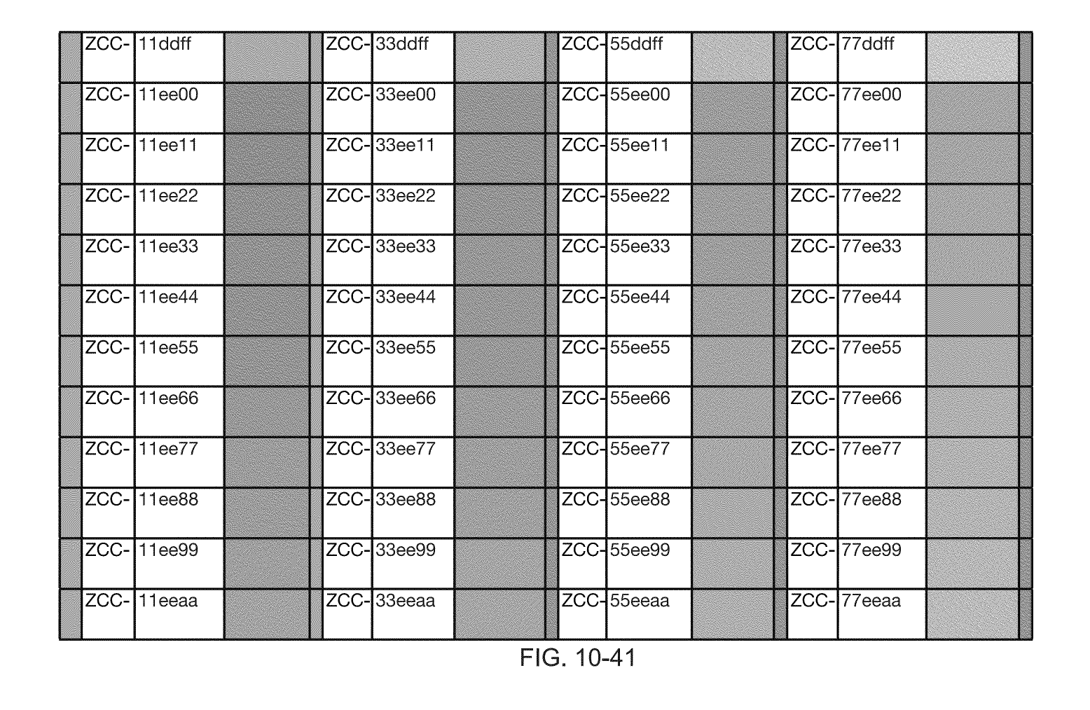

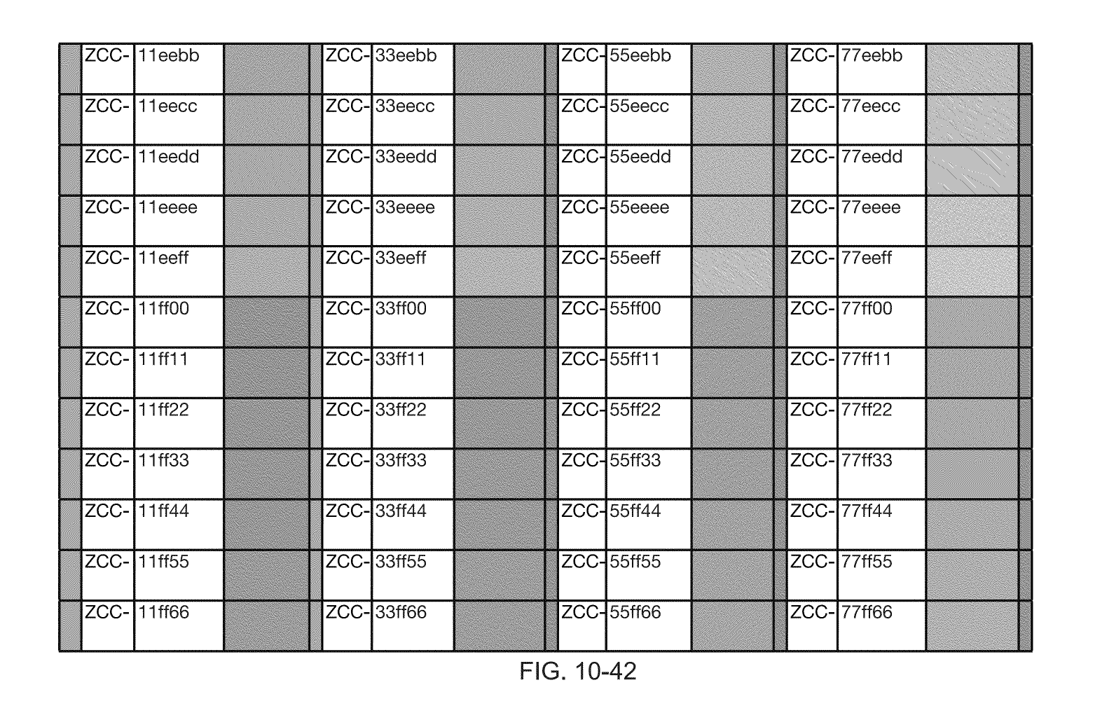

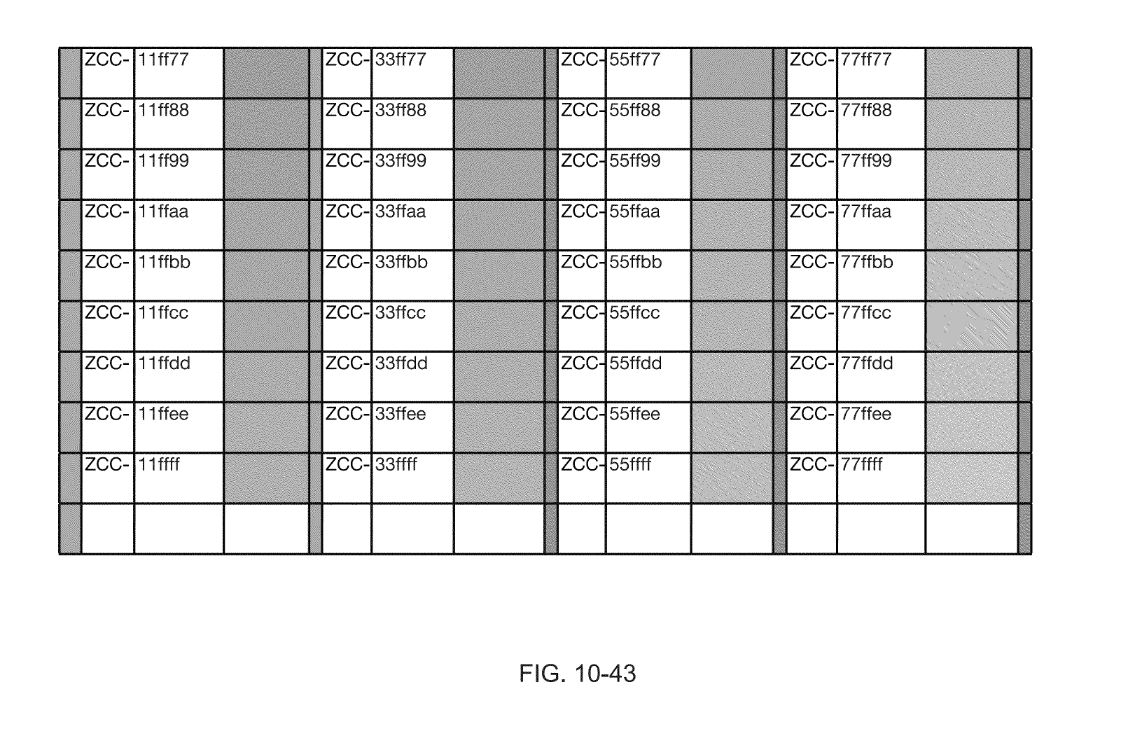

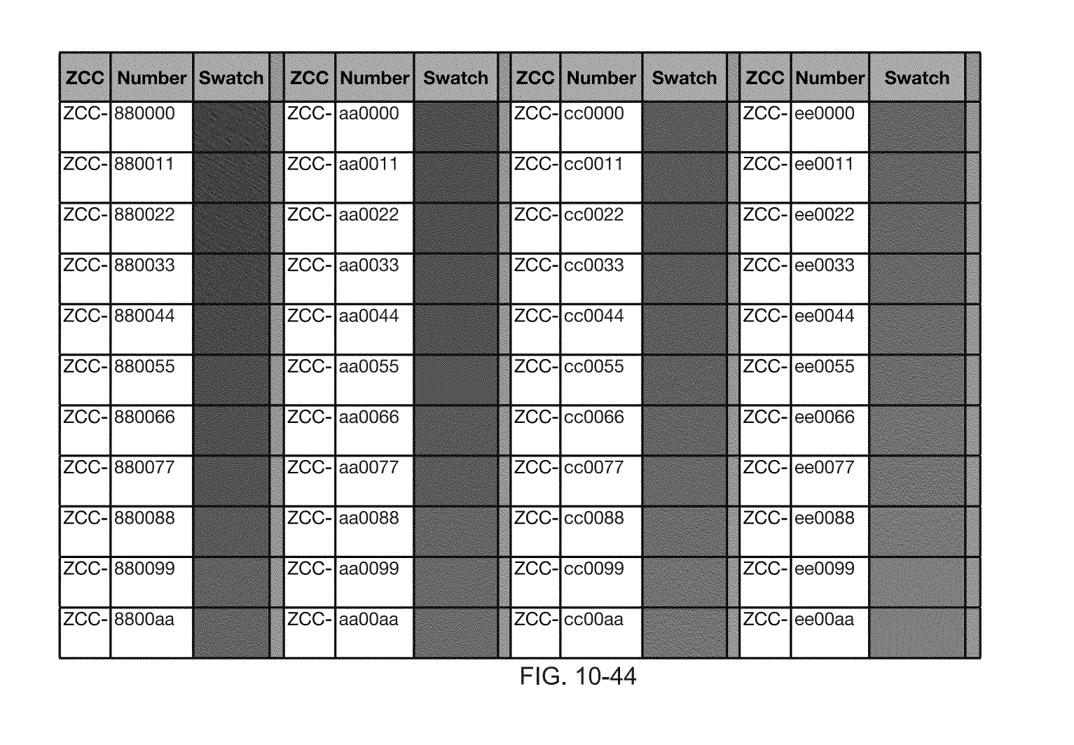

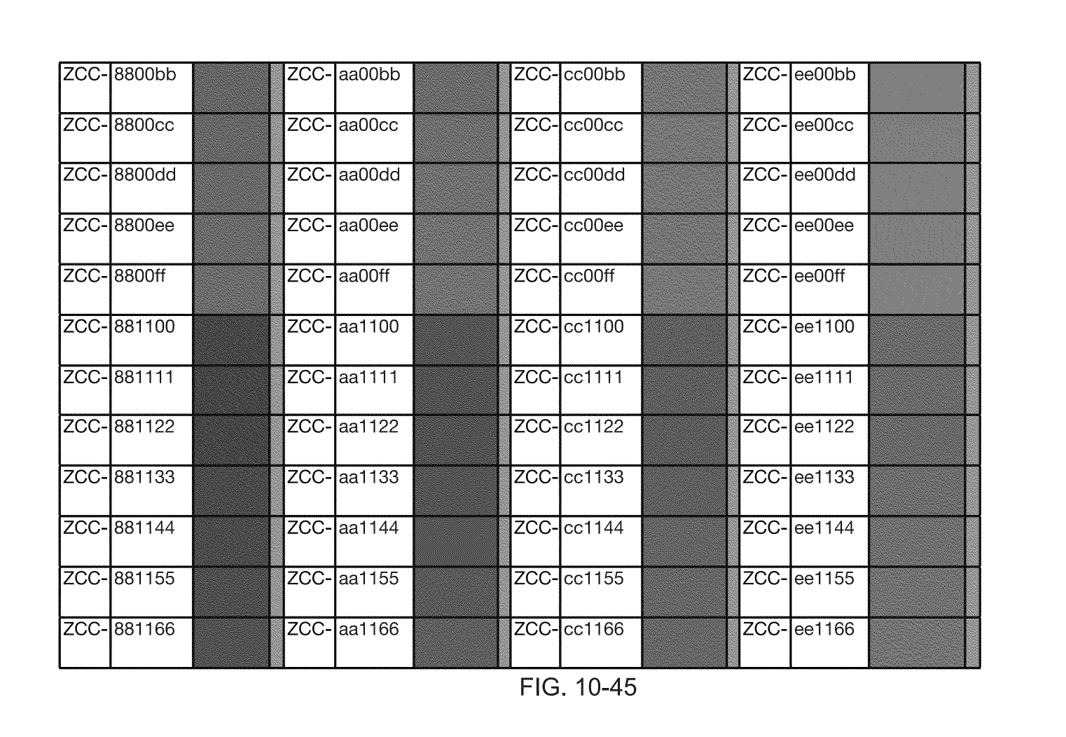

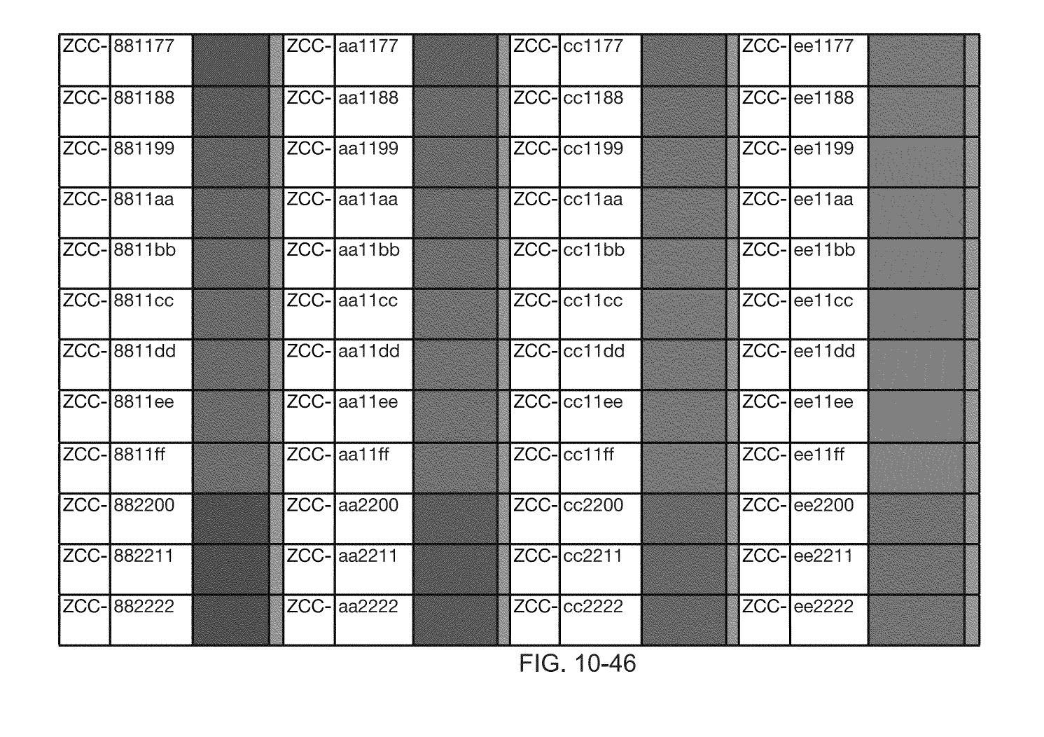

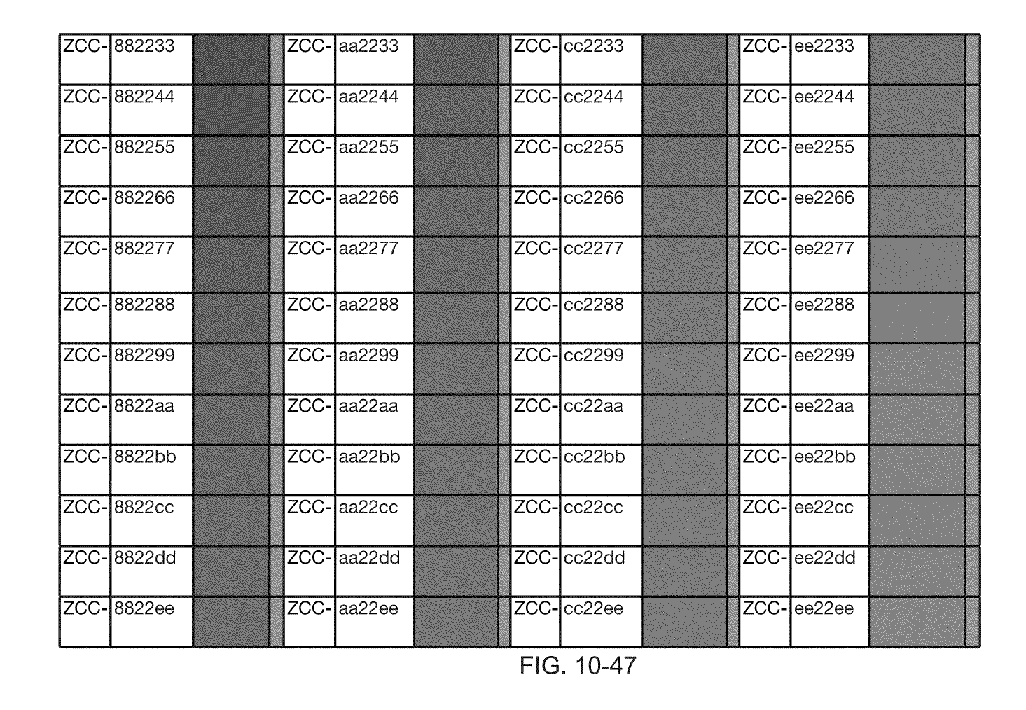

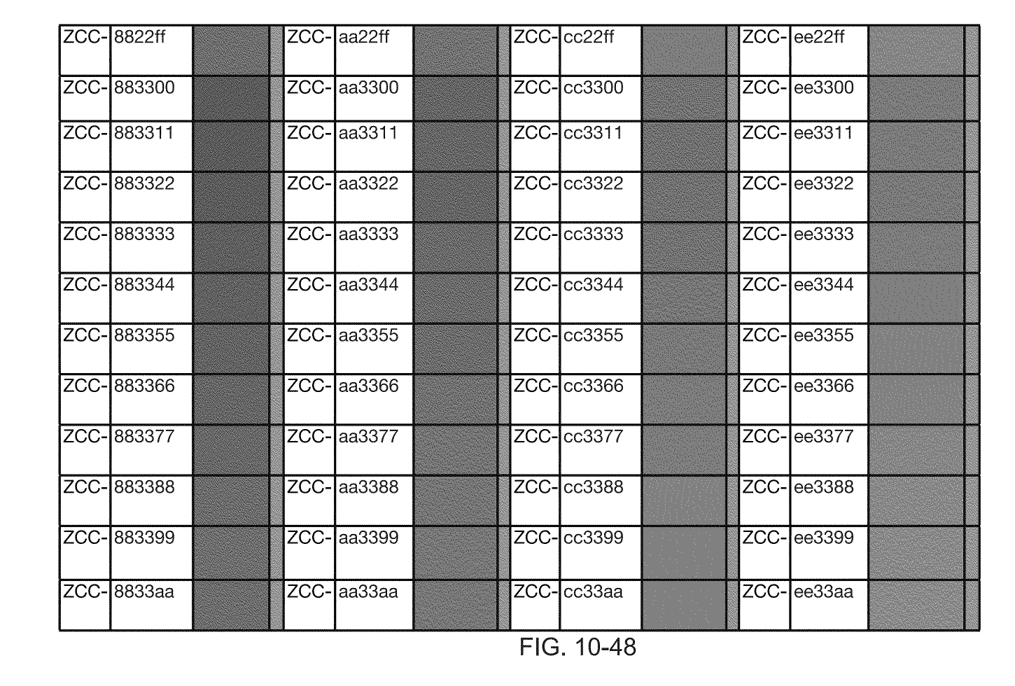

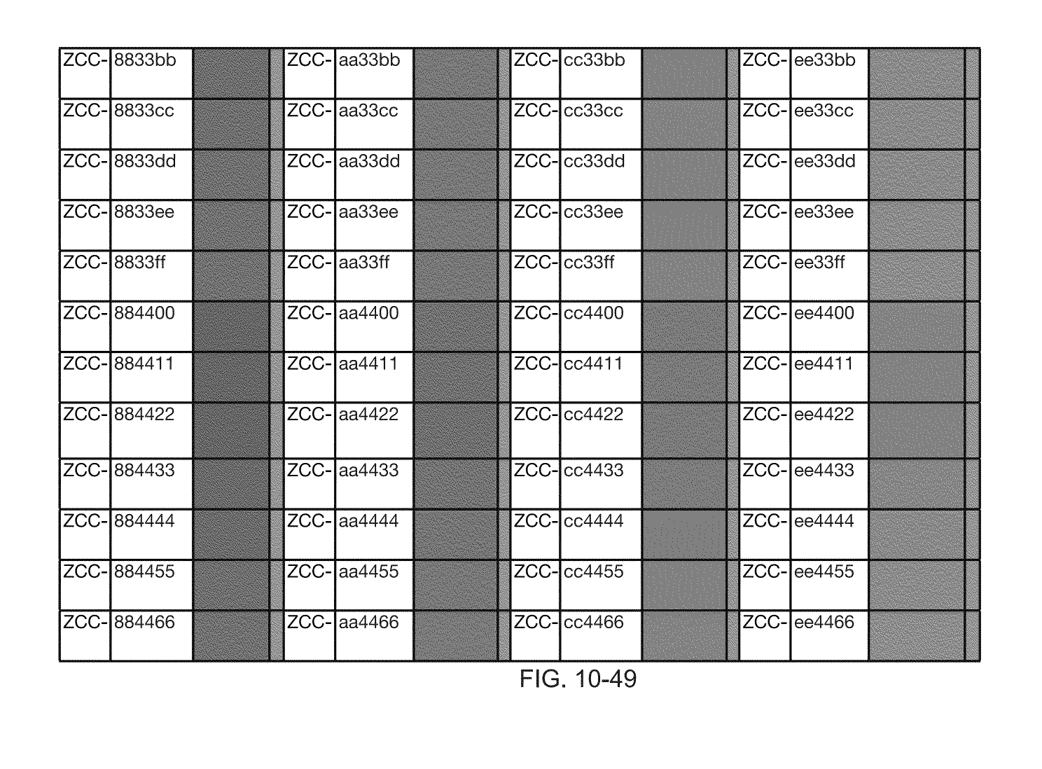

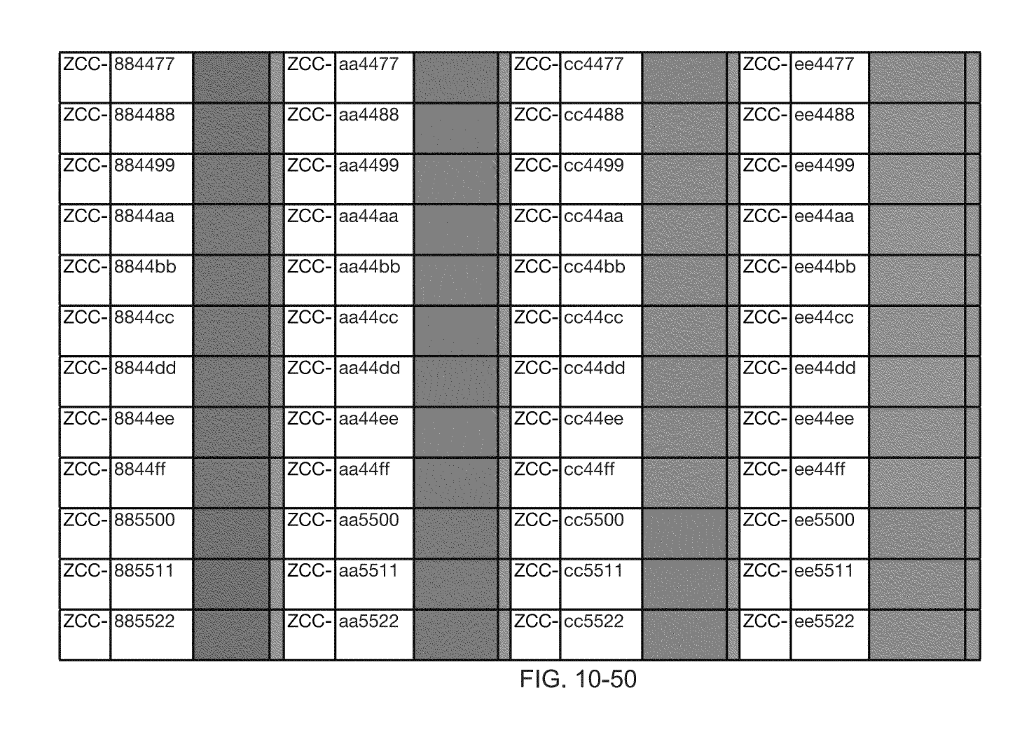

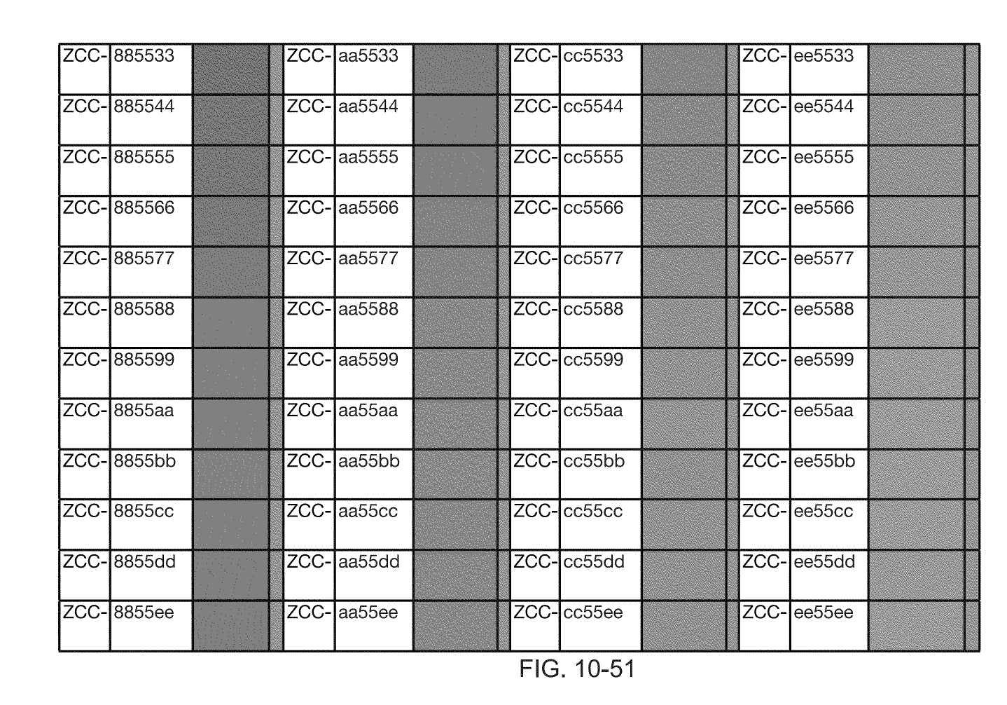

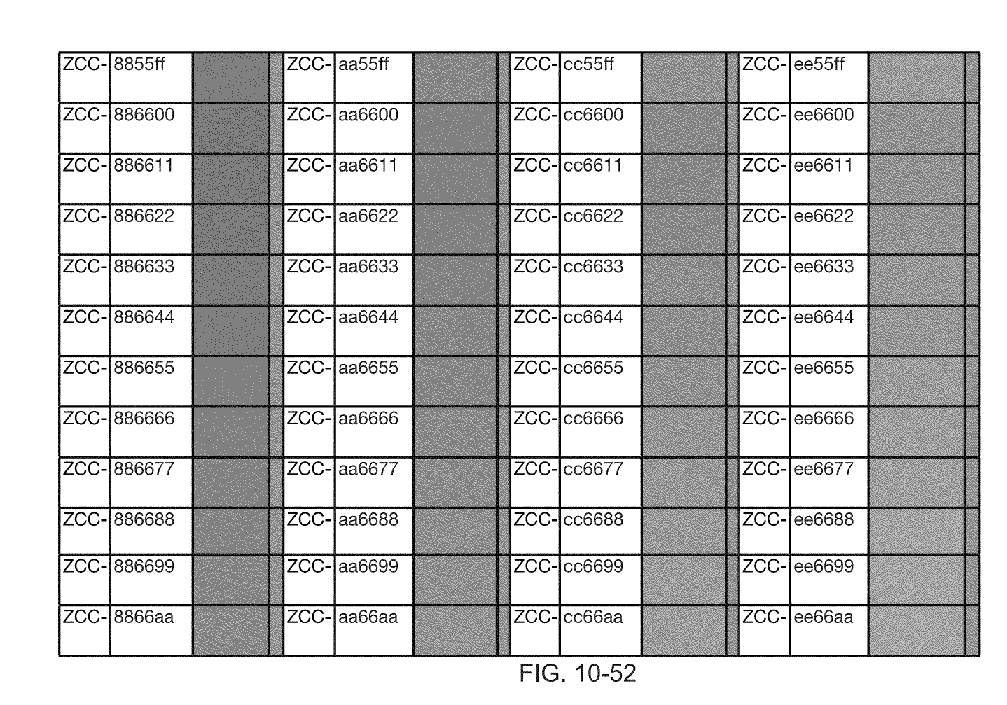

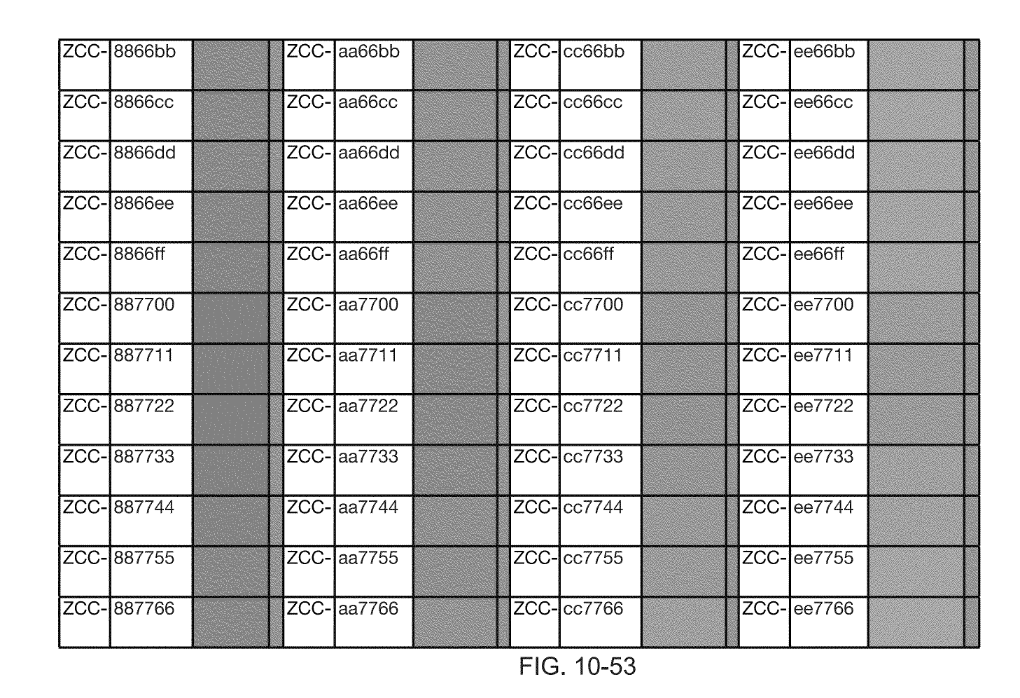

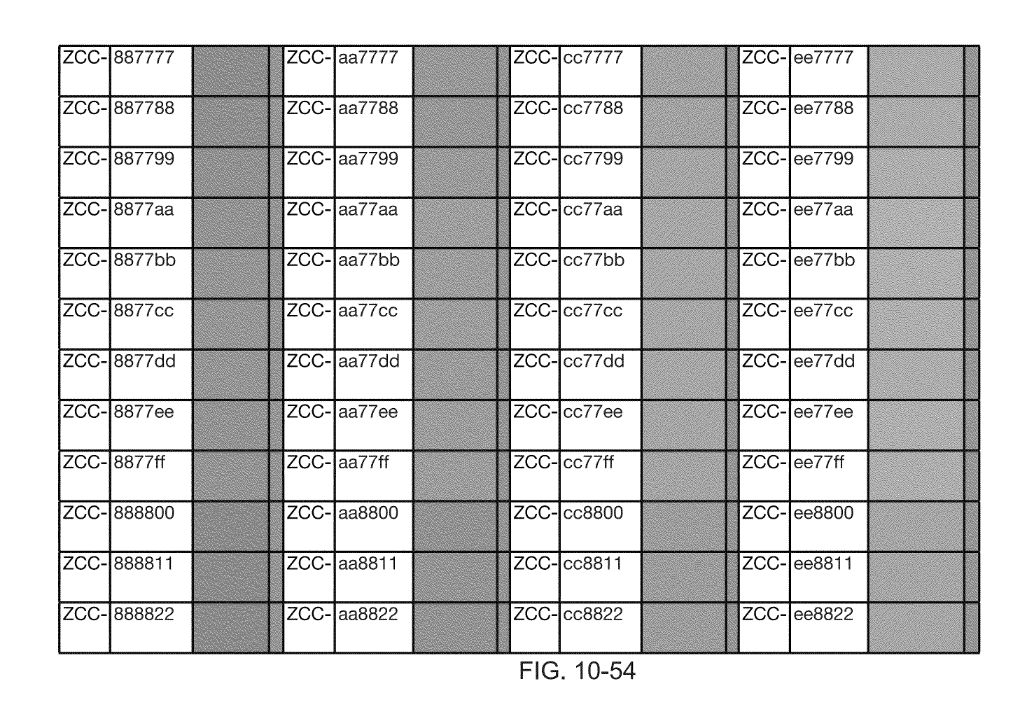

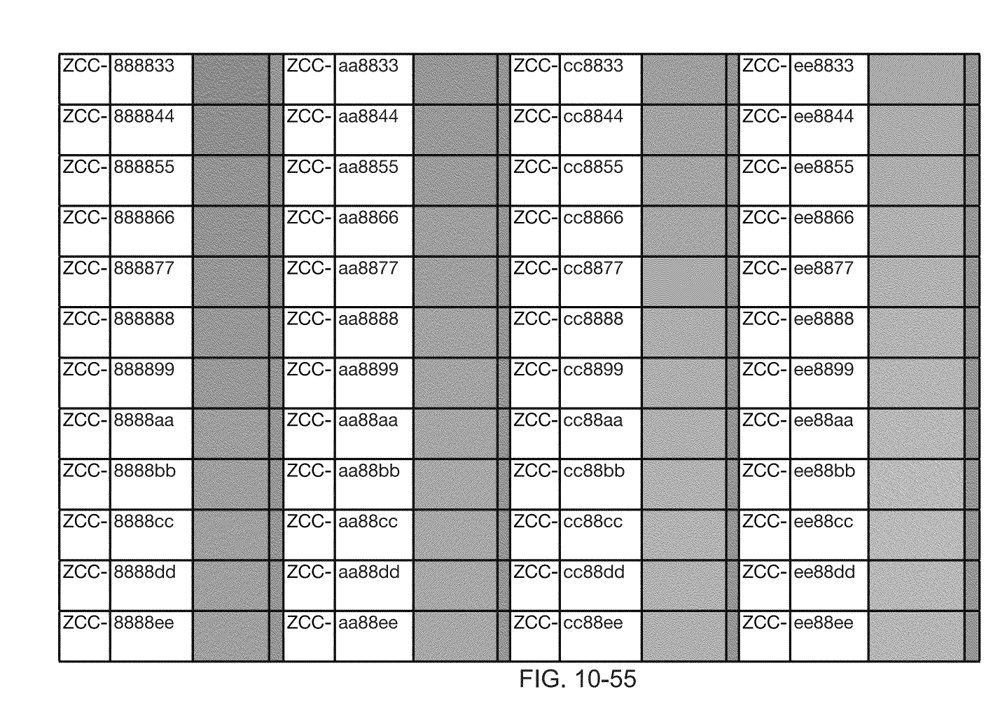

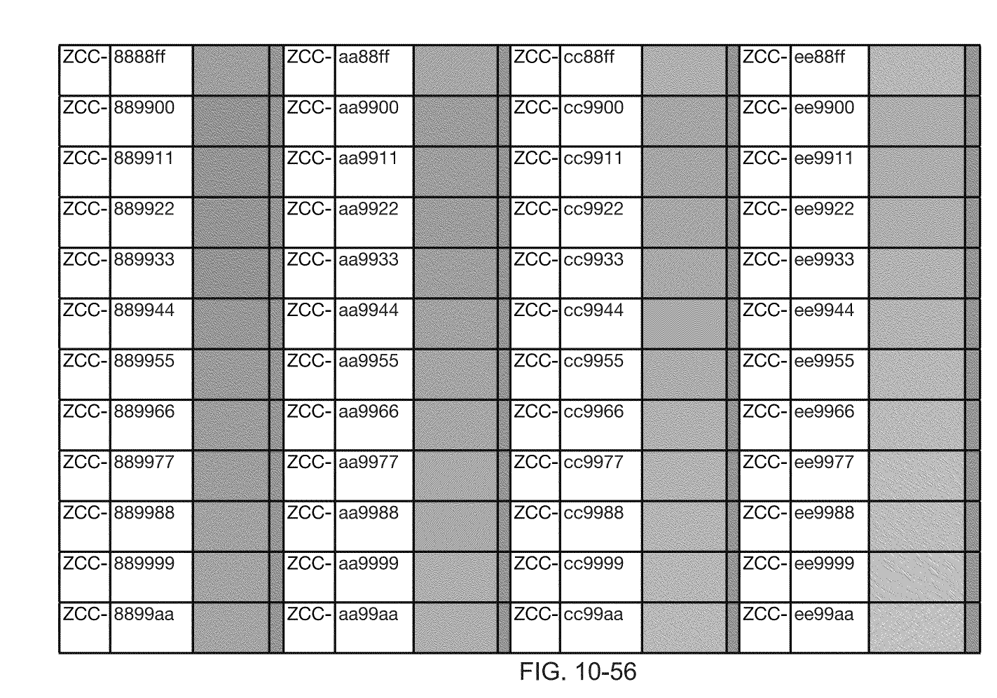

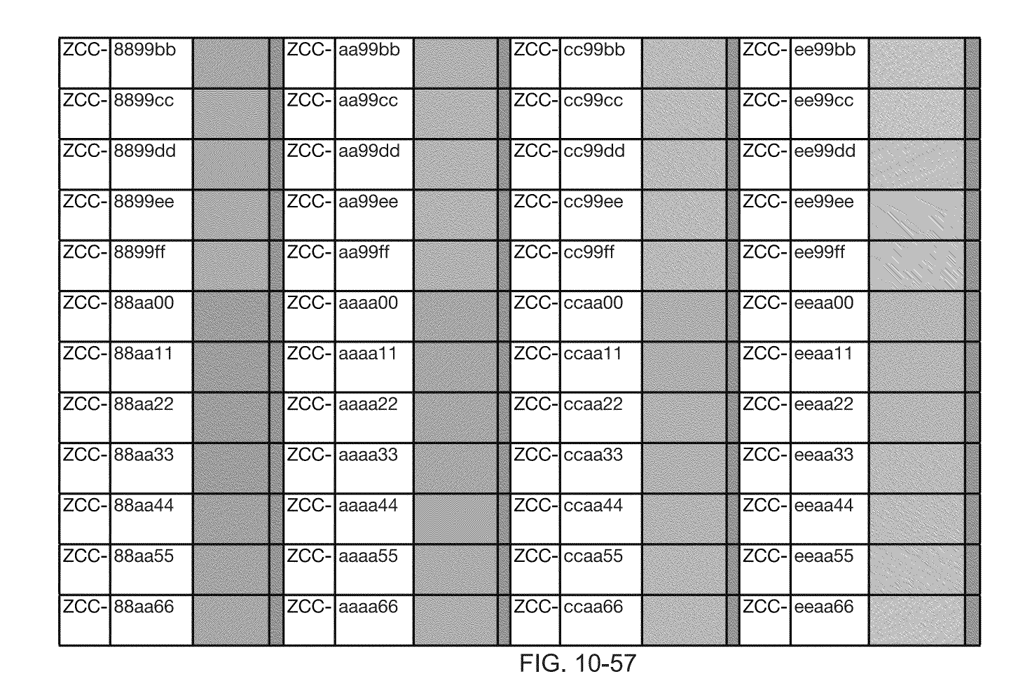

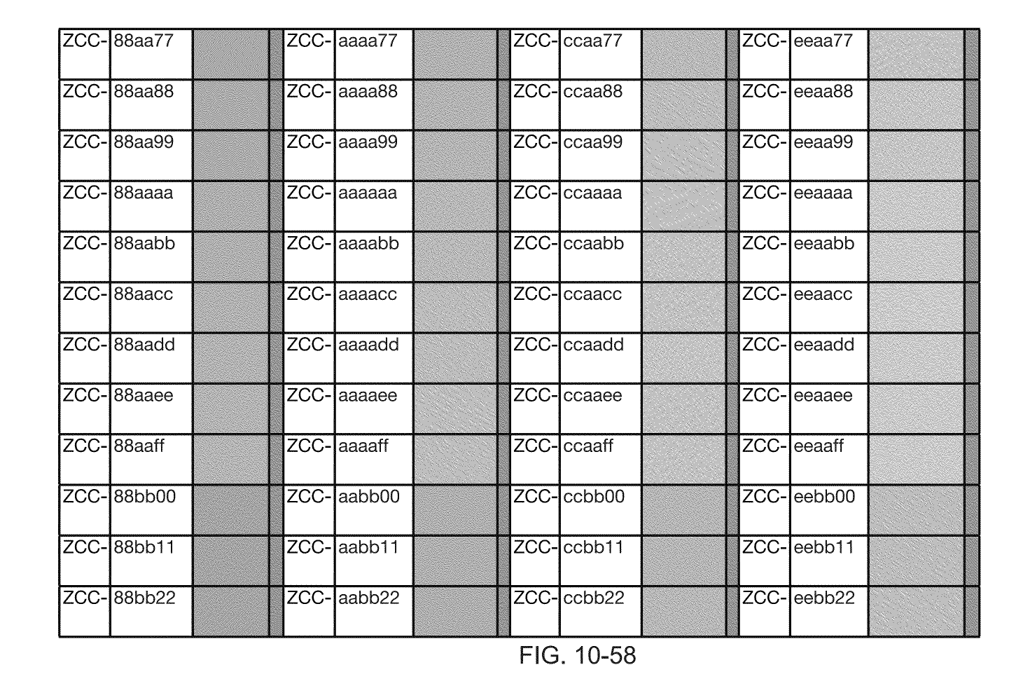

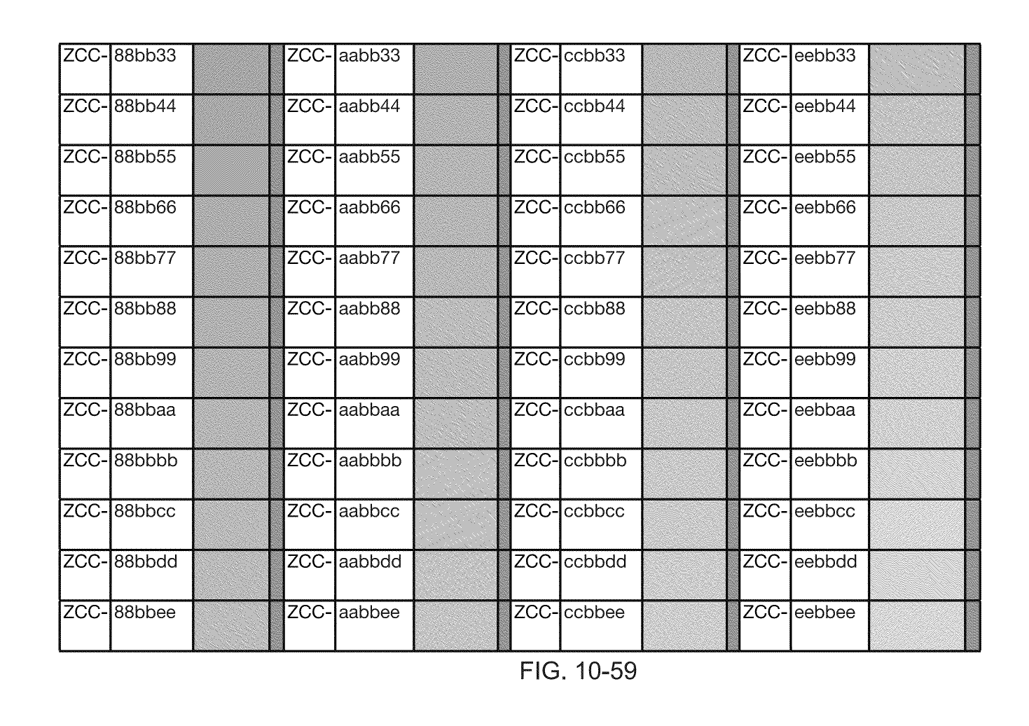

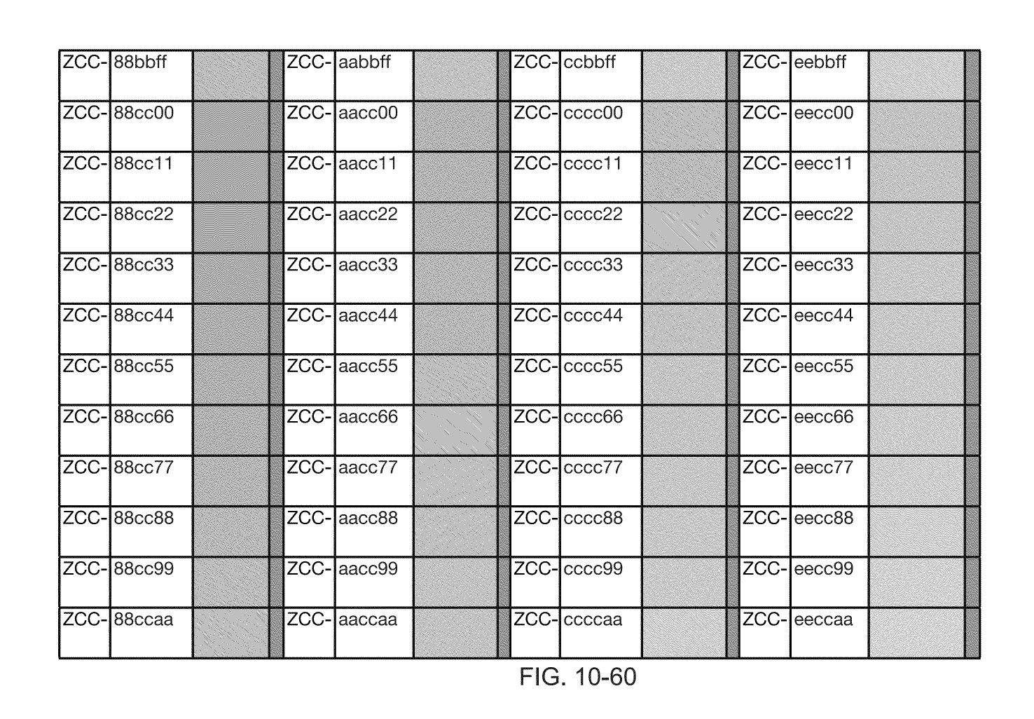

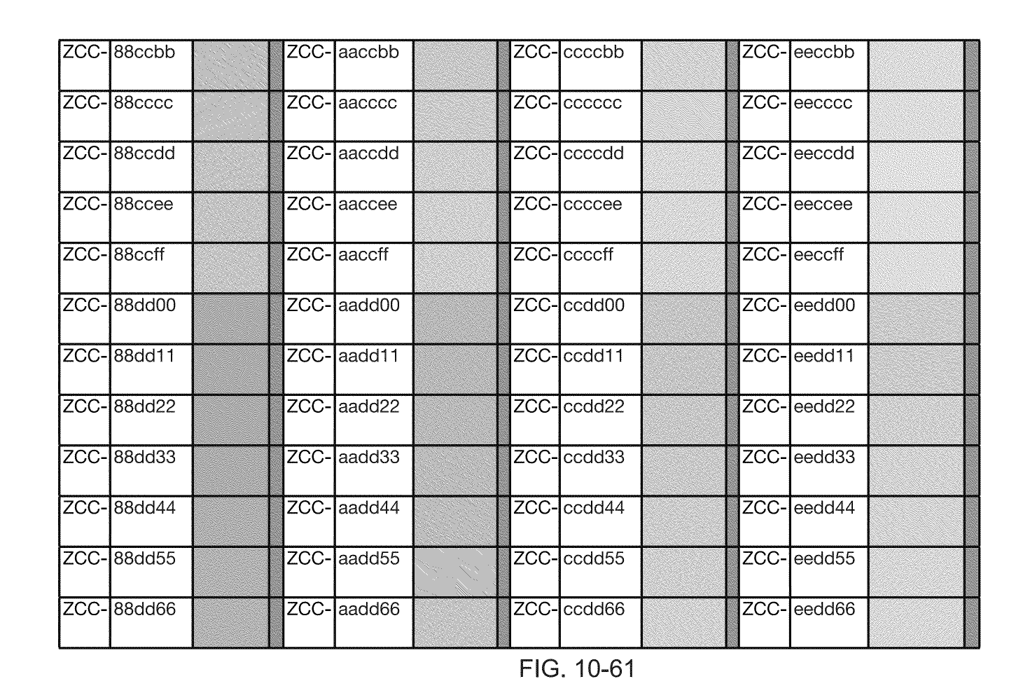

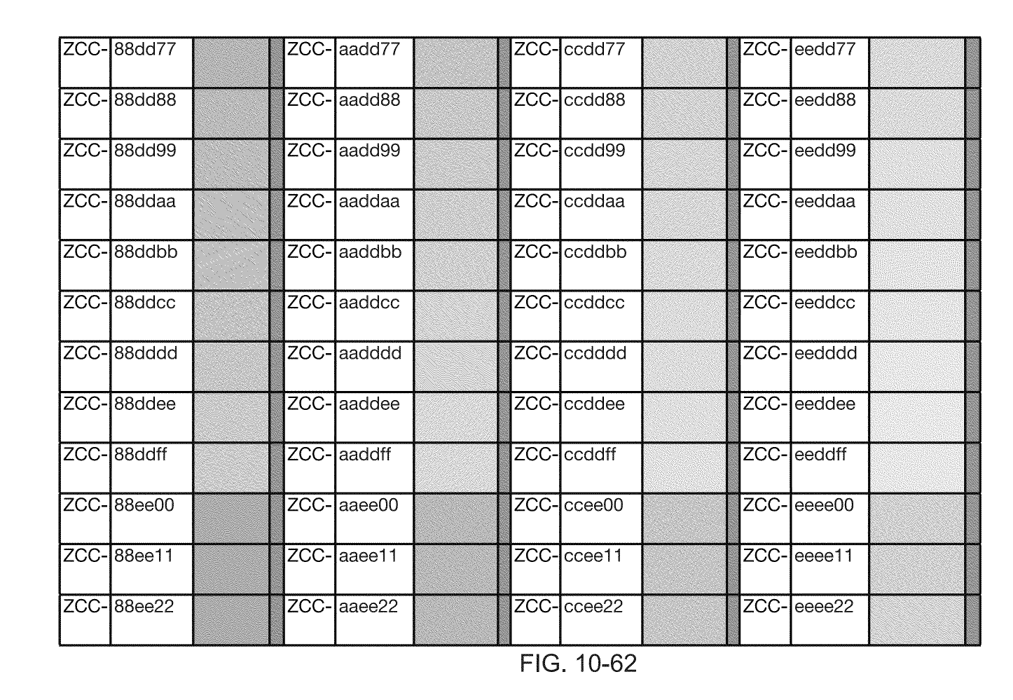

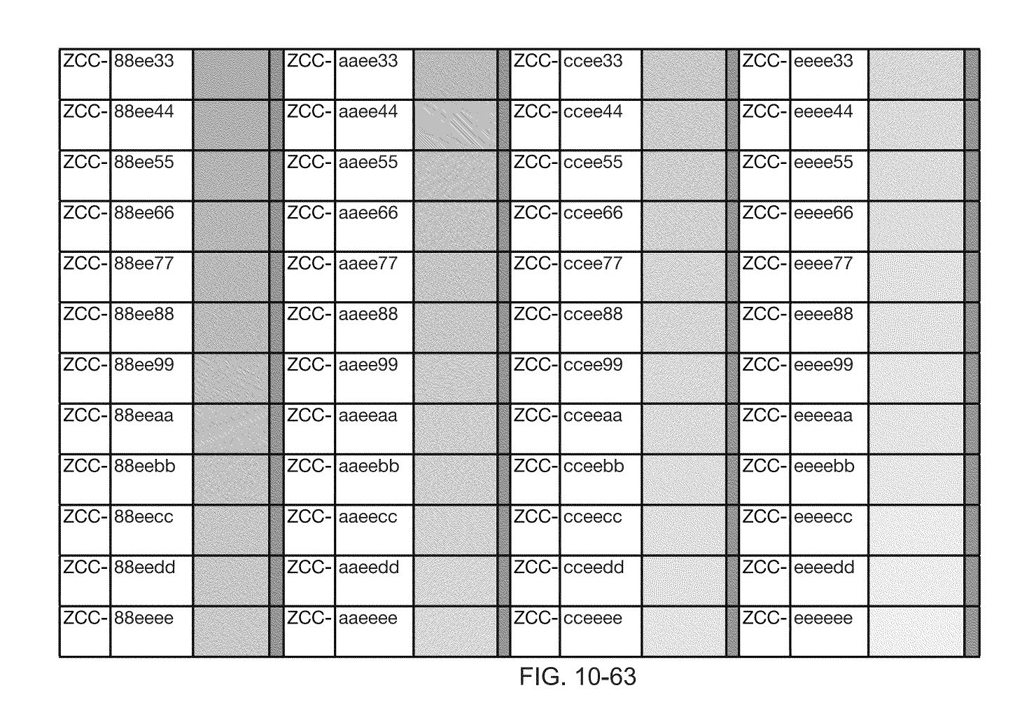

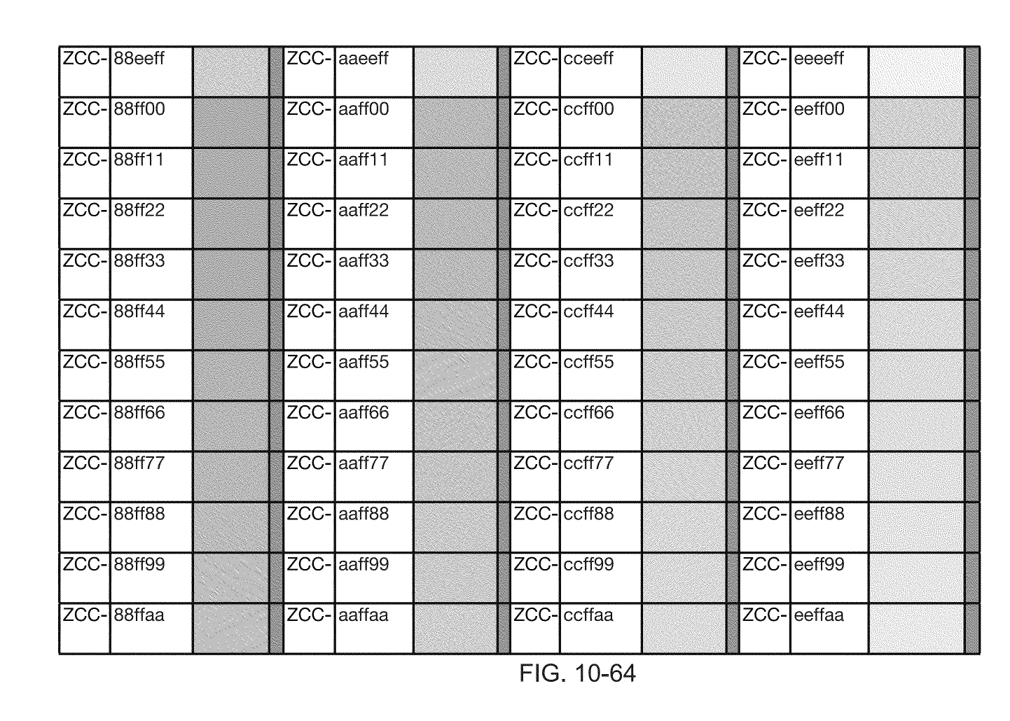

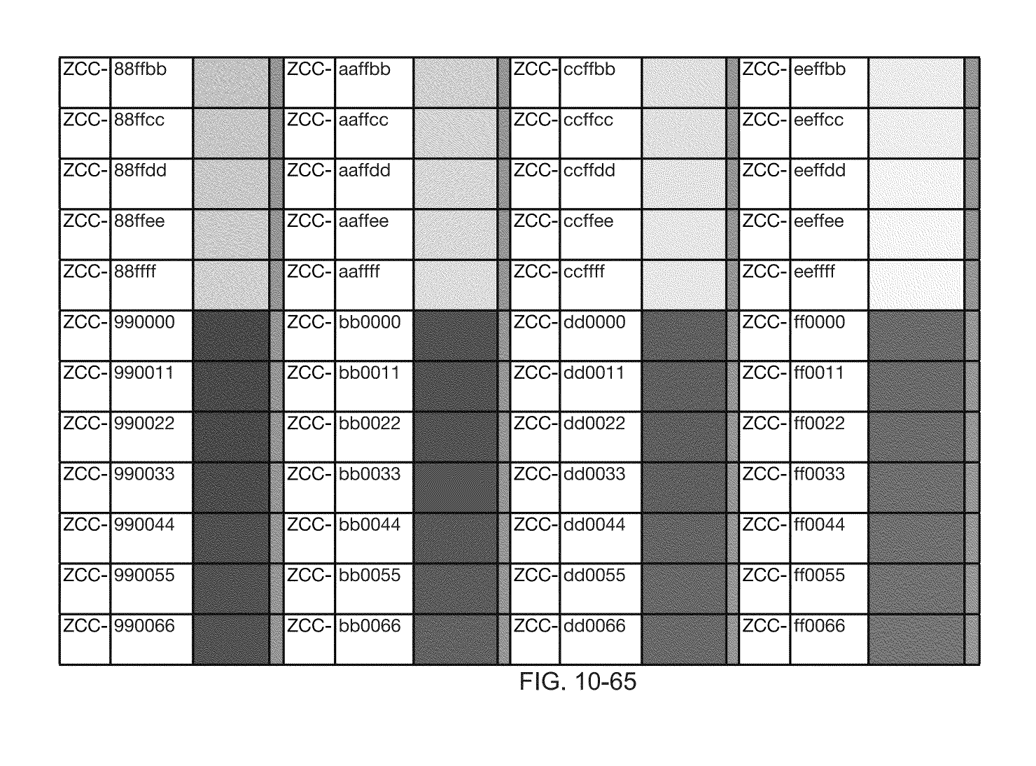

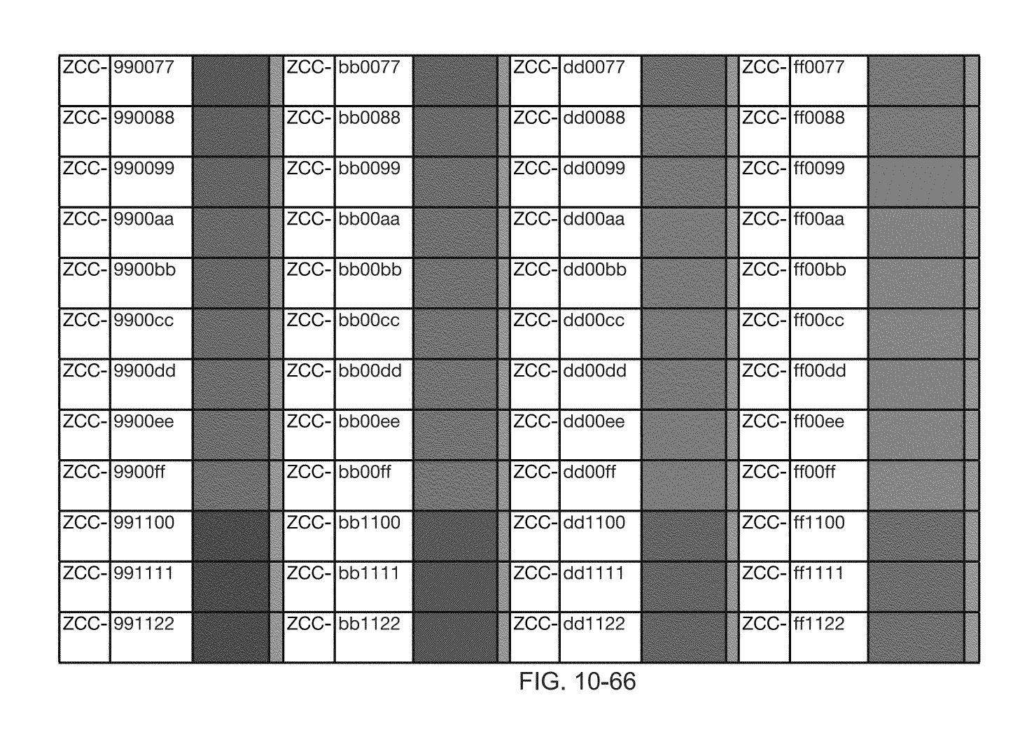

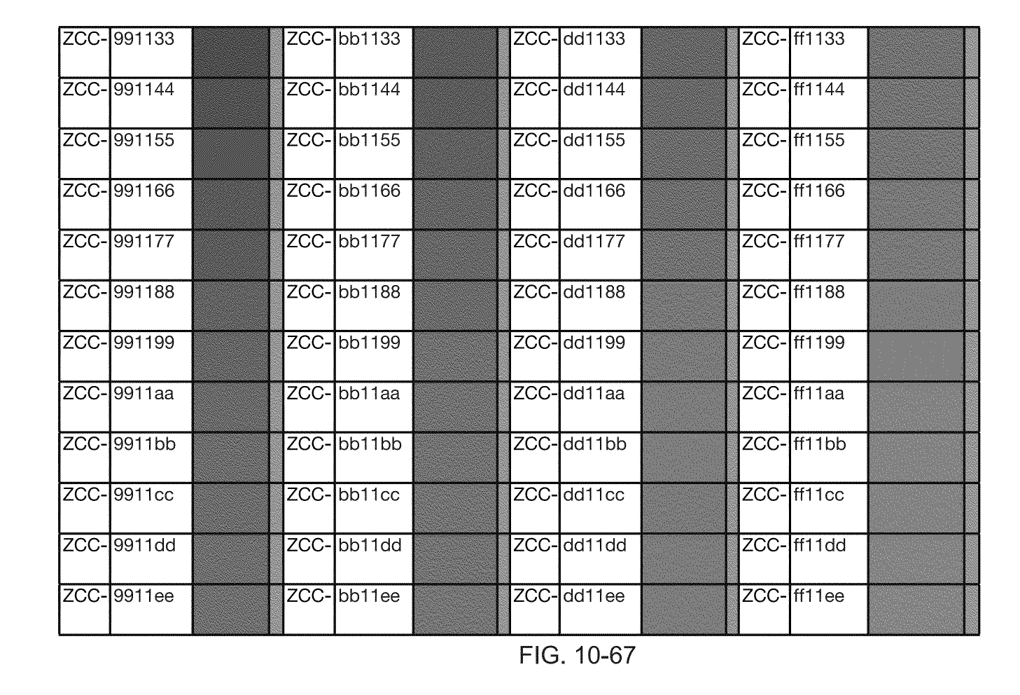

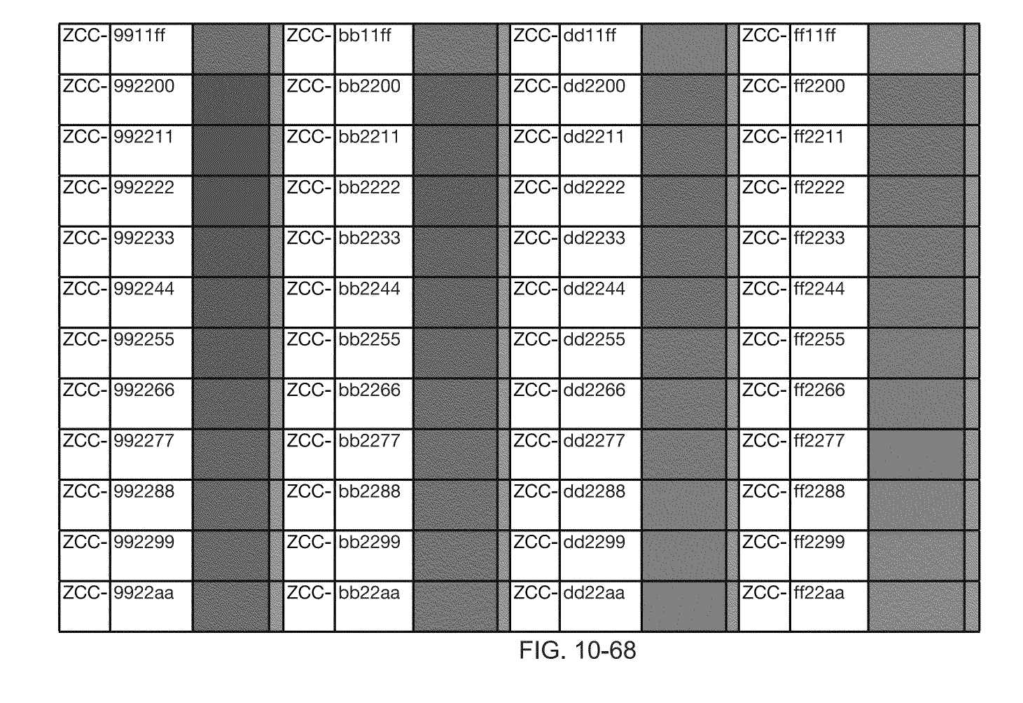

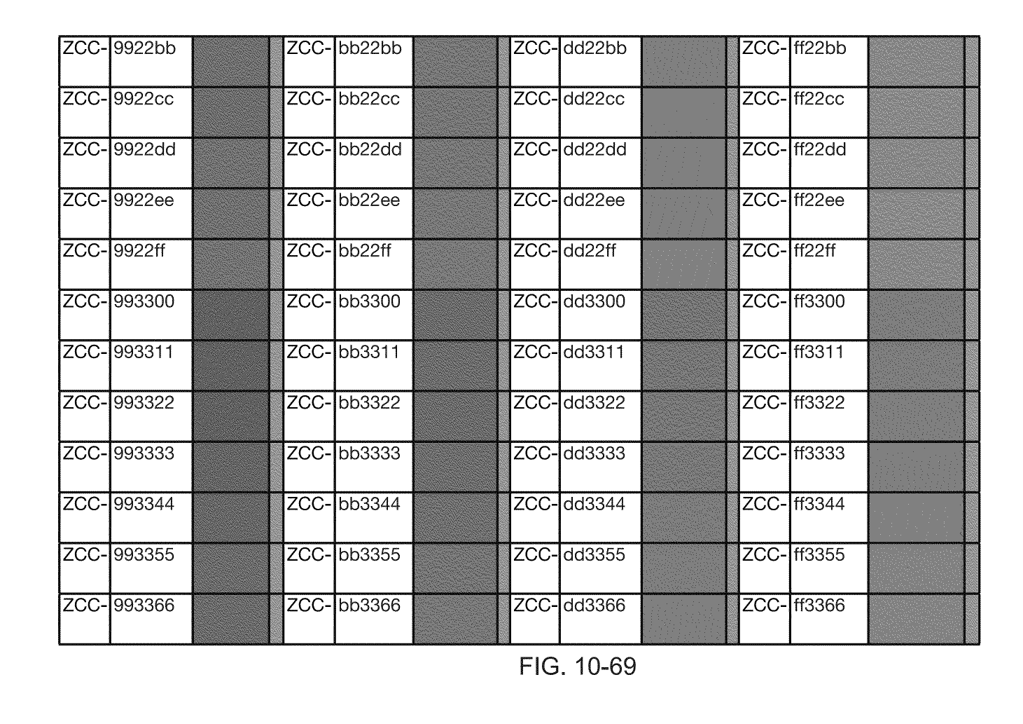

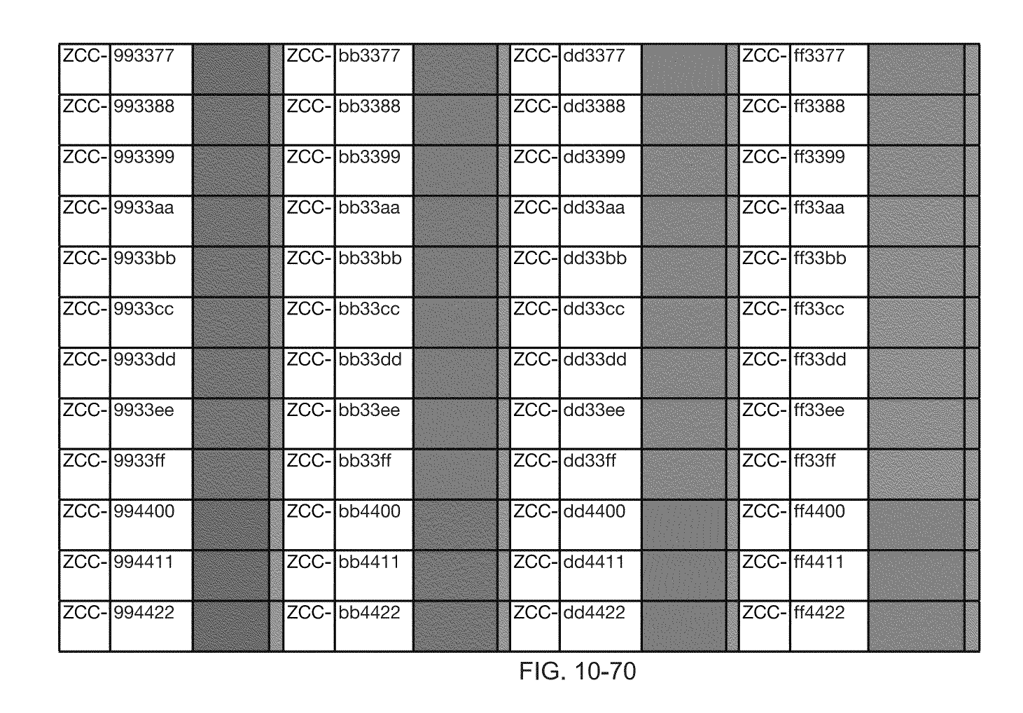

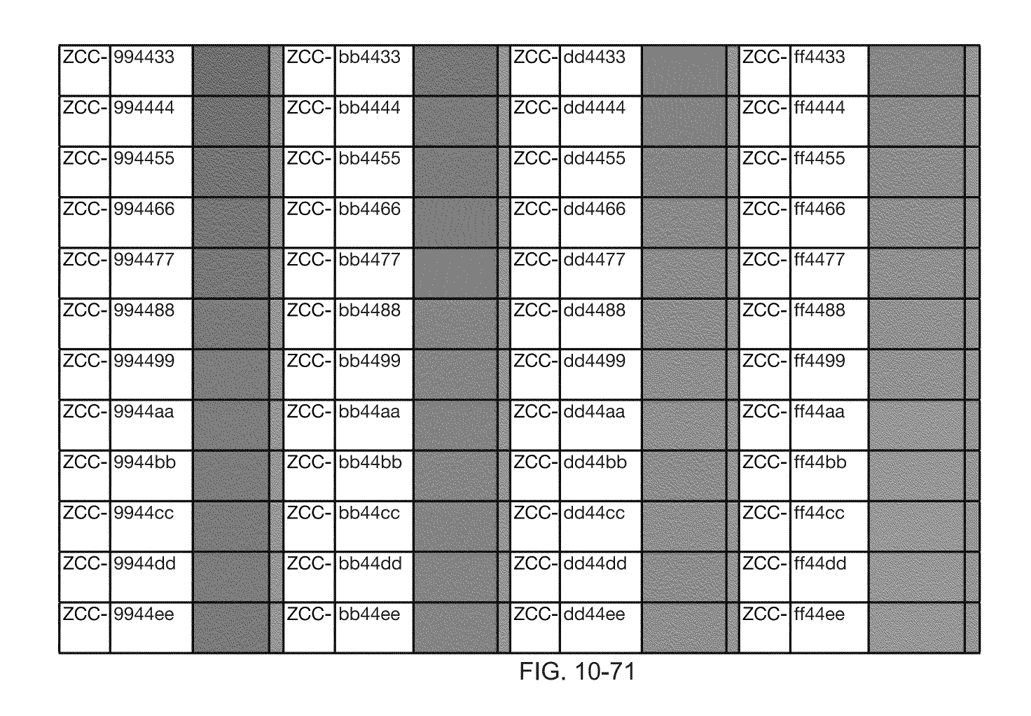

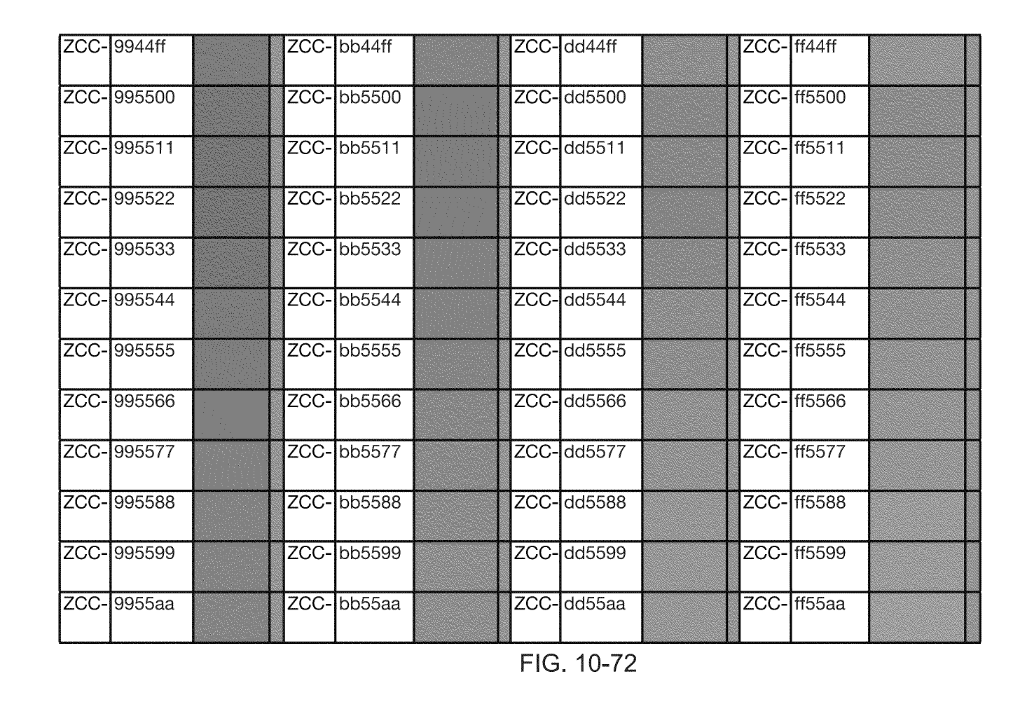

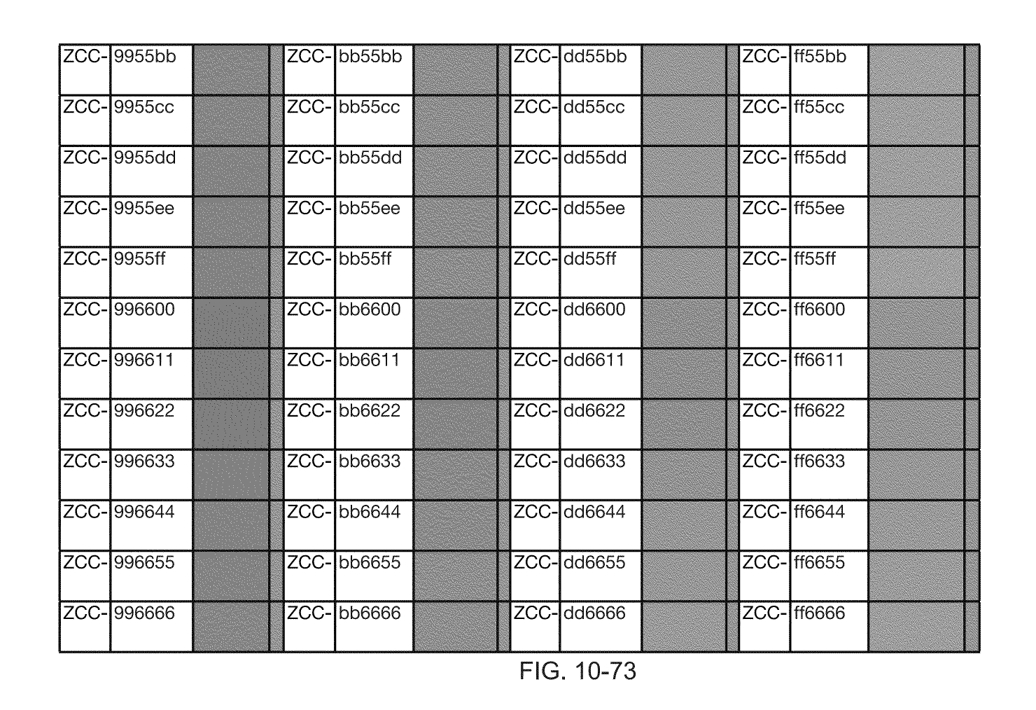

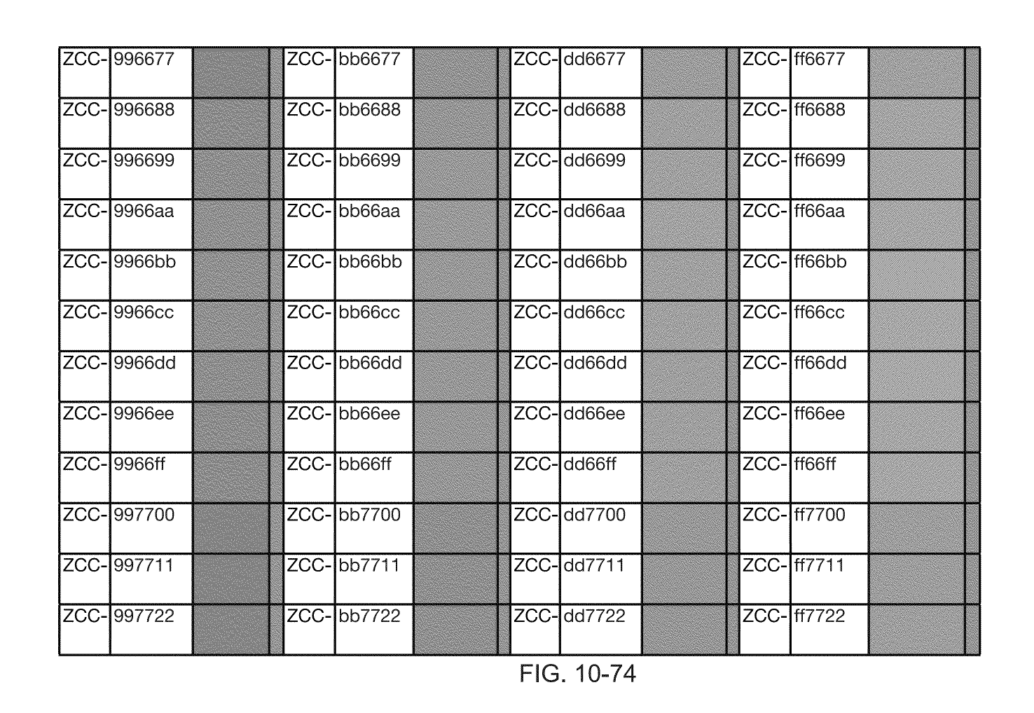

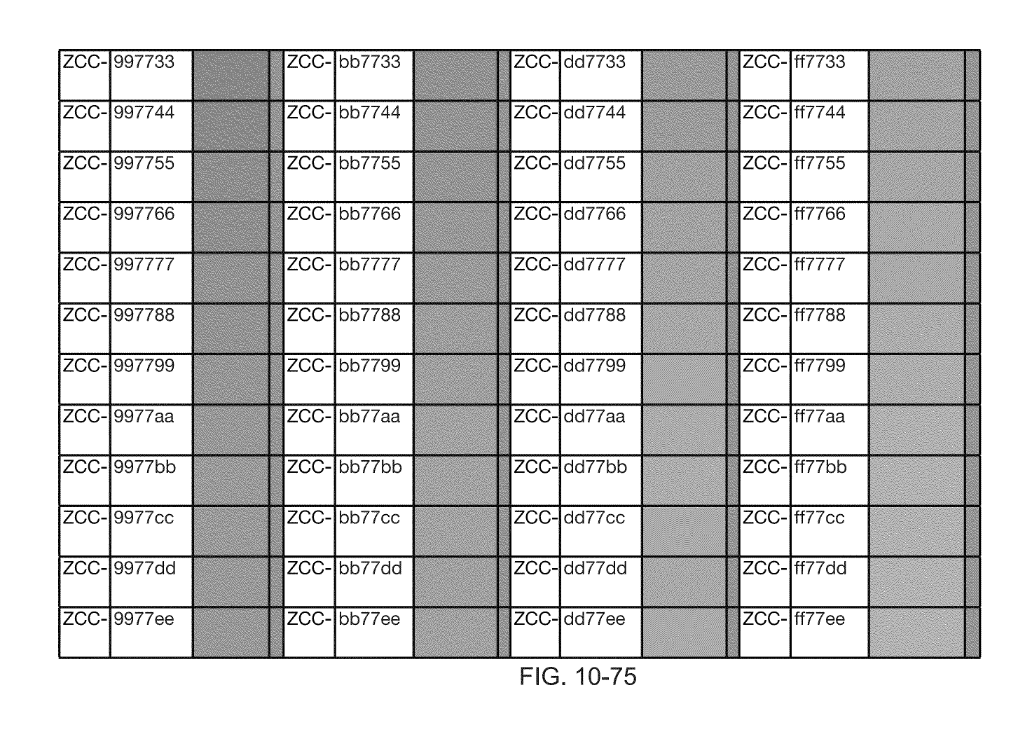

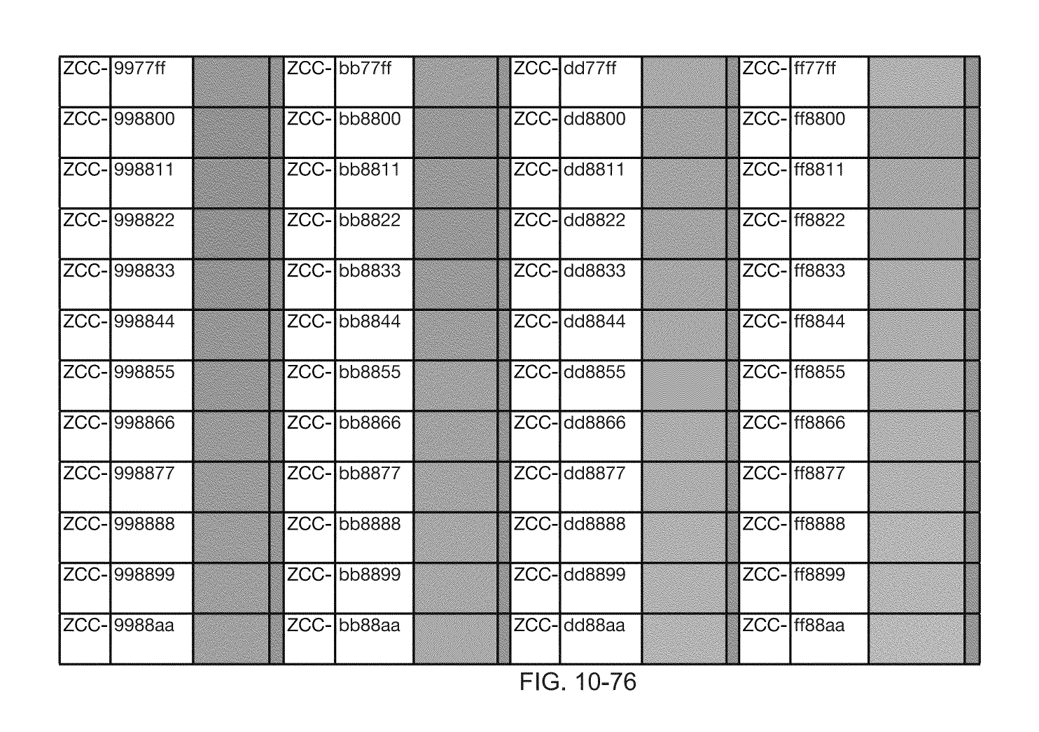

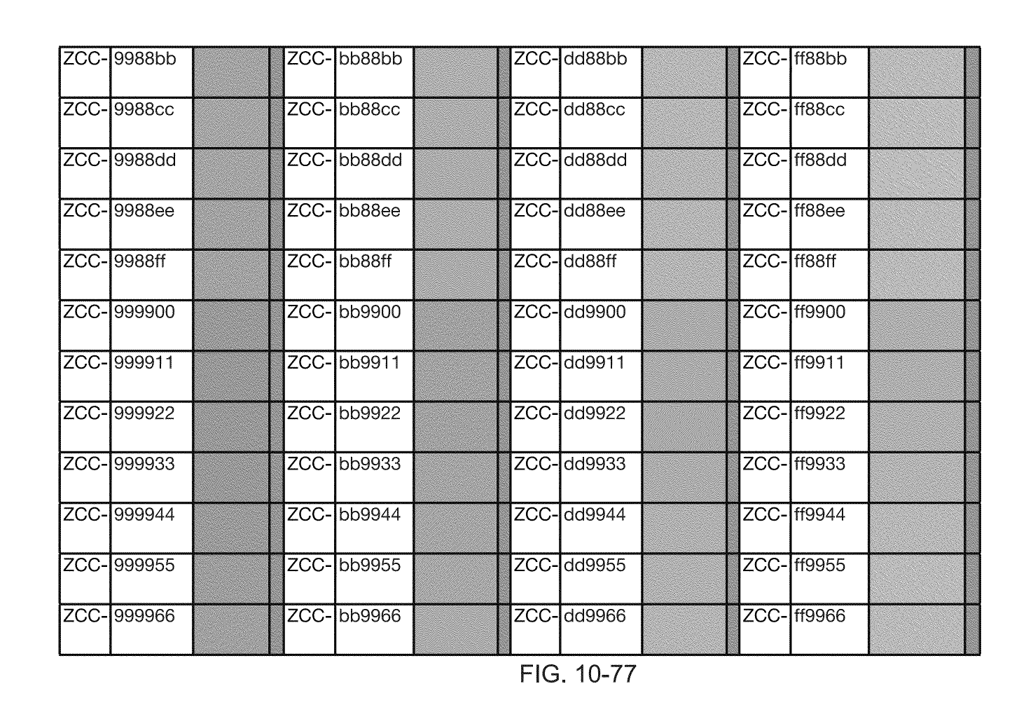

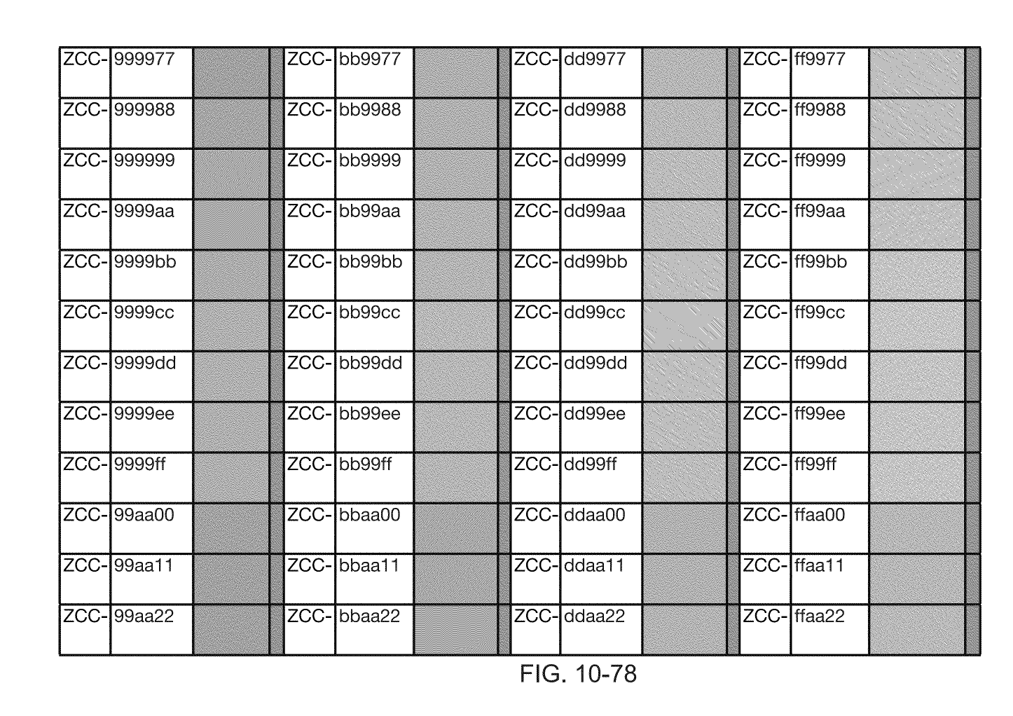

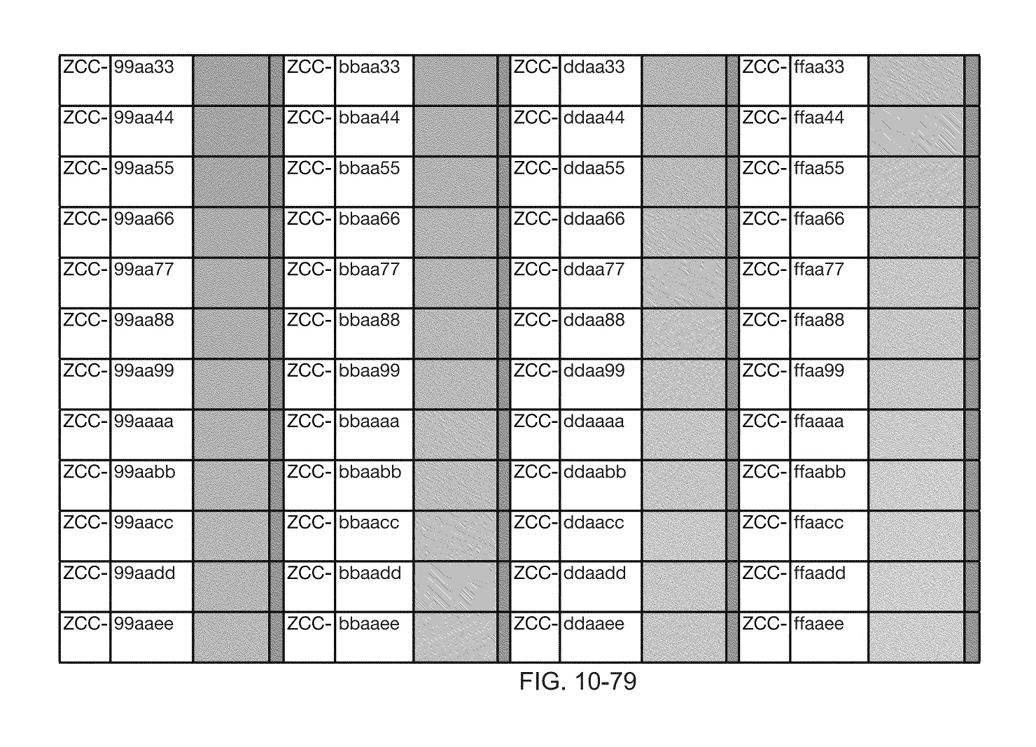

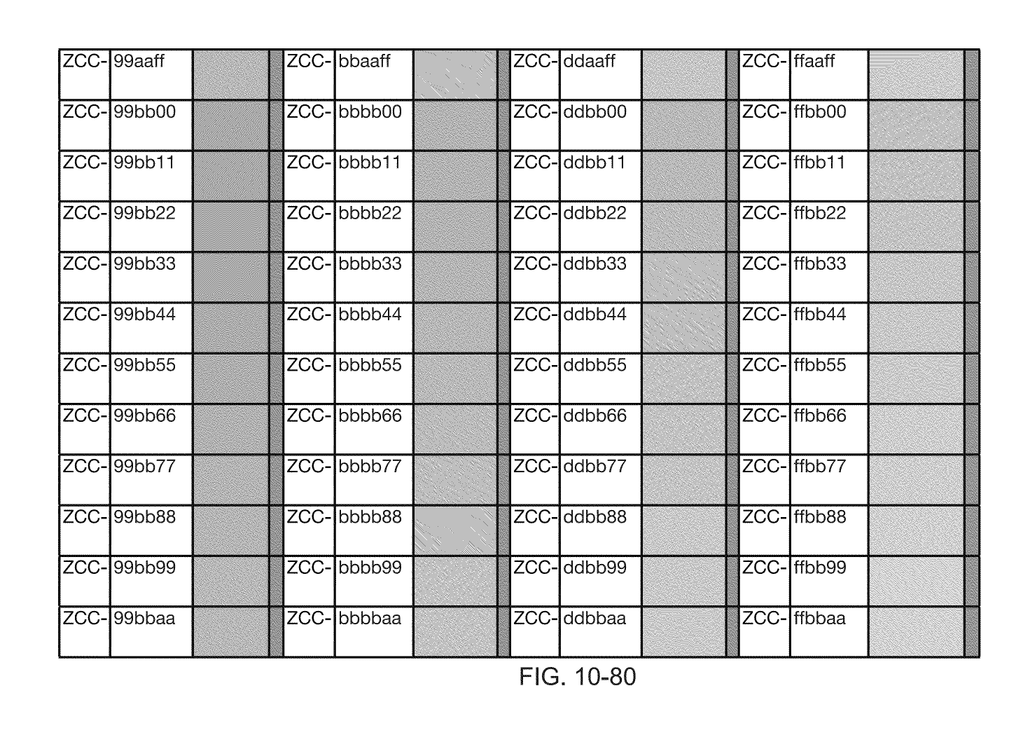

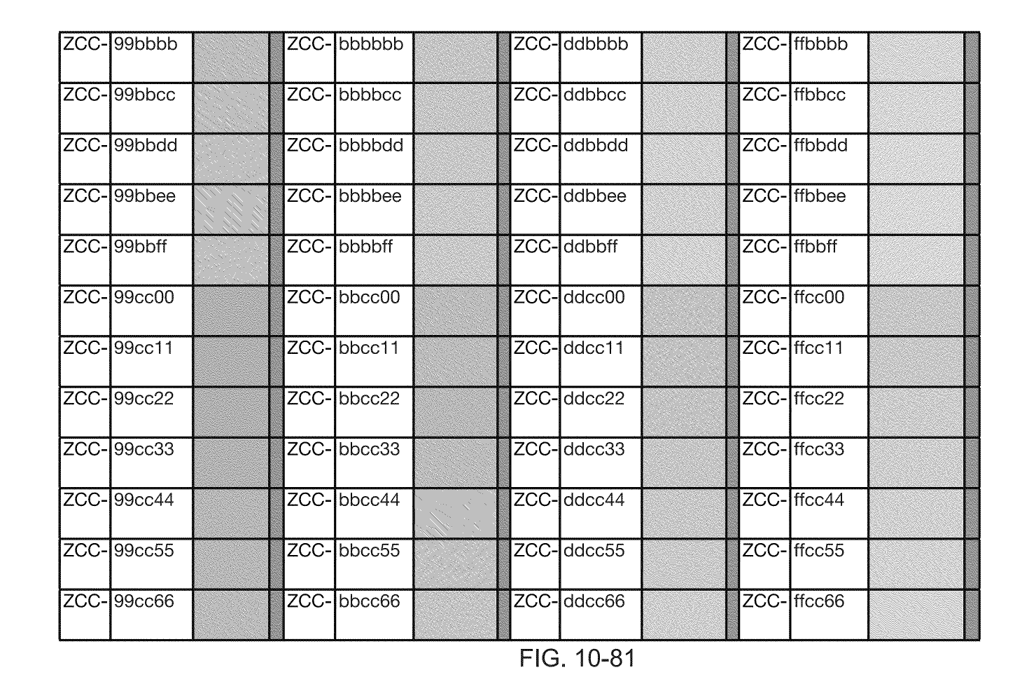

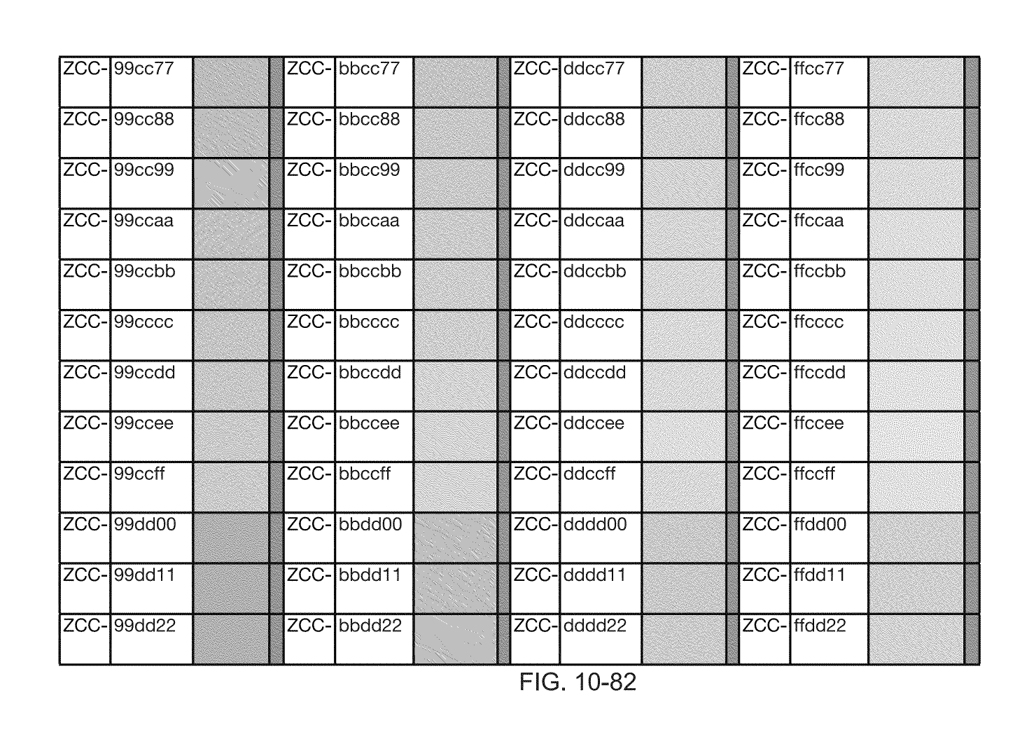

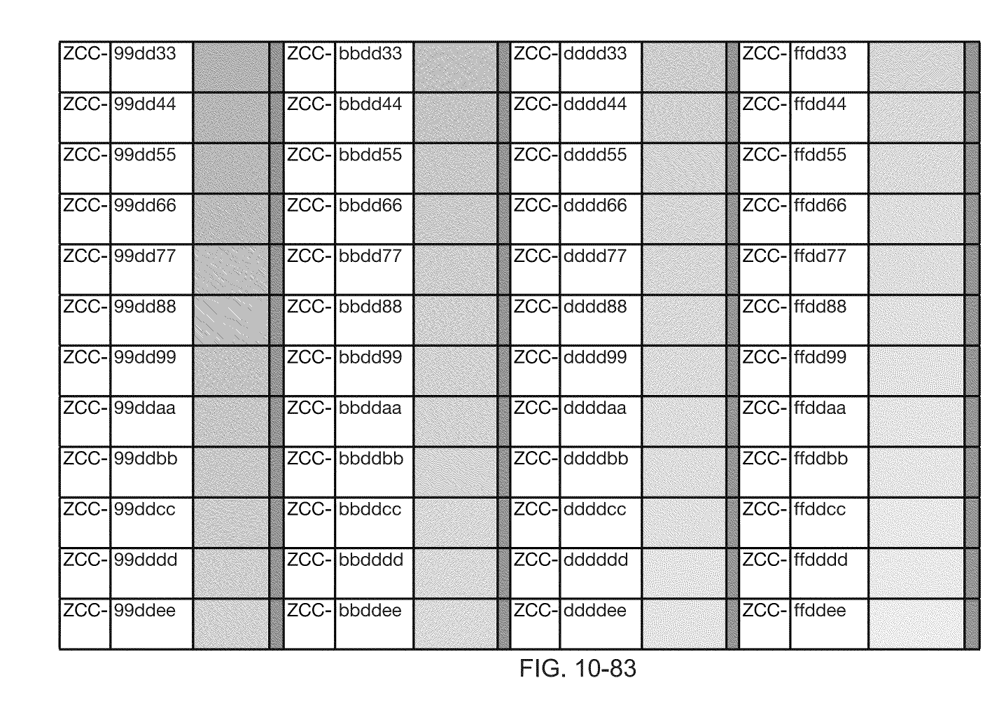

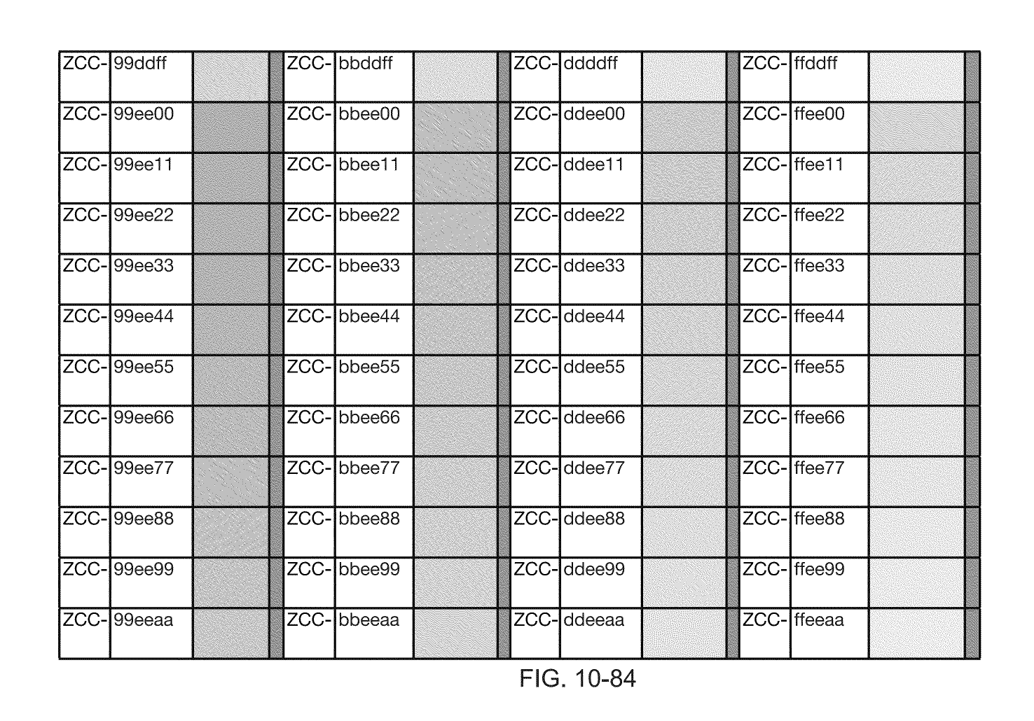

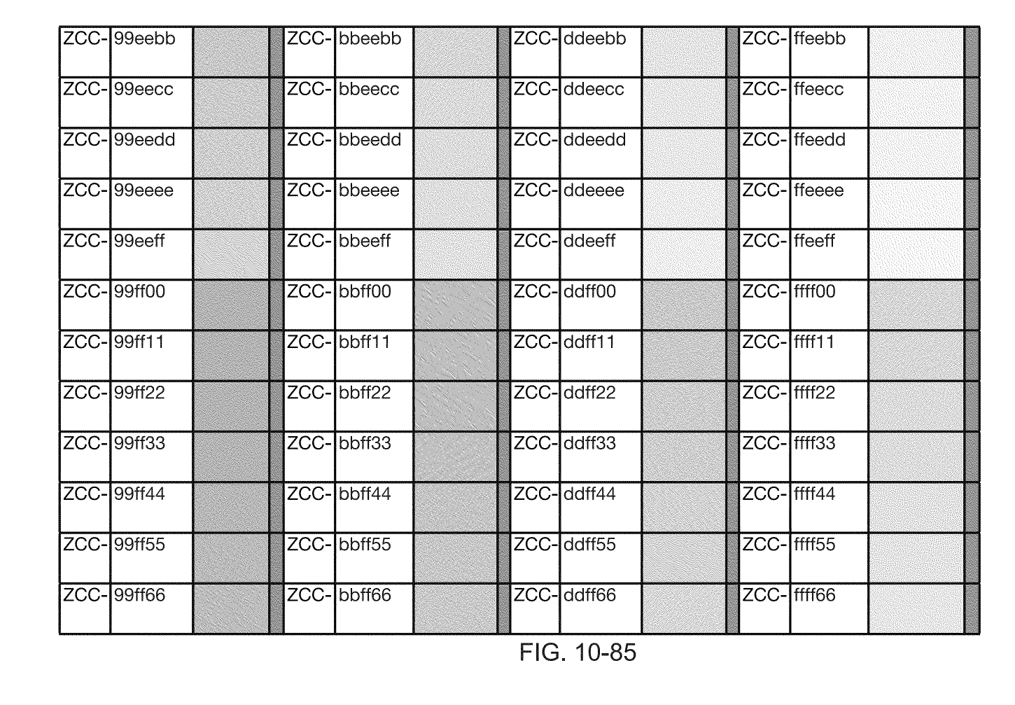

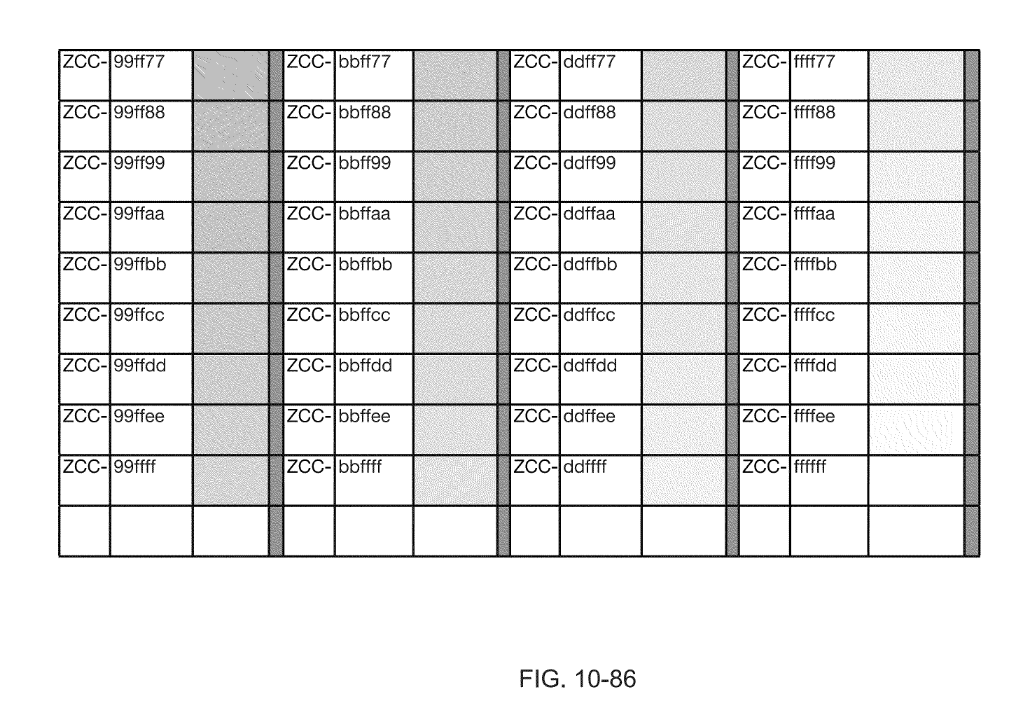

In the examples presented above, colors are determined and classified in 6-digit hexadecimal values. However, it should be understood that the available colors for classification can be adjusted to correspond to an expandable or fixed color environment. For example, in an expandable 4096 color environment, which is the preferred embodiment of the present invention, a color in a given image is assigned a 6-digit hexadecimal value (and corresponding RGB values) that corresponds to one of the 4096 selectable values that are available. The assignment of the 6-digit hexadecimal value (and corresponding RGB values) enables expansion if additional colors are desired beyond 4096 through the 16+ million colors that are actually available. FIGS. 10-1 through 10-86 reference a scalable 4096 color environment with corresponding color swatches and hexadecimal codes. It should be appreciated that each hexadecimal code can be converted into component RGB values and/or a binary representation.

In a fixed 4096 color environment, each of the component RGB colors presented on a scale of 0 to 255 can be adjusted downward to 16 intensities of RGB, respectively, on a scale of 0-15. Based on the 16 color intensities of each of these colors, a total of 16³ or 4096 colors variations are possible. For example, the color identified in hexadecimal code as CB93B1 and corresponding RGB values: 203 Red: 147 Green: 177 Blue could be adjusted on a 4096 color scale to hexadecimal code C9B and corresponding RGB values: 13 Red: 9 Green: 11 Blue, by using the closest values on the 16-level RGB scale. On this form of scale, these values would be associated with a product, such as a shirt, to which the image or color swatch belongs such that when a query for color C9B is made, one of the recommendations and or product results is the shirt. While utilizing only 16 RGB intensities (and 3 hexadecimal digits) does not easily lend itself to color expansion, it still permits a fair level of color variance sufficient for consumer and merchant classification.

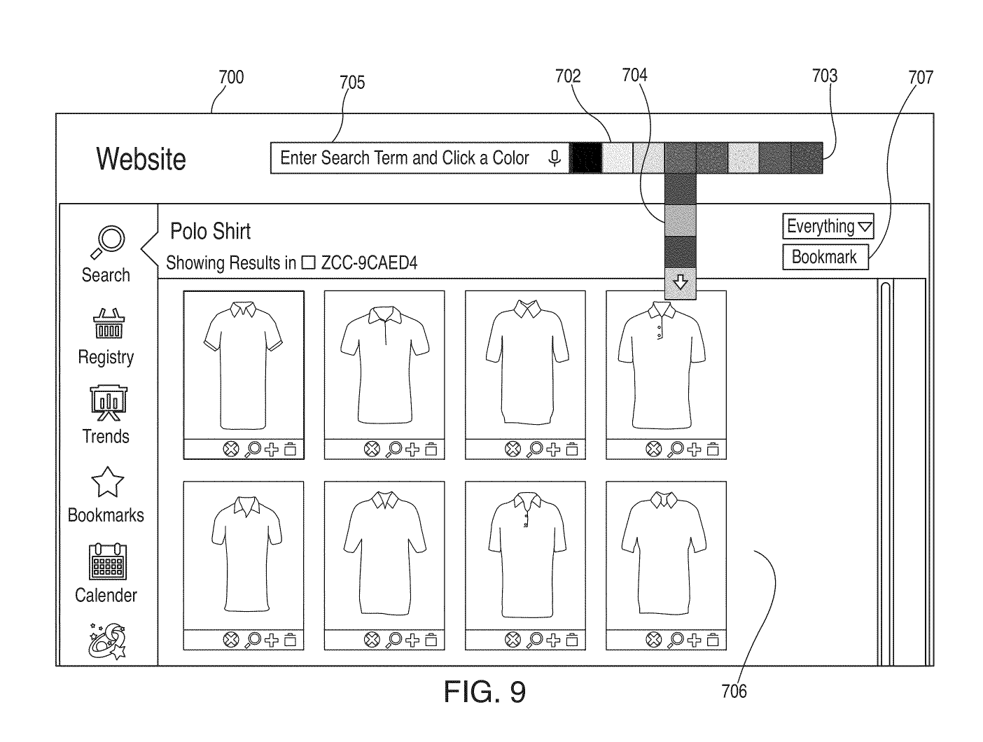

With reference to FIG. 3 and FIG. 9, all user subscribers gain entry and access to a graphical user interface 700 by subscription and by using known security approaches, such as a login and password 710, which are optionally managed by a separate login server (not shown). Once a login 710 is confirmed and a subscriber authenticates, a user's age, gender, location and other demographic information is loaded 720 and the verified user is permitted access to the search query functions 730.

A color-based search query may be initiated via graphical user interface 700. By selecting a selectable color area or swatch 702 along the top of the interface, a user may initiate a search for products from item table 540 (and color pattern table 580) with the associated digital color codes (e.g., in hexadecimal, RGB, binary) that correspond to the selectable color area 702. It should be appreciated that the query/ies sent to item table 540 and to color pattern table 580 may be referred to as a single query for ease of reference since the query received by each table requests essentially the same information. As illustrated in FIG. 9, when a user desires to search for products of a particular color, the user selects a color from one of the selectable color bar colors that appear on the clickable horizontal color bar 703. Once one of the colors on the horizontal bar 703 is selected, a vertical bar 704 expands downward, typically with shades of the initial color selected on the horizontal color bar 703. Once a user makes a final selection a search query is transmitted to the item table 540.

Preferences in the color swatches 702 appearing on the color bars 703, 704 may also be controlled and modified via the user interface 700, typically utilizing the bookmark feature 707. In controlling changes to selectable colors that readily appear on the GUI 700, a user may also be presented with a modify color panel (not shown).

When inputting additional search parameters in the textual search field 705, such as “Polo Shirt,” results coincide with products from item table 540 (and color pattern table 580) that meet both search limitations: 1. “Polo Shirt” and 2. the designated color code, in this case, the hexadecimal color identifier 9CAED4. Search results 740 are returned by the database engine and rendered in a designated display area 706. When resources permit, queries are performed continuously and automatically for products with identifying colors that match those colors that appear as selectable color areas 702 on a user's GUI 700. This enables population of the designated display area 706 with some relevant products from item table 540 before a formal search is initiated by a user.

Ideally, matches that are made comprise products from the item table 540 with associated colors that are identical (e.g., same hexadecimal and RGB values) to the color that is selected on the color bar. However, it may also be desirable under certain circumstances to return products with matching colors which are not identical, but which have a color code identification that is nearly the same or the one closest to the queried color. As noted above, in determining the closest matching color to the queried color, the software executes the following calculation c=sqrt((r−r₁)²+(g−g₁)²+(b−b₁)²), wherein c=closest color; r=first red value; r₁=second red value; g=first green value; g₁=second green value; and b=first blue value b₁=second blue value. The candidate matching color is the one or more colors that yield the value closest to zero.

Furthermore, it should be appreciated that advanced search queries may be performed by a user via the GUI 700, inputting a variety of parameters to narrow search results and, ideally, to find specific types of products that are available for purchase. These parameters may include a second color-based identifier, a specific pattern, or a physical attribute, such as size.

While the embodiments illustrated herein enable a user to search for a plurality of desired colors in one item (e.g., a first color and a secondary color), as well as specific pattern-color combinations (e.g., blue and red plaid), it should be appreciated that the system and storage may be configured to enable a user to search for “complementary” colored items to a queried color. To that end, in addition to the hexadecimal codes and RGB codes and other information associated with a particular color, a listing comprising one or more complimentary colors may be associated with each selectable color. Rules for determining what colors constitute a complimentary color may be incorporated such that queries return applicable results when the complementary color search is desired. For example, since a given shade of blue is known to complement or “go with” all other shades of blue along with a small sample of shades of red, the item table 540 and core color database 570 may list lists the complimentary shades of blue and red accordingly. Based on the rules, complimentary colors may be found in predetermined ranges, thereby allowing for multiple shades of a particular color to be categorized the same with respect to being identified as a complimentary color.

In addition to receiving results 740, a preferred embodiment of the system further provides a user with a number of user actions or options 800 to share the product via a social medium 810 (and to a social database 812), to “like” the product 820, to save the product as a bookmark 830 or into a user registry, to “hide” the product to ensure that it never appears again in a user's search results 840, and to purchase the product 850. When selections are made, they are stored as records in a user history table 860 and conveyed to the real-time analytics segment of the system to analyze and utilize for future recommendations to the user and to others with correlating selections and/or demographics. Thus, information from searches performed by users of available products or merchant inventory is organized and indexed as user data and is used to formulate user preferences that is available to be used for future recommendations to the users providing the data, as well as to other users sharing common user demographics and/or online shopping activities.

The accompanying description and drawings only illustrate several embodiments of a system, methods and interfaces for color-based identification, searching and matching, however, other forms and embodiments are possible. Accordingly, the description and drawings are not intended to be limiting in that regard. Thus, although the description above and accompanying drawings contain much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments may be practiced by those of ordinary skill in the art without departing from the spirit and scope of the invention.

1. With a processor controlled system in communication with a non-transitory computer readable storage medium having product data storage and color data storage, said product data storage being populated by merchant IMS/SCM feeds, a method of color based product matching comprising the steps of:
providing a plurality of selectable colors swatches;
assigning a unique color value to each of said plurality of selectable color swatches;
storing said plurality of selectable color swatches and said unique color values in a color table in said color data storage;
providing a graphical user interface to display said plurality of selectable color swatches, wherein each of said each of said plurality of selectable color swatches serves as a queried color when selected by a user to transform said selectable color swatches to a color-based query for a product;
in response to a color based query for a product by a user, matching said queried color with products from multiple merchants listed in said product data storage associated with a matching color value.

2. The method of claim 1 wherein said color value corresponds to a hexadecimal value.

3. The method of claim 1 wherein said color value corresponds to individual RGB color values.

4. The method of claim 1 wherein said matching color and said queried color each have the same hexadecimal value.

5. The method of claim 1 wherein said matching color and said queried color each have the same individual RGB color values.

6. The method of claim 1 wherein said matching step comprises the steps of comparing the color value of said queried color to the color value of products listed in said product data storage.

7. The method of claim 1 wherein said queried color is selected by a user via said graphical user interface.

8. The method of claim 1 further comprising the steps of assigning each of said plurality of selectable color swatches a corresponding alias.

9. A non-transitory computer readable storage medium, in communication with color data storage and product data storage, said product data storage being populated by merchant IMS/SCM feeds, and said non-transitory computer readable storage medium storing one or more programs, the one or more programs comprising instructions, which when executed by a computer, cause the computer to:
provide a plurality of selectable colors swatches;
assign a unique color value to each of said plurality of selectable color swatches;
store said plurality of selectable color swatches and said unique color values in a color table in said color data storage;
provide a graphical user interface to display said plurality of selectable color swatches, wherein each of said each of said plurality of selectable color swatches serves as a queried color when selected by a user to transform said selectable color swatches to a color-based query for a product;
in response to a color based query for a product by a user, match said queried color with products from multiple merchants listed in said product data storage associated with a matching color value.

10. The device of claim 9 wherein said color value corresponds to a hexadecimal value.

11. The device of claim 9 wherein said color value corresponds to individual RGB color values.

12. The device of claim 9 wherein said matching color and said queried color each have the same hexadecimal value.

13. The device of claim 9 wherein said matching color and said queried color each have the same individual RGB color values.

14. The device of claim 9 the one or more programs further including instructions to compare the color value of said queried color to the color value of products listed in said product data storage.

15. The device of claim 9 wherein said queried color is selected by a user via said graphical user interface.

16. The device of claim 9 the one or more programs further including instructions to assign each of said plurality of selectable color swatches a corresponding alias.

17. With a processor controlled system in communication with a non-transitory computer readable storage medium having product data storage and color-pattern data storage, said product data storage being populated by merchant IMS/SCM feeds, a method of color and pattern based product matching comprising the steps of:
providing a plurality of selectable colors swatches;
assigning a unique color value to each of said plurality of selectable color swatches;
storing said plurality of selectable color swatches and said unique color values in a table;
providing a plurality of selectable pattern swatches;
assigning a pattern value to each of a plurality of selectable pattern swatches;
storing said plurality of selectable pattern swatches and said pattern values in said table;
providing a graphical user interface to display said plurality of selectable color swatches and said plurality of selectable pattern swatches, wherein each of said plurality of selectable color swatches may serve as a queried color and each of said plurality of selectable pattern swatches may serve as a queried pattern when selected by a user to transform said selectable color swatches and said selectable pattern swatches to a color-pattern based query for a product;
in response to a color-pattern based query for a product by a user, matching said queried color and said queried pattern with products from multiple merchants listed in said product data storage associated with a matching color value and a matching pattern value.

18. The method of claim 17 wherein said color value corresponds to a hexadecimal value.

19. The method of claim 17 wherein said color value corresponds to individual RGB color values.

20. The method of claim 17 wherein said matching color and said queried color each have the same hexadecimal value.

21. The method of claim 17 wherein said matching color and said queried color each have the same individual RGB color values.

22. The method of claim 17 wherein said matching pattern and said queried pattern each have the same pattern value.

23. The method of claim 17 wherein said matching step comprises the steps of comparing the color value of said queried color to the color value of products listed in said product data storage and comparing the pattern value of said queried pattern to the pattern value of products listed in said product data storage.

24. The method of claim 17 wherein said queried color and said queried pattern are selected by a user via said graphical user interface.

25. The method of claim 17 further comprising the steps of assigning each of said plurality of selectable color swatches a corresponding alias.

26. A non-transitory computer readable storage medium, in communication with color data storage and product data storage, said product data storage being populated by merchant IMS/SCM feeds, and said non-transitory computer readable storage medium storing one or more programs, the one or more programs comprising instructions, which when executed by a computer, cause the computer to:
provide a plurality of selectable colors swatches;
assign a unique color value to each of said plurality of selectable color swatches;
store said plurality of selectable color swatches and said unique color values in a table;
provide a plurality of selectable pattern swatches;
assign a pattern value to each of a plurality of selectable pattern swatches;
store said plurality of selectable pattern swatches and said pattern values in said table;
provide a graphical user interface to display said plurality of selectable color swatches and said plurality of selectable pattern swatches, wherein each of said plurality of selectable color swatches may serve as a queried color and each of said plurality of selectable pattern swatches may serve as a queried pattern when selected by a user to transform said selectable color swatches and said selectable pattern swatches to a color-pattern based query for a product;
in response to a color-pattern based query for a product by a user, match said queried color and said queried pattern with products from multiple merchants listed in said product data storage associated with a matching color value and a matching pattern value.

27. The device of claim 26 wherein said color value corresponds to a hexadecimal value.

28. The device of claim 26 wherein said color value corresponds to individual RGB color values.

29. The device of claim 26 wherein said matching color and said queried color each have the same hexadecimal value.

30. The device of claim 26 wherein said matching color and said queried color each have the same individual RGB color values.

31. The device of claim 26 wherein said matching pattern and said queried pattern each have the same pattern value.

32. The device of claim 26 the one or more programs further including instructions to compare the color value of said queried color to the color value of products listed in said product data storage and comparing the pattern value of said queried pattern to the pattern value of products listed in said product data storage.

33. The device of claim 26 wherein said queried color and said queried pattern are selected by a user via said graphical user interface.

34. The device of claim 26 the one or more programs further including instructions to assign each of said plurality of selectable color swatches a corresponding alias.

35. With a processor controlled system in communication with a non-transitory computer readable storage medium having product data storage and color data storage, said product data storage being populated by merchant IMS/SCM feeds, a method of color based product searching comprising the steps of:
displaying a plurality of selectable color swatches on a graphical user interface, each of said plurality of selectable color swatches having an associated unique color value stored in said color data storage;
in response to a user selecting one of said plurality of selectable color swatches, sending a query to said product data storage for products from multiple merchants having an associated unique color value that matches the unique color value associated with said selected color swatch;
determining whether there are any products in said product data storage which match said query; and
displaying representations of products having an associated unique color value that matches the unique color value associated with said selected color swatch.

36. The method of claim 35 wherein said unique color value comprises a 6-digit hexadecimal code.

37. The method of claim 35 wherein said unique color value comprises component RGB intensities.

38. The method of claim 35 wherein said determining step returns a positive match when there are products having an associated unique color value that is the same as the unique color value associated with said selected color swatch.

39. The method of claim 35 wherein said determining step returns a positive match when there are products having an associated unique color value that is within a predetermined range of the unique color value associated with said selected color swatch.

40. The method of claim 35 wherein a variety of said selectable color swatches is a variety chosen by a user.

41. The method of claim 35 further comprising the steps of assigning each of said plurality of selectable colors swatches a corresponding alias.

42. The method of claim 35 further comprising the step of providing selectable user parameters to narrow query results.

43. The method of claim 42 wherein, in response to a user selecting a number of said user parameters, displaying representations of products that also conform to said selected user parameters.

44. A non-transitory computer readable storage medium, in communication with color data storage and product data storage, said product data storage being populated by merchant IMS/SCM feeds, and said non-transitory computer readable storage medium storing one or more programs, the one or more programs comprising instructions, which when executed by a computer, cause the computer to:
display a plurality of selectable color swatches on a graphical user interface, each of said plurality of selectable color swatches having an associated unique color value stored in said color data storage;
in response to a user selecting one of said plurality of selectable color swatches, send a query to said product data storage for products from multiple merchants having an associated unique color value that matches the unique color value associated with said selected color swatch;
determine whether there are any products in said product data storage which match said query; and
display representations of products having an associated unique color value that matches the unique color value associated with said selected color swatch.

45. The device of claim 44 wherein said unique color value comprises a 6-digit hexadecimal code.

46. The device of claim 44 wherein said unique color value comprises component RGB intensities.

47. The device of claim 44, the one or more programs further including instructions to return a positive match when there are products having an associated unique color value that is the same as the unique color value associated with said selected color swatch.

48. The device of claim 44, the one or more programs further including instructions to return a positive match when there are products having an associated unique color value that is within a predetermined range the unique color value associated with said selected color swatch.

49. The device of claim 44, wherein a variety of said selectable color swatches is a variety chosen by a user.

50. The device of claim 44, the one or more programs further including instructions to assign each of said plurality of selectable colors a corresponding alias,

51. The device of claim 44, the one or more programs further including instructions to provide selectable user parameters to narrow query results.

52. The device of claim 44, the one or more programs further including instructions to, in response to a user selecting a number of said user parameters, display representations of products that also conform to said selected user parameters.

53. A graphical user interface operatively connected to a processor controlled computer system for conducting color-based searches of an item table populated with representations of products from merchant IMS/SCM feeds, each of said products being associated with at least one of a plurality of unique color identifiers, comprising:
a plurality of selectable color swatches, each selectable color swatch being associated with one of said plurality of unique color identifiers and configured to initiate a color-based query for products associated with said one of said plurality of unique color identifiers when one of said selectable color swatches is selected by a user;
a textual search field configured to receive textual query parameters used to supplement said color-based query for products;
a search result display area configured to display representations of products that match said textual query parameters and are associated with the same unique color identifier as the selectable color swatch selected by a user in response to it being selected by a user.

54. The graphical user interface of claim 53 wherein said selectable color swatches form a color bar of different selectable color swatches, said bar being located adjacent to said textual search field.

55. The graphical user interface of claim 54 wherein each selectable color swatch on said color bar can be expanded to display different shades of said selectable color swatch when said color swatch is selected.

56. The graphical user interface of claim 53 further comprising a plurality of selectable pattern swatches which, when selected by a user, is configured to supplement said color-based query for products.

57. The graphical user interface of claim 53 further comprising a selectable bookmark function to save searches utilizing previously selected color swatches.

58. A graphical user interface operatively connected to a processor controlled computer system for conducting color-based searches of an item table populated with representations of products from merchant IMS/SCM feeds, each of said products being associated with at least one of a plurality of unique color identifiers, comprising:
a plurality of selectable color swatches, each selectable color swatch being associated with one of said plurality of unique color identifiers and configured to initiate a color-based query for products associated with said one of said plurality of unique color identifiers when one of said selectable color swatches is selected by a user;
a search result display area, populated in response to a selection of a selectable color swatch, said search result display area configured to display products having a color that matches said selected color swatch.

59. The graphical user interface of claim 58 further comprising a textual search field to supply textual search parameters to narrow the results of a color-based query.

60. The graphical user interface of claim 58 further comprising a plurality of selectable pattern swatches, wherein when one of said selectable pattern swatch fields is selected by a user, said products results from said color-based query also matches said selected pattern swatch.

61. The graphical user interface of claim 58, wherein said displayed products are associated with a unique color identifier that is identical to the unique color identifier associated with the selected color swatch.

62. The graphical user interface of claim 58, wherein said displayed products are associated with a unique color identifier that is the closest having associated products to the unique color identifier associated with the selected color swatch.

63. The graphical user interface of claim 58, wherein each of said unique color identifiers comprise a 6-digit hexadecimal color code.

64. The graphical user interface of claim 58, wherein each of said unique color identifiers comprise a RGB component values.

65. A graphical user interface operatively connected to a processor controlled computer system for conducting color-based searches of an item table populated with representations of products from merchant IMS/SCM feeds, each of said products being associated with at least one of a plurality of color codes being formed from a concatenation of digital values for R, G and B components of a color, comprising:
a plurality of selectable color swatches, each selectable color swatch being associated with one of said plurality of color codes and configured to initiate a color-based query for products associated with said one of said plurality of color codes when one of said selectable color swatches is selected by a user;
a search result display area, populated in response to a selection of a selectable color swatch, said search result display area sized to display products having a color code that matches that of the selected color swatch.

66. The graphical user interface of claim 65 further comprising a textual search field to supply textual search parameters to narrow the results of a color-based query.

67. The graphical user interface of claim 65 further comprising a plurality of selectable pattern swatches, wherein when one of said selectable pattern swatch fields is selected by a user, said products results from said color-based query also matches said selected pattern swatch.

68. The graphical user interface of claim 65, wherein said displayed products are associated with a color code that is identical to that associated with the selected color swatch.

69. The graphical user interface of claim 65, wherein said displayed products are associated with a color code that is the closest one having associated products to the color code associated with the selected color swatch.

70. A processor-based computer system with machine readable storage media operatively connected to a plurality of merchant ISM/SCM feeds and configured to receive formatted data on products and color from said feeds, comprising:
a color table database, said color table database comprising a plurality of unique color identifiers, each associated with a color swatch;
a product table database, said product table database comprising a plurality of products, each associated with at least one of said plurality of unique color identifiers;
one or more processors configured to (a) transform product data and color data received from said ISM/SCM feeds so that said product data and color data is incorporated into said product table database, and (b) execute IMS/SCM functions by accessing said product table database and, in response to a query, retrieving data entries therein which are related in a manner that dictates retrieval of both a unique color identifier and products associated therewith.

71. A relational database access system for performing ISM/SCM functions comprising:
a processor-based computer system with a machine readable storage medium and memory operatively connected by a channel to a plurality of merchant ISM/SCM feeds and configured to receive formatted data from said feeds via said channel; and
a relational database responsive to a query language and queries from a user, said relational database having transformed forms of data records input therein from a plurality of merchants including product records, each associated with a color identifier in the form of a concatenation of digital values for R, G and B components;
wherein product records associated with a different merchant and having the same color identifier are related to one another by said color identifier in said relational database such that when a color query for said color identifier returns a positive match, product records having the same color identifier are displayed in response.

72. In a processor controlled system in communication with a non-transitory computer readable storage medium having color data storage and product data storage, a method comprising the steps of:
populating an item table by merchant IMS/SCM feeds transformed by a middleware engine with values in a unique color coding scheme;
conducting a color analysis of said merchant IMS/SCM feeds when said merchant IMS/SCM feeds do not contain a value in said unique color coding scheme
determining a value in said unique color coding scheme based upon said merchant IMS/SCM feeds which do not contain a value;
populating a color/pattern table with said determined value in said unique color coding scheme;
receiving a query to said item table and said color/pattern table from a user to return a color based product record having a value that matches said query; and
returning all color based product records having a value that matches said query from said item table and said color/pattern table.

73. In a processor controlled system in communication with a non-transitory computer readable storage medium having color data storage and product data storage, a method comprising the steps of:
receiving in a middleware engine a plurality of merchant IMS/SCM data feeds of item information including, for each data feed, a color field comprising a concatenation of digital values for R, G and B components of a color represented in a color field; and
receiving in an item table from the middleware engine said color fields of all of said data feeds;
wherein the item table comprises additional product identification fields.
